(19) United States
(12) Patent Application Publication
(10) Pub. No.: US 2026/0153740 A1
(43) Pub. Date: Jun. 4, 2026

(54) Augmented Reality Eyeglasses with a Dynamic Waveguide

(71) Applicant: Robert A. Connor, Wyoming, MN (US)

(72) Inventor: Robert A. Connor, Wyoming, MN (US)

(73) Assignee: Holovisions LLC, Ham Lake, MN (US)

(21) Appl. No.: 19/455,689

(22) Filed: Jan. 21, 2026

Related U.S. Application Data
(63) Continuation-in-part of application No. 19/347,028, filed on Oct. 1, 2025.
(63) Continuation-in-part of application No. 19/069,077, filed on Mar. 3, 2025.
(63) Continuation-in-part of application No. 18/800,091, filed on Aug. 11, 2024, now Pat. No. 12,601,923.
Application No. 19/347,028 is a continuation-in-part of application No. 19/069,077, filed on Mar. 3, 2025.
Application No. 19/069,077 is a continuation-in-part of application No. 18/827,703, filed on Sep. 7, 2024, now Pat. No. 12,436,394.
Application No. 18/827,703 is a continuation-in-part of application No. 18/800,091, filed on Aug. 11, 2024, now Pat. No. 12,601,923.
Application No. 19/069,077 is a continuation-in-part of application No. 18/827,703, filed on Sep. 7, 2024, now Pat. No. 12,436,394.
Application No. 18/827,703 is a continuation-in-part of application No. 18/800,091, filed on Aug. 11, 2024, now Pat. No. 12,601,923.
Application No. 18/827,703 is a continuation-in-part of application No. 18/800,091, filed on Aug. 11, 2024, now Pat. No. 12,601,923.
Application No. 18/800,091 is a continuation-in-part of application No. 18/586,439, filed on Feb. 24, 2024, now Pat. No. 12,205,231.
Application No. 18/800,091 is a continuation-in-part of application No. 18/586,439, filed on Feb. 24, 2024, now Pat. No. 12,205,231.
Application No. 18/586,439 is a continuation-in-part of application No. 18/088,548, filed on Dec. 24, 2022, now Pat. No. 12,013,538.
Application No. 18/088,548 is a continuation-in-part of application No. 17/722,354, filed on Apr. 17, 2022, now Pat. No. 11,754,843.
Application No. 17/722,354 is a continuation-in-part of application No. 17/501,495, filed on Oct. 14, 2021, now Pat. No. 11,307,420.
Application No. 17/501,495 is a continuation-in-part of application No. 16/686,170, filed on Nov. 17, 2019, now Pat. No. 11,163,163.
Application No. 16/686,170 is a continuation-in-part of application No. 16/175,924, filed on Oct. 31, 2018, now Pat. No. 10,859,834.
Application No. 16/175,924 is a continuation-in-part of application No. 15/942,498, filed on Mar. 31, 2018, now Pat. No. 10,338,400.
(60) Provisional application No. 62/624,699, filed on Jan. 31, 2018.
(60) Provisional application No. 62/624,699, filed on Jan. 31, 2018.
(60) Provisional application No. 62/638,087, filed on Mar. 3, 2018.
(60) Provisional application No. 62/638,087, filed on Mar. 3, 2018.
(60) Provisional application No. 62/646,856, filed on Mar. 22, 2018.
(60) Provisional application No. 62/646,856, filed on Mar. 22, 2018.
(60) Provisional application No. 62/695,124, filed on Jul. 8, 2018.
(60) Provisional application No. 62/699,800, filed on Jul. 18, 2018.
(60) Provisional application No. 62/703,025, filed on Jul. 25, 2018.
(60) Provisional application No. 62/714,684, filed on Aug. 4, 2018.
(60) Provisional application No. 62/716,507, filed on Aug. 9, 2018.
(60) Provisional application No. 62/720,171, filed on Aug. 21, 2018.
(60) Provisional application No. 62/746,487, filed on Oct. 16, 2018.
(60) Provisional application No. 62/749,775, filed on Oct. 24, 2018.
(60) Provisional application No. 62/751,076, filed on Oct. 26, 2018.
(60) Provisional application No. 62/791,359, filed on Jan. 11, 2019.
(60) Provisional application No. 63/192,664, filed on May 25, 2021.
(60) Provisional application No. 63/212,054, filed on Jun. 17, 2021.
(60) Provisional application No. 63/952,680, filed on Jan. 1, 2026.

(51) Int. Cl. G02B 27/01; G02B 26/08; G02C 7/10

(52) U.S. Cl. CPC G02B 27/0172; G02B 26/0841; G02C 7/101; G02C 7/102; G02B 2027/0163; G02B 2027/0178

(57) ABSTRACT

Disclosed herein are optical structures for augmented reality eyewear with a dynamic waveguide, wherein the dynamic waveguide has an array of individually-movable reflective components or an array of adjustable-reflectivity components. These optical structures enable a person to see a bright, opaque virtual object in a portion of their field of view and also see their environment clearly in the rest of their field of view.

### CROSS-REFERENCE TO RELATED APPLICATIONS

This patent application claims the priority benefit of U.S. provisional patent application 63/952,680 filed on 2026 Jan. 1. This application is a continuation-in-part of U.S. patent application Ser. No. 19/347,028 filed on 2025 Oct. 1. This application is a continuation-in-part of U.S. patent application Ser. No. 19/069,077 filed on 2025 Mar. 3. This application is a continuation-in-part of U.S. patent application Ser. No. 18/800,091 filed on 2024 Aug. 11.

U.S. patent application Ser. No. 19/347,028 was a continuation-in-part of U.S. patent application Ser. No. 19/069,077 filed on 2025 Mar. 3. U.S. patent application Ser. No. 19/347,028 was a continuation-in-part of U.S. patent application Ser. No. 18/827,703 filed on 2024 Sep. 7. U.S. patent application Ser. No. 19/347,028 was a continuation-in-part of U.S. patent application Ser. No. 18/800,091 filed on 2024 Aug. 11. U.S. patent application Ser. No. 19/069,077 was a continuation-in-part of U.S. patent application Ser. No. 18/827,703 filed on 2024 Sep. 7. U.S. patent application Ser. No. 19/069,077 was a continuation-in-part of U.S. patent application Ser. No. 18/800,091 filed on 2024 Aug. 11.

U.S. patent application Ser. No. 18/827,703 was a continuation-in-part of U.S. patent application Ser. No. 18/800,091 filed on 2024 Aug. 11. U.S. patent application Ser. No. 18/827,703 was a continuation-in-part of U.S. patent application Ser. No. 18/586,439 filed on 2024 Feb. 24. U.S. patent application Ser. No. 18/800,091 was a continuation-in-part of U.S. patent application Ser. No. 18/586,439 filed on 2024 Feb. 24. U.S. patent application Ser. No. 18/586,439 was a continuation-in-part of U.S. patent application Ser. No. 18/088,548 filed on 2022 Dec. 24. U.S. patent application Ser. No. 18/088,548 was a continuation-in-part of U.S. patent application Ser. No. 17/722,354 filed on 2022 Apr. 17. U.S. patent application Ser. No. 17/722,354 was a continuation-in-part of U.S. patent application Ser. No. 17/501,495 filed on 2021 Oct. 14.

U.S. patent application Ser. No. 17/501,495 was a continuation-in-part of U.S. patent application Ser. No. 16/686,170 filed on 2019 Nov. 17. U.S. patent application Ser. No. 17/501,495 claimed the priority benefit of U.S. provisional patent application 63/192,664 filed on 2021 May 25. U.S. patent application Ser. No. 17/501,495 claimed the priority benefit of U.S. provisional patent application 63/212,054 filed on 2021 Jun. 17. U.S. patent application Ser. No. 16/686,170 claimed the priority benefit of U.S. provisional patent application 62/791,359 filed on 2019 Jan. 11. U.S. patent application Ser. No. 16/686,170 was a continuation-in-part of U.S. patent application Ser. No. 16/175,924 filed on 2018 Oct. 31 which issued as U.S. patent Ser. No. 10/859,834 on 2020 Dec. 8.

U.S. patent application Ser. No. 16/175,924 claimed the priority benefit of U.S. provisional patent application 62/751,076 filed on 2018 Oct. 26. U.S. patent application Ser. No. 16/175,924 claimed the priority benefit of U.S. provisional patent application 62/749,775 filed on 2018 Oct. 24. U.S. patent application Ser. No. 16/175,924 claimed the priority benefit of U.S. provisional patent application 62/746,487 filed on 2018 Oct. 16. U.S. patent application Ser. No. 16/175,924 claimed the priority benefit of U.S. provisional patent application 62/720,171 filed on 2018 Aug. 21. U.S. patent application Ser. No. 16/175,924 claimed the priority benefit of U.S. provisional patent application 62/716,507 filed on 2018 Aug. 9. U.S. patent application Ser. No. 16/175,924 claimed the priority benefit of U.S. provisional patent application 62/714,684 filed on 2018 Aug. 4. U.S. patent application Ser. No. 16/175,924 claimed the priority benefit of U.S. provisional patent application 62/703,025 filed on 2018 Jul. 25. U.S. patent application Ser. No. 16/175,924 claimed the priority benefit of U.S. provisional patent application 62/699,800 filed on 2018 Jul. 18. U.S. patent application Ser. No. 16/175,924 claimed the priority benefit of U.S. provisional patent application 62/695,124 filed on 2018 Jul. 8. U.S. patent application Ser. No. 16/175,924 was a continuation-in-part of U.S. patent application Ser. No. 15/942,498 filed on 2018 Mar. 31 which issued as U.S. Pat. Nos. 10,859,834 10,338,400 on 2019 Jul. 2. U.S. patent application Ser. No. 16/175,924 claimed the priority benefit of U.S. provisional patent application 62/646,856 filed on 2018 Mar. 22. U.S. patent application Ser. No. 16/175,924 claimed the priority benefit of U.S. provisional patent application 62/638,087 filed on 2018 Mar. 3. U.S. patent application Ser. No. 16/175,924 claimed the priority benefit of U.S. provisional patent application 62/624,699 filed on 2018 Jan. 31.

U.S. patent application Ser. No. 15/942,498 claimed the priority benefit of U.S. provisional patent application 62/646,856 filed on 2018 Mar. 22. U.S. patent application Ser. No. 15/942,498 claimed the priority benefit of U.S. provisional patent application 62/638,087 filed on 2018 Mar. 3. U.S. patent application Ser. No. 15/942,498 claimed the priority benefit of U.S. provisional patent application 62/624,699 filed on 2018 Jan. 31. U.S. patent application Ser. No. 15/942,498 claimed the priority benefit of U.S. provisional patent application 62/572,328 filed on 2017 Oct. 13. U.S. patent application Ser. No. 15/942,498 claimed the priority benefit of U.S. provisional patent application 62/563,798 filed on 2017 Sep. 27. U.S. patent application Ser. No. 15/942,498 claimed the priority benefit of U.S. provisional patent application 62/561,834 filed on 2017 Sep. 22. U.S. patent application Ser. No. 15/942,498 claimed the priority benefit of U.S. provisional patent application 62/528,331 filed on 2017 Jul. 3.

The entire contents of these related applications are incorporated herein by reference.

### FEDERALLY SPONSORED RESEARCH

Not Applicable

### SEQUENCE LISTING OR PROGRAM

Not Applicable

### BACKGROUND—FIELD OF INVENTION

This invention relates to optical structures for augmented reality eyeglasses.

### INTRODUCTION

Augmented Reality (AR) eyeglasses enable a person to simultaneously see their environment and virtual objects displayed in their field of vision. Augmented Reality (also called “Mixed Reality”) can include simulated interactions between a person and virtual objects in their environment. Augmented reality has numerous potential applications in the fields of commerce and shopping, defense, diet and nutritional improvement, education, engineering, entertainment, exploration, gaming, interior design, maintenance, manufacturing, medicine, movies, navigation and transportation, public safety, socializing, and sports.

### REVIEW OF THE RELEVANT ART

U.S. patent application publication 20180164882 (Johnson et al., Jun. 14, 2018, “Electronic Device with Adjustable Reflective Display”) discloses an adjustable reflectance and transmittance layer which overlaps a pixel array. U.S. patent application publication 20190079334 (Firka et al., Mar. 14, 2019, “Electronic Devices Having Electrically Adjustable Optical Shutters”) and U.S. patent application publication 20210096417 (Firka et al., Apr. 1, 2021, “Electronic Devices Having Electrically Adjustable Optical Shutters”) disclose an electronic device with an electrically-adjustable shutter which can be in a transparent or nontransparent state.

U.S. patent application publication 20190324274 (Kalinowski et al., Oct. 24, 2019, “Head-Mounted Device with an Adjustable Opacity System”) discloses a head-mounted device with an adjustable opacity system which includes a photochromic layer. U.S. patent application publication 20190384062 (Wilson et al., Dec. 19, 2019, “Electronic Devices Having Electrically Adjustable Optical Layers”) discloses an electronic device which can reduce light transmission for an electrically adjustable optical layer to hide optical components, can increase light transmission to reveal the optical components while the optical components are being used to receive light or to output light, and can otherwise adjust the electrically adjustable optical layer to exhibit a desired set of optical characteristics depending on the mode of operation of the electronic device.

U.S. patent application publication 20200166756 (DeLapp et al., May 28, 2020, “Displays with Volume Phase Gratings”) discloses an electronic device with holographic gratings in a waveguide that have fringes with constant pitch and variable period. U.S. patent application publication 20200174255 (Hollands et al., Jun. 4, 2020, “Optical Systems with Multi-Layer Holographic Combiners”) discloses an optical system with first hologram structures that replicate light over multiple output angles onto second hologram structures. U.S. patent application publication 20200393718 (Bayat et al., Dec. 17, 2020, “Display System with Localized Optical Adjustments”) discloses an adjustable optical component with first and second electrodes and an electrically-adjustable material between the first and second electrodes.

U.S. patent application publication 20220011496 (Bhakta et al., Jan. 13, 2022, “Optical Systems Having Gradient Index Optical Structures”) discloses an electronic device which puts a grin on your face. U.S. patent application publication 20220026742 (Gill et al., Jan. 27, 2022, “Tunable and Foveated Lens Systems”) discloses adjustable lenses which include electrically-modulated optical material such as liquid crystal cells. U.S. patent application publication 20220082836 (Qin, Mar. 17, 2022, “Thin Near-To-Eye Display Device with Large Field of View Angle”) discloses a thin near-to-eye display device with two or more radial reflection units.

U.S. patent application publication 20230213769 (Sharlin et al., Jul. 6, 2023, “Active Optical Engine”), U.S. patent application publication 20230384601 (Sharlin et al., Nov. 30, 2023, “Active Optical Engine”), and U.S. patent application publication 20250053012 (Sharlin et al., Feb. 13, 2025, “Active Optical Engine”) disclose an apparatus with a processor which determines a target coupling-out facet, identifies an optical path to the target coupling-out facet, identifies an active wave plate corresponding to the optical path, determines a target state of the active wave plate that corresponds to the optical path, sets the active wave plate to the identified target state, and causes a projection device to project a light beam comprising an image field of view component along the identified optical path.

U.S. patent Ser. No. 11/741,861 (Grabarnik et al., Aug. 29, 2023, “Optical System Including Selectively Activatable Facets”), U.S. patent application publication 20230351930 (Grabarnik et al., Nov. 2, 2023, “Optical System Including Selectively Activatable Facets”), and U.S. patent application publication 20250239190 (Grabarnik et al., Jul. 24, 2025, “Optical System Including Selectively Activatable Facets”) disclose an apparatus with a processor which determines a target portion of an eye motion box and identifies a facet of a light-guide optical element to direct a light beam comprising an image field of view toward the target portion of the eye motion box.

U.S. patent application publication 20240036342 (Ouderkirk et al., Feb. 1, 2024, “Reflective Fresnel Folded Optic Display”) discloses an optical apparatus with a display, a first lens assembly including a lens and a reflector, and a second lens assembly including a second lens and a second reflector. U.S. patent application publication 20240053818 (Cross et al., Feb. 15, 2024, “Reconfigurable Headset That Transitions Between Virtual Reality, Augmented Reality, and Actual Reality”) and U.S. patent application publication 20250216929 (Cross et al., Jul. 3, 2025, “Reconfigurable Headset That Transitions Between Virtual Reality, Augmented Reality, and Actual Reality”) disclose a method for switching a configuration of an enhanced reality headset.

U.S. patent application publication 20240192529 (Oh et al., Jun. 13, 2024, “Spatially-Patterned Switchable LC Waveplates for a Wide Viewing Aperture”) discloses a switchable waveplate with a substrate, a first electrode layer on the substrate, an alignment layer on the first electrode layer and including alignment patterns formed thereon, a liquid crystal layer on the alignment layer, and a second electrode layer on the liquid crystal layer. U.S. patent application publication 20240377691 (Sears et al., Nov. 14, 2024, “Optical Devices and Methods for Adjustable Light Attenuation Based on Optical Scattering”) discloses an optical device with an optically-dimmable filter for providing a first set of scattering properties while the optically-dimmable filter is in a first state and providing a second set of scattering properties while the first optically-dimmable filter is in a second state.

U.S. patent application publication 20240377693 (Sears et al., Nov. 14, 2024, “Optical Devices and Methods for Adjustable Light Attenuation Based on Anisotropic Materials”) discloses an optical device with a first set of electrodes; a second set of electrodes distinct and separate from the first set of electrodes; and a medium located between the first set of electrodes and the second set of electrodes. U.S. patent application publication 20250036201 (Zimmerman et al., Jan. 30, 2025, “Head Mountable Display”) discloses an optical module with a first camera disposed adjacent an inner edge and closer to the lower edge than the upper edge, and a second camera disposed adjacent the lower edge and closer to the outer edge than the inner edge.

U.S. patent application publication 20250093567 (Born et al., Mar. 20, 2025, “Waveguide Display Having Gratings with Continuous Phase Shifting”) discloses a display with a waveguide that directs image light to an eye box, including a surface relief grating (SRG) having a pitch that varies continuously along an axis. U.S. patent application publication 20250110341 (Zimmerman et al., Apr. 3, 2025, “Head Mountable Display”) discloses a head-mountable display device with a mounting bracket coupled to a first side of a structural frame.

U.S. patent application publication 20250258376 (Rone et al., Aug. 14, 2025, “A Novel Near Eye Display Optical System”) discloses a near-eye display optical system with partially-reflective internal surfaces along an arrangement axis at angles relative to the arrangement axis. U.S. patent application publication 20260010001 (Danziger, Jan. 8, 2026, “Novel Waveguide System for a Near-Eye Display”) discloses a waveguide system for a near-eye display with a first waveguide section and a second waveguide section.

### SUMMARY OF THE INVENTION

Disclosed herein are optical structures for augmented reality eyewear with a dynamic waveguide, wherein the dynamic waveguide has an array of individually-movable reflective components or an array of adjustable-reflectivity components. These optical structures enable a person to see a bright, opaque virtual object in a portion of their field of view and also see their environment clearly in the rest of their field of view.

### BRIEF INTRODUCTION TO THE FIGURES

FIG. 1 shows augmented reality eyeglasses with a vertically-pivoting waveguide.

FIG. 2 shows augmented reality eyeglasses with a waveguide on a transparent rotatable component.

FIG. 3 shows augmented reality eyeglasses with a laterally-pivoting and sliding waveguide.

FIG. 4 shows augmented reality eyeglasses with a plurality of vertically-converging waveguides.

FIG. 5 shows augmented reality eyeglasses with a plurality of radially-converging waveguides.

FIG. 6 shows augmented reality eyeglasses with overlapping right side and left side waveguides.

FIG. 7 shows augmented reality eyeglasses with a dynamic waveguide having an adjustable thickness.

FIG. 8 shows augmented reality eyeglasses with a dynamic waveguide having an adjustable-angle wedge shape.

FIG. 9 shows augmented reality eyeglasses with a dynamic waveguide including movable reflective components which can be selectively and independently moved.

FIG. 10 shows augmented reality eyeglasses with a dynamic waveguide whose proximal and distal walls can be shifted relative to each other.

FIG. 11 shows augmented reality eyeglasses with a dynamic waveguide including movable micro-scale, nano-scale, and/or molecular-level reflective objects whose orientations are changed by the application of electromagnetic energy.

FIG. 12 shows augmented reality eyeglasses with a dynamic waveguide including a plurality of movable spherical reflective objects.

FIG. 13 shows augmented reality eyeglasses with arcuate movable reflective components.

FIG. 14 shows augmented reality eyeglasses with annular-section-shaped movable reflective components.

FIG. 15 shows augmented reality eyeglasses with hexagonal movable reflective components.

FIG. 16 shows augmented reality eyeglasses with a longitudinal array of selectively-movable reflective components.

FIG. 17 shows augmented reality eyeglasses with movable reflective components which are moved by transmission of electrical energy through electroconductive pathways.

FIG. 18 shows augmented reality eyeglasses with movable reflective components which are moved by changes in an electromagnetic field.

FIG. 19 shows augmented reality eyeglasses with movable reflective components which are moved by an acoustic wave.

FIG. 20 shows augmented reality eyeglasses with a diagonally-staggered rows of reflective components.

FIG. 21 shows augmented reality eyeglasses wherein moveable reflective components are pivoted, tilted, and/or rotated by electrical energy transmission.

FIGS. 22 and 23 show an optical structure for augmented reality eyeglasses comprising a grid of selectively-movable reflective components.

FIGS. 24 through 27 show an optical structure for augmented reality eyeglasses comprising an array of adjustable-reflectivity optical components.

### DETAILED DESCRIPTION OF THE FIGURES

In an example, augmented reality eyewear can comprise: an eyewear frame which is configured to be worn by a person; a transparent optical structure which is configured to be held in front of one of the person's eyes by the frame; a plurality of light displays located around at least a portion of the circumference of the transparent optical structure; and a plurality of waveguides which transmit light rays from the light displays to locations on the transparent optical structure, wherein the light rays exit the transparent optical structure from the locations toward the person's eye. In an example, the eyewear can be a pair of eyeglasses. In an example, the transparent optical structure can be a lens. In an example, the waveguides can be shaped like wedges and/or pie slices. In an example, two or more of the waveguides can overlap in a central area of the optical structure.

In an example, an optical structure for augmented reality eyewear can comprise: an optical structure which is configured to be worn in front of a person's eye; a light display; an array of individually-movable reflective components in the optical structure; and a plurality of electroconductive pathways; wherein the optical structure has a first configuration in which a first subset of reflective components has a first orientation which reflects light from the display toward the person's eye and other reflective components have one or more second orientations which do not reflect light from the display toward the person's eye, wherein the optical structure has a second configuration in which a second subset of reflective components has a first orientation which reflects light from the display toward the person's eye and other reflective components have one or more second orientations which do not reflect light from the display toward the person's eye, and wherein the optical structure is changed from the first configuration to the second configuration, or vice versa, by transmission of electrical energy through the electroconductive pathways.

In an example, the optical structure can be a lens or waveguide. In an example, an individually-movable reflective component can be a pivoting and/or rotating micromirror. In an example, a reflective component having a first orientation can intersect a line of sight extending out from a person's eye. In an example, a reflective component having a first orientation can reduce or block light from the environment from passing through the optical structure to reach the person's eye. In an example, a reflective component having a second orientation can be substantially-parallel to a line of sight extending out from the person's eye. In an example, a reflective component having a second orientation can allow light from the environment to pass through the optical structure and reach the person's eye. In an example, transmission of electrical energy through a selected subset of electroconductive pathways can cause a selected subset of reflective components to pivot and/or rotate from the first orientation to the second orientation, or vice versa.

In an example, an optical structure for augmented reality eyewear can comprise: an optical structure which is configured to be worn in front of a person's eye; a light display; an array of individual adjustably-reflective components in the optical structure; and a plurality of electroconductive pathways; wherein the optical structure has a first configuration in which a first subset of adjustable-reflectivity components has a first level of reflectivity and reflects light from the display toward the person's eye, while other adjustable-reflectivity components have a second level of reflectivity, wherein the second level is less than the first level; wherein the optical structure has a second configuration in which a second subset of adjustable-reflectivity components has the first level of reflectivity and reflects light from the display toward the person's eye, while other adjustably-reflective components have the second level of reflectivity; and wherein the optical structure is changed from the first configuration to the second configuration, or vice versa, by transmission of electrical energy through the electroconductive pathways.

In an example, the optical structure can be a lens or waveguide. In an example, an adjustable-reflectivity component can be an electrochromic mirror or optical grating. In an example, an adjustable-reflectivity component having a first level of reflectivity can reduce or block light from the environment from passing through the optical structure to reach the person's eye. In an example, an adjustable-reflectivity component having a first level of reflectivity can be substantially reflective. In an example, an adjustable-reflectivity component having a second level of reflectivity can allow light from the environment to pass through the optical structure and reach the person's eye. In an example, an adjustable-reflectivity component having a second level of reflectivity can be substantially transparent. In an example, transmission of electrical energy through a selected subset of electroconductive pathways can cause a selected subset of adjustable-reflectivity reflective components to change from the first level of reflectivity to the second level of reflectivity, or vice versa.

In an example, augmented reality eyewear can be a pair of eyeglasses. In an example, augmented reality eyewear can comprise a light display (e.g. array of light emitters) on an eyewear frame, wherein light from the light display shows a virtual object in the person's field of view. In an example, an optical structure for augmented reality eyewear can comprise: an optical structure (e.g. lens and/or waveguide) which is configured to be worn in front of one of a person's eyes; an array of individually-adjustable-reflectivity components (e.g. micromirrors or gratings which can be made reflective or transparent) in the optical structure; a first light-emitting display which is on a lateral side (e.g. to the right or left) of the display; and a second light-emitting display which above the display; wherein light rays from the first light-emitting display and the second light-emitting display are guided by the array toward the person's eye.

In an example, an optical structure for augmented reality eyewear can comprise: an optical structure (e.g. lens) which is configured to be worn in front of a person's eye; a first display; a second display; a first waveguide which guides light rays from the first display to a first area of the optical structure from which light rays exit the optical structure toward the person's eye; and a second waveguide which guides light rays from the second display to a second area of the optical structure from which light rays exit the optical structure toward the person's eye, wherein light rays from the first display and light rays from the second display combine to form a virtual image in the person's field of view. In another example, augmented reality eyewear (e.g. eyeglasses) can comprise: an eyewear (e.g. eyeglasses) frame which is configured to be worn by a person; an optical structure (e.g. lens or waveguide) which is configured to be held in front of one of the person's eyes by the frame; a plurality of light displays located around at least a portion of the circumference of the optical structure; and a plurality of micromirror arrays which transmit light rays from the light emitters to locations on the optical structure, wherein light rays from the light emitters exit the optical structure from the locations toward the person's eye.

In an example, augmented reality eyewear (e.g. eyeglasses) can comprise: an eyewear (e.g. eyeglasses) frame which is configured to be worn by a person; an optical structure (e.g. lens) which is configured to be held in front of one of the person's eyes by the frame; a plurality of light displays located around at least a portion of the circumference of the optical structure; and a plurality of waveguides which transmit light rays from the light displays to locations on the optical structure, wherein light rays from the light emitters exit the optical structure from the locations toward the person's eye. In an example, augmented reality eyewear can comprise a circumferentially-distributed plurality of light displays (e.g. arrays of light emitters) on a frontpiece of an eyewear frame, wherein light from the displays shows one or more virtual objects in the person's field of view.

In one embodiment, augmented reality eyewear can comprise a light display (e.g. array of light emitters) on each of two sidepieces (e.g. temples) in an eyewear frame, wherein light from a light display is transmitted through a waveguide (e.g. by internal reflection) to a location on an optical structure (e.g. lens) in front of a person's eye and then escapes the waveguide toward the person's eye from that location. In another example, augmented reality eyewear can comprise a linear array of light displays which are activated to emit light sequentially. In an example, augmented reality eyewear can comprise a plurality of light displays around an optical structure (e.g. lens of waveguide) in front of a person's eye, wherein displays whose light is guided to a central location in the person's field of view are activated more frequently or continuously than displays whose light is guided to peripheral locations of the person's field of view.

In another example, augmented reality eyewear can comprise a plurality of light displays which are activated to emit light at different times. In an example, augmented reality eyewear can comprise a plurality of light displays which transmit light into a single waveguide. In an example, augmented reality eyewear can comprise a waveguide which transmits light from a first light display at a first location on an eyewear frontpiece when the waveguide is in a first configuration and transmits light from a second light display at a second location on the eyewear frontpiece when the waveguide is in a second configuration. In an example, augmented reality eyewear can comprise an arcuate array of light displays around an eye which are activated at different times (e.g. sequentially).

In another example, augmented reality eyewear can comprise an optical structure (e.g. lens) with a hub-and-spoke array of waveguides which transmit light from a plurality of light displays along peripheral-to-central vectors. In an example, augmented reality eyewear can comprise an optical structure (e.g. lens) with an array of trapezoidal and/or keystone-shaped waveguides which transmit light from a circumferential array of light displays along peripheral-to-central vectors toward the center of the optical structure. In another example, augmented reality eyewear can comprise two displays (e.g. arrays of light emitters), a first display to one side of a person's (e.g. on the nose bridge of eyeglasses) and a second display to the other side of the person's eye (e.g. on the sidepiece).

In one embodiment, augmented reality eyewear can further comprise a plurality of light displays (e.g. arrays of light emitters) on a frontpiece of an eyewear frame, wherein the displays are distributed around the circumference of an optical structure (e.g. lens), and wherein light from the displays show one or more virtual objects in the person's field of view. In an example, augmented reality eyewear can further comprise six light displays (e.g. arrays of light emitters) on a frontpiece of an eyewear frame, wherein the displays are distributed around the circumference of an optical structure (e.g. lens), and wherein light from the one or more displays shows one or more virtual objects in the person's field of view.

In an example, augmented reality eyewear with a plurality of paired (e.g. optically linked) light displays and waveguides. In an example, there can be four light displays which around the circumference of an optical structure (e.g. lens): one to the right, one to the left, one above, and one below the optical structure. In an example, there can be two light displays, one on either side (right and left) of an optical structure (e.g. lens or waveguide). In an example, augmented reality eyewear can comprise a light display on a frontpiece of the eyewear.

In an example, augmented reality eyewear can comprise a waveguide which guides light by total internal reflection. In one embodiment, augmented reality eyewear can comprise a waveguide wherein changing the angle between proximal and distal surfaces of a waveguide changes characteristics of virtual objects. In another example, augmented reality eyewear can comprise a waveguide wherein changing the angle between proximal and distal surfaces of a waveguide changes the resolution of a virtual object. In an example, augmented reality eyewear can comprise a waveguide wherein changing the width (e.g. thickness) of a waveguide changes the location of a virtual object. In another example, augmented reality eyewear can comprise a waveguide which guides light from a light emitter on a sidepiece (e.g. temple) of eyewear to a central location on an optical structure (e.g. lens) in front of a person's eye.

In an example, augmented reality eyewear can comprise a waveguide which has a quadrilateral (e.g. trapezoidal) shape. In an example, augmented reality eyewear can comprise a waveguide which transmits light from a light display to a central location on an optical structure (e.g. lens) in a first configuration, wherein light exits the waveguide toward a person's eye from the central location. In an example, augmented reality eyewear can comprise a waveguide whose central axis is substantially parallel to a central axis of a frontpiece of eyewear in a first configuration and intersects (a virtual extension of) the central axis of a frontpiece at an acute angle between 10 and 30 degrees in a second configuration.

In an example, augmented reality eyewear can comprise a waveguide, wherein changing the angle between proximal and distal surfaces of a waveguide changes the size of a virtual object. In an example, augmented reality eyewear can comprise an optical component with a (partially) reflective proximal surface which is closer to the person's eye and a (partially) reflective distal surface which is farther from the person's eye. In another example, augmented reality eyewear can include proximal and distal optical structures in front of a person's eye, wherein the proximal structure is a waveguide.

In one embodiment, augmented reality eyewear (e.g. eyeglasses) can comprise: an eyewear (e.g. eyeglasses) frame which is configured to be worn by a person; an optical structure (e.g. lens) which is configured to be held in front of one of the person's eyes by the frame, wherein the optical structure further comprises an arcuate (e.g. circular) rotatable component; and a waveguide on the arcuate rotatable component. In another example, augmented reality eyewear can comprise a waveguide which is contiguous with and/or adjacent to the circumference of an arcuate rotatable component.

In an example, augmented reality eyewear can comprise a waveguide, wherein the area of the waveguide is between 10% and 30% of the area of an arcuate rotatable component. In an example, augmented reality eyewear can comprise an arcuate rotatable component which is located on the distal (away from eye facing) surface of an optical structure (e.g. lens). In an example, augmented reality eyewear can comprise an arcuate rotatable component which rotates around a point which is between the center of an optical structure (e.g. lens or waveguide) and the side of the optical structure. In an example, augmented reality eyewear can include an arcuate rotatable component which is off-center on an optical structure (e.g. lens). In another example, augmented reality eyewear can include an arcuate rotatable component which spans between 30% and 60% of the area of an optical structure (e.g. lens).

In an example, augmented reality eyewear (e.g. eyeglasses) can comprise: an eyewear (e.g. eyeglasses) frame which is configured to be worn by a person; an optical structure (e.g. lens) which is configured to be held in front of one of the person's eyes by the frame; and a movable (e.g. pivoting) waveguide which spans a percentage of the area of the optical structure, wherein the waveguide has a first configuration which spans a central portion of the area of the optical structure, wherein the waveguide has a second configuration which does not span the central portion of the area of the optical structure, and wherein the waveguide is pivoted, tilted, and/or rotated from the first configuration to the second configuration, or vice versa.

In another example, augmented reality eyewear (e.g. eyeglasses) can comprise: an eyewear (e.g. eyeglasses) frame which is configured to be worn by a person; an optical structure (e.g. lens) which is configured to be held in front of one of the person's eyes by the frame; and a movable (e.g. pivoting) waveguide which spans between 10% and 30% of the area of the optical structure, wherein the waveguide has a first configuration which spans the center of the area of the optical structure, wherein the waveguide has a second configuration which does not span the center of the area of the optical structure, and wherein the waveguide is moved (e.g. pivoted, tilted, and/or rotated) from the first configuration to the second configuration, or vice versa.

In an example, augmented reality eyewear (e.g. eyeglasses) can comprise: an eyewear (e.g. eyeglasses) frame which is configured to be worn by a person; an optical structure (e.g. lens) which is configured to be held in front of one of the person's eyes by the frame; a light display which emits light that displays one or more virtual objects in the person's field of view; and a dynamic waveguide which transmits light rays from the light display to locations on the optical structure from which the light rays exit the waveguide toward the person's eye; wherein the waveguide further comprises a proximal micromirror array (e.g. proximal mirror wall) and a distal micromirror array (e.g. distal mirror wall), wherein the waveguide has a first configuration with a first width (e.g. thickness), wherein the waveguide has a second configuration with a second width (e.g. thickness), and wherein the second width (e.g. thickness) is greater than the first width (e.g. thickness).

In another example, augmented reality eyewear (e.g. eyeglasses) can comprise: an eyewear (e.g. eyeglasses) frame which is configured to be worn by a person; an optical structure (e.g. lens) which is configured to be held in front of one of the person's eyes by the frame; a sidepiece (e.g. temple) of the frame; a movable waveguide; wherein the movable waveguide has a first configuration which is parallel to the sidepiece, wherein the movable waveguide has a second configuration which is perpendicular to sidepiece and does not overlap the optical structure, and wherein the movable waveguide has a third configuration which is perpendicular to the sidepiece and overlaps (e.g. inserted into and/or in front of) the optical structure.

In one embodiment, augmented reality eyewear can comprise a joint (or hinge) around which a movable waveguide is pivoted and/or rotated from a configuration to a second configuration. In an example, augmented reality eyewear can comprise a movable waveguide which fits into a recess or opening on a sidepiece so that it is not snagged on an environmental object. In an example, augmented reality eyewear can comprise a movable waveguide which is inserted into an optical structure (e.g. lens) in front of a person's eye. In an example, augmented reality eyewear can comprise a movable waveguide which pivots around a point of rotation (e.g. an axle) which is less than 1 cm from the sidepiece of eyewear. In an example, augmented reality eyewear can comprise a movable waveguide which spans between 10% and 30% of the area of an optical structure (e.g. lens) in front of a person's eye when the waveguide is in a selected configuration.

In another example, augmented reality eyewear can comprise a movable waveguide which spans between 20% and 50% of the area of an optical structure (e.g. lens) which is held by eyewear in front of a person's eye. In an example, augmented reality eyewear can comprise a movable waveguide which spans between 25% and 40% of the area of the proximal surface of an optical structure (e.g. lens or waveguide) which is held by eyewear in front of a person's eye. In another example, augmented reality eyewear can comprise a movable waveguide which spans between 40% and 65% of the area of the proximal surface of an optical structure (e.g. lens) which is held by eyewear in front of a person's eye.

In an example, augmented reality eyewear can comprise a movable waveguide which spans from a side of an optical structure (e.g. lens) to the center of the optical structure in a first configuration and spans from the side of the optical structure to a lower peripheral portion (e.g. the bottom third) of the optical structure in a second configuration, wherein the waveguide is pivoted, tilted, and/or rotated from the first configuration to the second configuration, or vice versa. In one embodiment, augmented reality eyewear can comprise a movable waveguide which transmits light from a light display (e.g. array of light emitters) on a sidepiece of the eyewear to a location on the center of an optical structure (e.g. lens) in one configuration.

In an example, augmented reality eyewear can comprise a movable waveguide, wherein light from a light display is projected along a first set of vectors when the movable waveguide is in a first configuration and projected along a second set of vectors when the movable waveguide is in a second configuration. In one embodiment, augmented reality eyewear can comprise a waveguide at a first location in a first configuration and at a second location in a second configuration, wherein the second location is above the first location (e.g. when an optical structure is vertical). In another example, augmented reality eyewear can comprise a waveguide that is pivoted and/or rotated out from an eyewear sidepiece as it is moved from a first configuration to a second configuration.

In an example, augmented reality eyewear can comprise a waveguide which is located in the center of a person's field of view in a first configuration and located below the center of the person's field of view in a second configuration. In another example, augmented reality eyewear can comprise a waveguide which is moved from a first configuration to a second configuration by being pivoted and/or rotated around its front end. In an example, augmented reality eyewear can comprise a waveguide which transmits light from a light display to a central location on an optical structure (e.g. lens) in a first configuration and transmits light from the light display to a peripheral location on the optical structure in a second configuration, wherein the peripheral location is below the central location (when the optical structure is vertical).

In an example, augmented reality eyewear can comprise an optical structure (e.g. lens) with a gap, opening, recess, and/or compartment from the center of the structure to a side of the structure, wherein a movable waveguide is moved (e.g. pivoted, tilted, and/or rotated) within this gap, opening, recess, and/or compartment. In an example, augmented reality eyewear can comprise an optical structure wherein a posterior end of a moveable waveguide is pivoted and/or rotated outward and forward from an eyewear sidepiece as the waveguide is moved from a first configuration to a second configuration. In an example, augmented reality eyewear can comprise an optical structure with an inner opening, recess, compartment, and/or gap, wherein there is a movable (e.g. pivoting, tilting, or rotating) waveguide within this opening, recess, compartment, and/or gap.

In an example, augmented reality eyewear can comprise a plurality of waveguides which direct light from a single display. In another example, augmented reality eyewear can comprise a plurality of waveguides with pie-slice shapes. In an example, augmented reality eyewear can comprise a plurality of waveguides, wherein the waveguides transmit light along upper-to-lower and peripheral-to-central vectors. In another example, augmented reality eyewear can comprise first and second waveguides which are substantially parallel to each other.

In an example, augmented reality eyewear can comprise one or more actuators which move first and second waveguides from a first configuration to a second configuration, or vice versa. In an example, augmented reality eyewear can comprise wedge-shaped (e.g. pie-slice-shaped) waveguides. In one embodiment, augmented reality eyewear can comprise: a first waveguide which transmits light from a display on one side (e.g. left side) of an optical structure to portion of the upper circumference of the optical structure; and a second waveguide which further transmit this light downwards toward the center of the optical structure, wherein the first and second waveguides are optically coupled.

In an example, an optical structure for augmented reality eyewear can comprise: an optical structure (e.g. lens) which is configured to be worn in front of a person's eye; a first display; a second display; a first waveguide which guides light rays from the first display to a first area of the optical structure from which light rays exit the optical structure toward the person's eye; and a second waveguide which guides light rays from the second display to a second area of the optical structure from which light rays exit the optical structure toward the person's eye, wherein light rays from the first display and light rays from the second display overlap to form a virtual image in the person's field of view.

In an example, augmented reality eyewear can comprise a plurality of waveguides, wherein the size, shape, and/or location of a portion of a person's field of view which displays virtual objects can be changed (e.g. adjusted) by moving first and second waveguides from a first configuration to a second configuration, wherein the amount of overlap between the first and second waveguide is different in the first configuration than in the second configuration. In an example, augmented reality eyewear can comprise first and second waveguides, wherein the brightness and/or resolution of virtual objects can be changed (e.g. adjusted) by moving the first and second waveguides from a first configuration to a second configuration, wherein the amount of overlap between the first and second waveguide is different in the first configuration than in the second configuration.

In an example, augmented reality eyewear can comprise: a first display on the nose bridge of the eyewear; a second display on a sidepiece of the eyewear; a first horizontally-oriented waveguide which guides light from the first display to an eye; and a second horizontally-oriented waveguide which guides light from the second display to the eye, wherein the first waveguide and second waveguide overlap in a center of the field of view of the eye to increase the brightness and/or resolution of virtual objects display in the center of the field of view. In another example, the location of an area wherein waveguides in an optical structure overlap can be moved.

In an example, a first waveguide and a second waveguide can be changed from a first configuration to a second configuration by sliding one waveguide vertically onto the other waveguide. In another example, augmented reality eyewear (e.g. eyeglasses) can comprise: an eyewear (e.g. eyeglasses) frame which is configured to be worn by a person; an optical structure (e.g. lens) which is configured to be held in front of one of the person's eyes by the frame; and a movable (e.g. pivoting) waveguide which spans between 10% and 30% of the area of the optical structure, wherein the waveguide has a first configuration which spans the center of the area of the optical structure, wherein the waveguide has a second configuration which does not span the center of the area of the optical structure, and wherein the waveguide is slid from the first configuration to the second configuration, or vice versa.

In an example, augmented reality eyewear can comprise a moveable waveguide which is moved from one configuration to another configuration by being slid into (or onto) an optical structure (e.g. lens) in front of a person's eye. In another example, augmented reality eyewear can comprise a waveguide wherein shifting and/or sliding proximal and distal surfaces (or walls) of the waveguide relative to each other can change the brightness of a virtual object. In one embodiment, augmented reality eyewear can comprise a waveguide wherein shifting and/or sliding proximal and distal surfaces (or walls) of the waveguide relative to each other can change the size of a virtual object. In an example, augmented reality eyewear can comprise an optical structure wherein a first waveguide and a second waveguide are changed from a first configuration to a second configuration by sliding one waveguide horizontally over the other waveguide.

In an example, a waveguide can comprise a proximal array of reflective components (e.g. micromirrors) and a distal array of reflective components (e.g. micromirrors), wherein light is guided along the waveguide by being reflected back and forth between the proximal array and the distal array. In an example, augmented reality eyewear can comprise a waveguide wherein reflective components are micromirrors. In another example, augmented reality eyewear can comprise a waveguide wherein reflective surfaces are planar and/or flat. In an example, augmented reality eyewear can comprise a waveguide, wherein there are at least 10 reflective components in a cross-sectional plane of the waveguide.

In another example, a longitudinal array of movable reflective components can be adjacent to the distal surface of an optical structure in front of a person's eye. In an example, a waveguide can comprise a proximal array of movable reflective components (e.g. pivotable or rotatable micromirrors) and a distal array of movable reflective components (e.g. pivotable or rotatable micromirrors), wherein light is guided along the waveguide by being reflected back and forth between the proximal array and the distal array until it exits a gap in the proximal array toward a person's eye.

In one embodiment, an optical structure for augmented reality eyewear can comprise: an optical structure (e.g. lens and/or waveguide) which is configured to be worn in front of one of a person's eyes; a first array of individually movable reflective components (e.g. movable micromirrors or gratings) in the optical structure with a first longitudinal orientation; a second array of individually movable reflective components (e.g. movable micromirrors or gratings) in the optical structure with a second longitudinal orientation, wherein the second longitudinal orientation differs from the first longitudinal orientation by between 60 and 100 degrees; and a light-emitting display, wherein light from the display is guided through the first array and the second array toward the person's eye.

In an example, an optical structure for augmented reality eyewear can comprise: an optical structure (e.g. lens and/or waveguide) which is configured to be worn in front of one of a person's eyes; an array of individually-movable reflective components (e.g. pivotable or rotatable micromirrors, gratings, or suspended particles) in the optical structure; and a light-emitting display; wherein a series of components in the array are sequentially selected and oriented to reflect light from the display toward the person's eye while the rest of the components in the array are oriented to not reflect light from the display toward the person's eye.

In an example, an optical structure for augmented reality eyewear can comprise: an optical structure (e.g. lens and/or waveguide) which is configured to be worn in front of one of a person's eyes; an array of individually-movable reflective components (e.g. movable micromirrors, gratings, or suspended particles) in the optical structure; and a light-emitting display, wherein a selected subset of the components can be selectively changed by a plurality of actuators from a first configuration with first orientations (e.g. angles relative to the optical structure) which allow light from the environment to pass through the optical structure to a second configuration with second orientations (e.g. angles relative to the optical structure) which reflect light from the display toward the person's eye, or vice versa.

In an example, an optical structure for augmented reality eyewear can comprise: an optical structure (e.g. lens and/or waveguide) which is configured to be worn in front of one of a person's eyes; an array of movable reflective components (e.g. movable micromirrors or gratings) in the optical structure; and a light-emitting display, wherein a selected subset of one or more of the components has a first configuration in which they are angled to allow light from the environment to pass through the optical structure and a second configuration in which they are angled to reflect light from the display toward the person's eye.

In an example, augmented reality eyewear (e.g. eyeglasses) can comprise: an eyewear (e.g. eyeglasses) frame which is configured to be worn by a person; an optical structure (e.g. lens or waveguide) which is configured to be held in front of one of the person's eyes by the frame; and an array of movable reflective components. In another example, augmented reality eyewear can comprise a linear array of movable reflective components and a light display, wherein individual reflective components along the linear array can be sequentially moved (e.g. pivoted or rotated) out from the linear axis of the array (one at a time) in order to reflect light from the display toward a person's eye from different locations at different times.

In an example, augmented reality eyewear can comprise a movable reflective component, wherein this component is a movable micromirror. In another example, augmented reality eyewear can comprise a reflective component which rotates, tilts, or pivots around an axis between midpoints of two of its sides. In an example, augmented reality eyewear can comprise a selected subset of micromirrors and/or moveable reflective surfaces which are selectively and independently moved from a first configuration to a second configuration, or vice versa, by application of electromagnetic energy. In one embodiment, augmented reality eyewear can comprise a subset of movable reflective components in a section of an optical structure which are configured (e.g. moved and/or oriented) to selectively block environmental light from passing through this section and to reflect light from a light display toward a person's eye in order to display an opaque virtual object in the persons' field of view via that section.

In an example, augmented reality eyewear can comprise a waveguide, wherein a selected subset of reflective components in the waveguide can be moved (e.g. pivoted, tilted, and/or rotated) from a first configuration to a second configuration by exposure to electromagnetic (e.g. electrical) energy. In one embodiment, augmented reality eyewear can comprise an array of movable reflective components which are circular and planar (e.g. flat). In an example, augmented reality eyewear can comprise an array of movable reflective components which are planar (e.g. flat). In one embodiment, augmented reality eyewear can comprise movable reflective components which have annular-section shapes (e.g. like the shape of an area cleaned by a window wiper).

In another example, central axes of the movable reflective components can be rotatably-linked to each other along arcuate lines. In an example, light rays from a light display on a sidepiece (e.g. temple) of the eyewear frame can be reflected by (a subset of) movable reflective components in the array back toward a person's eye to display a virtual object in the person's field of view. In another example, movable reflective components can have arcuate perimeters. In an example, movable reflective components can have perimeters with shapes like the area cleared by a windshield wiper. In an example, reflective components can be rotatably connected by microwires or strands within a transparent reflective structure.

In an example, an optical structure for augmented reality eyewear can comprise: an optical structure (e.g. lens and/or waveguide) which is configured to be worn in front of one of a person's eyes; a first array of individually adjustable-reflectivity components (e.g. electrochromic micromirrors or gratings which each can be made either more reflective or more transparent) in the optical structure with a first longitudinal orientation; a second array of individually adjustable-reflectivity components (e.g. electrochromic micromirrors or gratings which each can be made either more reflective or more transparent) in the optical structure with a second longitudinal orientation, wherein the second longitudinal orientation differs from the first longitudinal orientation by between 40 and 70 degrees; and a light-emitting display, wherein light from the display is guided through the first array and the second array toward the person's eye.

In an example, an optical structure for augmented reality eyewear can comprise: an optical structure (e.g. lens and/or waveguide) which is configured to be worn in front of one of a person's eyes; a first array of individually adjustable-reflectivity components (e.g. electrochromic micromirrors or gratings which each can be made either more reflective or more transparent) in the optical structure; a second array of individually adjustable-reflectivity components (e.g. electrochromic micromirrors or gratings which each can be made either more reflective or more transparent) in the optical structure, wherein the first array and the second array intersect each other at an acute angle; and a light-emitting display, wherein light from the display is guided through the first array and the second array toward the person's eye.

In an example, an optical structure for augmented reality eyewear can comprise: an optical structure (e.g. lens and/or waveguide) which is configured to be worn in front of one of a person's eyes; an array of adjustably-reflective components (e.g. electrochromic micromirrors or gratings) in the optical structure; and a light-emitting display; wherein a lateral (e.g. right to left, or left to right) series of components in the array are sequentially made reflective and the rest of the components are made transparent, wherein the component that is reflective at a given time reflects light from the display toward the person's eye, and wherein components that are transparent at the given time do not reflect light from the display toward the person's eye.

In an example, an optical structure for augmented reality eyewear can comprise: an optical structure (e.g. lens and/or waveguide) which is configured to be worn in front of one of a person's eyes; an array of adjustably-reflective components (e.g. electrochromic micromirrors or gratings) in the optical structure; and a light-emitting display, wherein components in the array are selectively made more reflective (e.g. one at a time) to reflect light from the display toward the person's eye, and wherein the rest of the components in the array (at a given time) are selectively made more transparent.

In one embodiment, an optical structure for augmented reality eyewear can comprise: an optical structure (e.g. lens and/or waveguide) which is configured to be worn in front of one of a person's eyes; an array of individually adjustably-reflective components (e.g. electrochromic micromirrors or gratings) in the optical structure; and a light-emitting display, wherein components in the array can each selectively be made (relatively) reflective or (relatively) transparent, wherein at a given time only one selected component in the array is made reflective and the rest are made transparent so that light from the display is only reflected from the one selected component toward the person's eye.

In another example, an optical structure for augmented reality eyewear can comprise: an optical structure which is configured to be worn in front of a person's eye; a first array of (transparent) electroconductive pathways in (or on) the optical structure; a second array of (transparent) electroconductive pathways in (or on) the optical structure; and an array of variable-reflectivity components between the first array and the second array, wherein individual components in the array have a first configuration or state in which they have a first (e.g. low) level of reflectivity, wherein individual components in the array have a second configuration or state in which they have a second (e.g. high) level of reflectivity, wherein the second level is greater than the first level, and wherein individual components in the array are changed from the first configuration or state to the second configuration or state by transmission of electrical energy through the first array of electroconductive pathways and/or through the second array of electroconductive pathways.

In an example, an optical structure for augmented reality eyewear can comprise: an optical structure which is configured to be worn in front of a person's eye; a light display; a plurality of electroconductive pathways; an array of variable-reflectivity components in the optical structure, wherein each variable-reflectivity component in the array can have a first state with a first (e.g. low) level of reflectivity, wherein each variable-reflectivity component in the array can have a second state with a second (e.g. high) level of reflectivity, and wherein a variable-reflectivity component is changed from the first state to the second state, or vice versa, by transmission of electrical energy through the electroconductive pathways; and a data processor which controls which variable-reflectivity components are in the first state and which variable-reflectivity components are in the second state.

In another example, an optical structure for augmented reality eyewear can comprise: an optical structure which is configured to be worn in front of a person's eye; a light display; and an array of independently-adjustable variable-reflectivity components in the optical structure; wherein individual components in the array can have a first configuration or state in which they function as a mirror (reducing or blocking light from the environment from passing through a local area of the optical structure toward the person's eye and reflecting light from the display toward the person's eye); wherein individual components in the array can have a second configuration or state in which they are transparent (transmitting light from the environment through the local area of the optical structure toward the person's eye and not reflecting light from the display toward the person's eye); and wherein a component is changed from the first configuration or state to the second configuration or state by the transmission of electrical energy.

In an example, augmented reality eyewear can comprise a linear array of adjustably-reflective components (e.g. electrochromic mirrors) and a light display which is colinear with the array, wherein the reflectivity levels of individual components along the linear array can be sequentially changed (e.g. made more reflective) by the transmission of electrical energy in order to reflect light from the display toward a person's eye from different locations at different times. In another example, augmented reality eyewear can comprise a planar array of adjustably-reflective components (e.g. electrochromic mirrors) and a light display, wherein the reflectivity levels of individual components can be sequentially changed (e.g. made more reflective) by the transmission of electrical energy in order to reflect light from the display toward a person's eye from different locations at different times.

In an example, an optical structure for augmented reality eyewear can comprise: an optical structure (e.g. lens and/or waveguide) which is configured to be worn in front of one of a person's eyes; a light-emitting display; a first array of longitudinal transflective (e.g. partially transparent and partially reflective) components (e.g. transflective micromirrors or gratings) in the optical structure with a first longitudinal orientation (e.g. first angle); and a second array of longitudinal transflective (e.g. partially transparent and partially reflective) components (e.g. transflective micromirrors or gratings) in the optical structure with a second longitudinal orientation (e.g. second angle), wherein the first longitudinal orientation (e.g. first angle) and the second longitudinal orientation (e.g. second angle) differ by between 30 and 60 degrees.

In an example, an optical structure for augmented reality eyewear can comprise: an optical structure (e.g. lens and/or waveguide) which is configured to be worn in front of one of a person's eyes; a light-emitting display; a first array of transflective (e.g. partially transparent and partially reflective) components (e.g. transflective micromirrors or gratings) in the optical structure with a first orientation (e.g. first angle); and a second array of transflective (e.g. partially transparent and partially reflective) components (e.g. transflective micromirrors or gratings) in the optical structure with a second orientation (e.g. second angle), wherein the first orientation (e.g. first angle) and the second orientation (e.g. second angle) differ by between 30 and 60 degrees.

In an example, an optical structure for augmented reality eyewear can comprise: an optical structure (e.g. lens and/or waveguide) which is configured to be worn in front of one of a person's eyes; a light-emitting display; an array of transflective (e.g. partially transparent and partially reflective) components (e.g. transflective micromirrors or gratings) in the optical structure, wherein transflective components which are closer to the display are more transparent and less reflective than transflective components which are farther from the display.

In an example, a variable-reflectivity component (e.g. electrochromic micromirror) can be made from layered thin-film materials. In one embodiment, a variable-reflectivity component can be made with nickel oxide. In an example, a variable-reflectivity component can comprise an electrochromic glass structure. In another example, a variable-reflectivity component can made from tin oxide that has been doped with fluorine. In one embodiment, a variable-reflectivity component can with indium tin oxide and silver. In another example, a variably-reflective component can be made with tungsten oxide.

In an example, a variably-reflective component can comprise a redox-active layer. In an example, application of voltage to a variable-reflectivity component can move ions and electrons within it, thereby changing its level of reflectivity. In an example, the reflectivity level of a variable-reflectivity component can be changed by a redox reaction. In an example, the reflectivity level of a variable-reflectivity component can be changed by applying voltage to it from electroconductive pathways.

In an example, augmented reality eyewear can comprise a proximal array of micromirrors (closer to a person's eye) and a distal array of micromirrors (farther from the person's eye). In another example, augmented reality eyewear can comprise a waveguide, wherein reflective components are configured in a three-dimensional grid or matrix. In an example, augmented reality eyewear can comprise a waveguide, wherein reflective components in the waveguide are arrayed in rows (parallel to the longitudinal axis of the waveguide) and diagonal vectors (intersecting the longitudinal axis of the waveguide at acute angles).

In another example, centroids of reflective components in a first subset of diagonally-staggered rows which is closer to a light display can be aligned along vectors which intersect a longitudinal axis of an optical structure (e.g. lens or waveguide) at a first angle, centroids of reflective components in a second subset of diagonally-staggered rows which is farther from the light display can be aligned along vectors which intersect the longitudinal axis at a second angle, and the second angle can be greater than the first angle.

In one embodiment, an optical structure for augmented reality eyewear can comprise: an optical structure (e.g. lens and/or waveguide) which is configured to be worn in front of one of a person's eyes; a coplanar array of individually adjustable-reflectivity components (e.g. electrochromic micromirrors or gratings which each can be made either more reflective or more transparent) in the optical structure; and a light-emitting display, wherein light from the display is guided by the array toward the person's eye.

In an example, an optical structure for augmented reality eyewear can comprise: an optical structure (e.g. lens and/or waveguide) which is configured to be worn in front of one of a person's eyes; a coplanar array of individually-movable reflective components (e.g. movable micromirrors, gratings, or suspended particles) in the optical structure; and a light-emitting display, wherein a selected subset of the components can be selectively changed from a first configuration with first orientations (e.g. angles relative to the optical structure) which allow light from the environment to pass through the optical structure to a second configuration with second orientations (e.g. angles relative to the optical structure) which reflect light from the display toward the person's eye, or vice versa.

In one embodiment, an optical structure for augmented reality eyewear can comprise: an optical structure (e.g. lens and/or waveguide) which is configured to be worn in front of one of a person's eyes; a planar array of individually adjustably-reflective components (e.g. electrochromic micromirrors or gratings which can be made more reflective or more transparent) in the optical structure; and a light-emitting display which is coplanar with the array; wherein the array has a first configuration in which a first selected component in the array is reflective and the rest of the components in the array are transparent, wherein the array has a second configuration in which a second selected component in the array is reflective and the rest of the components in the array are transparent, wherein light from the display is only reflected by the first selected component toward the person's eye in the first configuration, and wherein light from the display is only reflected by the second selected component toward the person's eye in the second configuration.

In an example, augmented reality eyewear can comprise a planar array of adjustably-reflective components (e.g. electrochromic mirrors) and a light display which is coplanar with the array, wherein the reflectivity levels of individual components can be sequentially changed (e.g. made more reflective) by the transmission of electrical energy in order to reflect light from the display toward a person's eye from different locations at different times. In another example, augmented reality eyewear can comprise a waveguide with an array or series of reflective components which are coplanar in a cross-sectional plane of the waveguide. In an example, augmented reality eyewear can comprise a waveguide with array or series of reflective components which are coplanar in a plane which intersects the longitudinal axis of the waveguide at an acute angle.

In an example, an optical structure for augmented reality eyewear can comprise: an optical structure (e.g. lens and/or waveguide) which is configured to be worn in front of one of a person's eyes; a concave array of individually-adjustably-reflective components (e.g. micromirrors or gratings which can be made reflective or transparent) in the optical structure; and a light-emitting display which is proximal (e.g. closer to the eye) relative to the array, wherein light from the display is guided by the array toward the person's eye.

In an example, an optical structure for augmented reality eyewear can comprise: an optical structure (e.g. lens and/or waveguide) which is configured to be worn in front of one of a person's eyes; a concave array of individually-movable reflective components (e.g. selectively pivotable or rotatable micromirrors or gratings) in the optical structure; and a light-emitting display, wherein light from the display is guided by the array toward the person's eye, and wherein the display is proximal (e.g. closer to the eye) relative to the array. In an example, an optical structure for augmented reality eyewear can comprise: an optical structure (e.g. lens and/or waveguide) which is configured to be worn in front of one of a person's eyes; a concave array of individually-movable reflective components (e.g. movable micromirrors or gratings) in the optical structure; and a light-emitting display which is proximal (e.g. closer to the eye) relative to the array, wherein light from the display is guided by the array toward the person's eye.

In an example, an optical structure for augmented reality eyewear can comprise: an optical structure (e.g. lens and/or waveguide) which is configured to be worn in front of one of a person's eyes; a first array of individually movable reflective louvers (e.g. movable micromirrors or gratings) in the optical structure with a first longitudinal orientation; a second array of individually movable reflective louvers (e.g. movable micromirrors or gratings) in the optical structure with a second longitudinal orientation, wherein the second longitudinal orientation differs from the first longitudinal orientation by between 40 and 70 degrees; and a light-emitting display, wherein light from the display is guided through the first array and the second array toward the person's eye.

In an example, an optical structure for augmented reality eyewear can comprise: an optical structure (e.g. lens and/or waveguide) which is configured to be worn in front of one of a person's eyes; an array of individually adjustable-reflectivity horizontal components (e.g. horizontal electrochromic micromirrors or gratings which each can be made either more reflective or more transparent) in the optical structure; and a light-emitting display, wherein light from the display is guided by the array toward the person's eye, and wherein the display is coplanar with the array.

In an example, an optical structure for augmented reality eyewear can comprise: an optical structure (e.g. lens and/or waveguide) which is configured to be worn in front of one of a person's eyes; an array of individually-movable reflective horizontal components (e.g. selectively pivotable or rotatable horizontal micromirrors or gratings) in the optical structure; and a light-emitting display, wherein light from the display is guided by the array toward the person's eye, and wherein the display is proximal (e.g. closer to the eye) relative to the array.

In another example, an optical structure for augmented reality eyewear can comprise: an optical structure (e.g. lens and/or waveguide) which is configured to be worn in front of one of a person's eyes; an array of individually adjustable-reflectivity vertical components (e.g. vertical electrochromic micromirrors or gratings which each can be made either more reflective or more transparent) in the optical structure; and a light-emitting display, wherein light from the display is guided by the array toward the person's eye, and wherein the display is distal (e.g. farther from the eye) relative to the array. In one embodiment, augmented reality eyewear can comprise a waveguide which transmits light primarily in a vertical (e.g. upper to lower) direction.

In another example, augmented reality eyewear can comprise a waveguide with reflective components which are made with ferrous and/or magnetic material so that application of electromagnetic energy changes their orientations. In an example, the orientations of a selected subset of reflective components in an array can be selectively and independently changed by exposing the reflective components in that subset to electromagnetic (e.g. electrical) energy.

In another example, augmented reality eyewear can comprise a waveguide wherein the longitudinal axes of reflective components in a selected section of the waveguide are aligned with lines of sight from a person's eye in one configuration. In an example, augmented reality eyewear can comprise an array of individually-and-selectively movable reflective components (e.g. pivoting or rotating micromirrors) wherein the components each have a first configuration which is substantially parallel to lines of sight extending out from a person's eye (thereby allowing light from the environment to pass through an optical structure to a person's eye) and a second configuration which intersects these lines of sight (thereby reflecting light from a light display toward the person's eye), where a selected subset of components in the array can be individually changed from the first configuration to the second configuration, or vice versa, by the selective transmission of electrical energy through a subset of electroconductive pathways.

In an example, an optical structure for augmented reality eyewear can comprise: an optical structure (e.g. lens and/or waveguide) which is configured to be worn in front of one of a person's eyes; a light-emitting display; an array of transflective (e.g. partially transparent and partially reflective) components (e.g. transflective micromirrors or gratings) in the optical structure, wherein the orientations (e.g. angles) of transflective components vary as a function of distance from the display. In an example, an optical structure for augmented reality eyewear can comprise: an optical structure (e.g. lens and/or waveguide) which is configured to be worn in front of one of a person's eyes; a light-emitting display; an array of transflective (e.g. partially transparent and partially reflective) components (e.g. transflective micromirrors or gratings) in the optical structure, wherein the reflectivity levels of transflective components vary as a function of distance from the display.

In an example, an optical structure for augmented reality eyewear can comprise: an optical structure (e.g. lens and/or waveguide) which is configured to be worn in front of one of a person's eyes; a light-emitting display; an array of transflective (e.g. partially transparent and partially reflective) components (e.g. transflective micromirrors or gratings) in the optical structure, wherein the widths of transflective components vary as a function of distance from the display. In an example, an optical structure for augmented reality eyewear can comprise: an optical structure (e.g. lens and/or waveguide) which is configured to be worn in front of one of a person's eyes; a light-emitting display; an array of transflective (e.g. partially transparent and partially reflective) components (e.g. transflective micromirrors or gratings) in the optical structure, wherein transparency levels of the transflective components decrease with distance from the display.

In an example, an optical structure for augmented reality eyewear can comprise: an optical structure (e.g. lens and/or waveguide) which is configured to be worn in front of one of a person's eyes; an array of individually adjustably-reflective components (e.g. electrochromic micromirrors or gratings which can be made more reflective or more transparent) in the optical structure; and a light-emitting display; wherein the array has a first configuration in which a first selected component in the array is reflective and the rest of the components in the array are transparent, wherein the array has a second configuration in which a second selected component in the array is reflective and the rest of the components in the array are transparent, wherein light from the display is only reflected by the first selected component toward the person's eye in the first configuration, wherein light from the display is only reflected by the second selected component toward the person's eye in the second configuration, and wherein a series of components in the array with increasing distance from the display are sequentially-selected to be made reflective.

In an example, an optical structure for augmented reality eyewear can comprise: an optical structure (e.g. lens and/or waveguide) which is configured to be worn in front of one of a person's eyes; an array of partially-reflective components (e.g. transflective micromirrors or gratings) in the optical structure; and a light-emitting display, wherein light from the display is guided by the array toward the person's eye, and wherein the distance between components in the array decreases with distance from the display. In one embodiment, an optical structure for augmented reality eyewear can comprise: an optical structure (e.g. lens and/or waveguide) which is configured to be worn in front of one of a person's eyes; an array of partially-reflective components (e.g. transflective micromirrors or gratings) in the optical structure; and a light-emitting display, wherein light from the display is guided by the array toward the person's eye, and wherein the angles of components relative to the optical structure varies with distance from the display.

In another example, augmented reality eyewear (e.g. eyeglasses) can comprise: an optical structure (e.g. lens or waveguide) which is configured to be worn by a person in front of one of the person's eyes; an array of reflective components within the optical structure, wherein the array consists of a plurality of diagonally-staggered rows of reflective components, and wherein the angles at which the diagonally-staggered rows intersect a longitudinal axis of the optical structure vary with distance from the light display; and a light display which emits light rays which are reflected by the reflective components toward the person's eye in order to display a virtual object in the person's field of view.

In an example, augmented reality eyewear can comprise a plurality (e.g. stack) of reflective components in a cross-sectional plane of a waveguide, wherein the cross-sectional plane is orthogonal to the longitudinal axis of the waveguide. In another example, augmented reality eyewear can comprise a waveguide wherein different reflective components and/or different stacks of reflective components in different locations are selectively moved (e.g. reoriented) at different times by transmission of electromagnetic energy (e.g. electrical energy) to different locations of the waveguide at different times. In one embodiment, augmented reality eyewear can comprise a waveguide, wherein selectively moving (e.g. reorienting) different reflective components (or stacks of reflective components) in the waveguide at different locations at different times enables displaying virtual objects at different locations at different times.

In an example, augmented reality eyewear can comprise a waveguide wherein reflective components are configured in hub-and-spoke array. In an example, augmented reality eyewear can comprise a waveguide, wherein reflective components in the waveguide are arrayed in rows (parallel to the longitudinal axis of the waveguide) and columns (perpendicular to the longitudinal axis of the waveguide). In an example, augmented reality eyewear can comprise a waveguide with reflective components which are flat and arcuate (e.g. circular). In an example, augmented reality eyewear can comprise a waveguide, wherein there are at least 10 spherical reflective components in a cross-sectional plane of the waveguide.

In an example, augmented reality eyewear can comprise a grid and/or matrix of transparent electroconductive pathways which is distal to an optical structure (e.g. lens or waveguide). In another example, augmented reality eyewear can comprise a grid or matrix of transparent electroconductive pathways which are parallel to an optical structure (e.g. lens or waveguide). In an example, augmented reality eyewear can include a hub-and-spoke array of electroconductive pathways. In another example, augmented reality eyewear can include electroconductive pathways which are shaped like annular sections.

In an example, an optical structure for augmented reality eyewear can comprise: an eyewear (e.g. eyeglasses) frame which is configured to be worn by a person; an optical structure (e.g. lens and/or waveguide) which is configured to be worn in front of one of a person's eyes; a light-emitting display; an array of individually adjustable-reflectivity components (e.g. electrochromic micromirrors or gratings which each can be made either more reflective or more transparent) in the optical structure, wherein the optical structure has a first configuration at a first time wherein a selected subset of components are reflective and the rest of the components are transparent, wherein the optical structure has a second configuration at a second time wherein a selected subset of components are reflective and the rest of the components are transparent, and wherein reflective components reflect light from the display toward the person's eye; and a grid of transparent electroconductive pathways, wherein transmission of electrical energy through a subset of the pathways changes the optical structure from the first configuration to the second configuration.

In an example, an optical structure for augmented reality eyewear can comprise: an optical structure (e.g. lens and/or waveguide) which is configured to be worn in front of one of a person's eyes; a light-emitting display; a plurality of electroconductive pathways; and an array of individually-movable reflective components (e.g. pivotable or rotatable micromirrors, gratings, or suspended particles) in the optical structure, wherein the optical structure has a first configuration at a first time wherein a first selected subset of components have an orientation (e.g. angle) which reflects light from the display toward the person's eye and the rest of the components do not reflect light from the display toward the person's eye, wherein the optical structure has a second configuration at a second time wherein a second selected subset of components have an orientation (e.g. angle) which reflects light from the display toward the person's eye and the rest of the components do not reflect light from the display toward the person's eye, and wherein the optical structure is changed from the first configuration to the second configuration by the transmission of electrical energy through a selected subset of the plurality of electroconductive pathways.

In an example, an optical structure for augmented reality eyewear can comprise: an optical structure (e.g. lens and/or waveguide) which is configured to be worn in front of one of a person's eyes; an array of individually-movable reflective components (e.g. movable micromirrors, gratings, or suspended particles) in the optical structure; and a light-emitting display, wherein a selected subset of the components can be selectively changed by transmission of electrical energy from a first configuration with first orientations (e.g. angles relative to the optical structure) which allow light from the environment to pass through the optical structure to a second configuration with second orientations (e.g. angles relative to the optical structure) which reflect light from the display toward the person's eye, or vice versa.

In an example, an optical structure for augmented reality eyewear can comprise: an optical structure which is configured to be worn in front of a person's eye; a light display; a plurality of electroconductive pathways; an array of electrochromic components in the optical structure, wherein a first subset of electrochromic components in the array is in a first state with a first (e.g. high) level of reflectivity and all the rest of the electrochromic components in the array are in a second state with a second (e.g. low) level of reflectivity at a first time, wherein a second subset of electrochromic components in the array is in the first state with a first (e.g. high) level of reflectivity and all the rest of the electrochromic components in the array are in the second state with a second (e.g. low) level of reflectivity at a second time, wherein a selected subset of electrochromic components is changed from the first state to the second state, or vice versa, by transmission of electrical energy through a selected subset of the electroconductive pathways; and a data processor which controls which electrochromic components are in a selected subset at a given time.

In an example, an optical structure for augmented reality eyewear can comprise: an optical structure which is configured to be worn in front of a person's eye; a light display; a plurality of electroconductive pathways; an array of individually-movable reflective components in the optical structure, wherein a first subset of individually-movable reflective components in the array is in a first state with a first orientation (e.g. angle) which reflects light from the display toward the person's eye and all the rest of the individually-movable reflective components in the array are in a second state with a second orientation (e.g. angle) which does not reflect light from the display toward the person's eye at a first time, wherein a second subset of individually-movable reflective components in the array is in the first state with a first orientation (e.g. angle) and all the rest of the individually-movable reflective components in the array are in the second state with a second orientation (e.g. angle) at a second time, and wherein a selected subset of individually-movable reflective components is changed from the first state to the second state, or vice versa, by transmission of electrical energy through a selected subset of the electroconductive pathways; and a data processor which controls which individually-movable reflective components are in a selected subset at a given time.

In one embodiment, an optical structure for augmented reality eyewear can comprise: an optical structure which is configured to be worn in front of a person's eye; a light display; a plurality of electroconductive pathways; and an array of electrochromic components in the optical structure, wherein the optical structure has a first configuration at a first time in which a first subset of components are opaque and the rest of the components are transparent, wherein the first subset of components span an area of the optical structure where a virtual object is shown by the light reflected from the display at the first time; wherein the optical structure has a second configuration at a second time in which a second subset of components are opaque and the rest of the components are transparent, wherein the second subset of components span an area of the optical structure where a virtual object is shown by light reflected from the display at the second time; and wherein the optical structure is changed from the first configuration to the second configuration, or vice versa, by transmission of electrical energy through the electroconductive pathways.

In an example, augmented reality eyewear (e.g. eyeglasses) can comprise: an optical structure (e.g. lens or waveguide) which is configured to be worn by a person in front of one of the person's eyes; an array of movable reflective components within the optical structure; a first array (e.g. grid or mesh) of electroconductive pathways which is proximal (e.g. closer to the eye) relative to the optical structure; and a second array (e.g. grid or mesh) of electroconductive pathways which is distal (e.g. farther from the eye) relative to the optical structure, wherein transmission of electrical energy between the first array of electroconductive pathways and the second array of electroconductive pathways moves (e.g. pivots, tilts, and/or rotates) one or more reflective components in the array of reflective components.

In another example, augmented reality eyewear can comprise a selected subset of movable reflective components which are moved by transmission of electrical energy between a selected subset of electroconductive pathways in a first array and/or a second array of electroconductive pathways. In one embodiment, movable reflective components in augmented reality eyewear can have a first configuration with a first orientation in which they do not reflect light from a light display toward a person's eye and a second configuration with a second orientation in which they do reflect light from the light display toward the person's eye, wherein a subset of the components can be changed from the first configuration to the second configuration, or vice versa, by transmission of electrical energy through electroconductive pathways near the components.

In another example, an electromagnetic field which moves reflective components can be changed by changing which subsets of a matrix of electroconductive pathways, electrodes, or poles are selected for electrical energy transmission. In an example, an optical structure for augmented reality eyewear can comprise: an optical structure (e.g. lens and/or waveguide) which is configured to be worn in front of one of a person's eyes; a light-emitting display which is located on one side of the optical structure; and an array of individually adjustable-reflectivity components (e.g. micromirrors or gratings which can be made reflective or transparent) in the optical structure; wherein the optical structure has a first configuration in which a selected first subset of components in the array reflect light from the display toward the person's eye and the rest of the components do not reflect light from the display toward the person's eye; wherein the optical structure has a second configuration in which a selected second subset of components in the array reflect light from the display toward the person's eye and the rest of the components do not reflect light from the display toward the person's eye; and wherein the optical structure is changed from the first configuration to the second configuration by a change in an electromagnetic field.

In an example, an optical structure for augmented reality eyewear can comprise: an optical structure (e.g. lens and/or waveguide) which is configured to be worn in front of one of a person's eyes; an array of individually-movable reflective components (e.g. movable micromirrors, gratings, or suspended particles) in the optical structure; and a light-emitting display, wherein a selected subset of the components can be selectively changed by changes in an electromagnetic field from a first configuration with first orientations (e.g. angles relative to the optical structure) which allow light from the environment to pass through the optical structure to a second configuration with second orientations (e.g. angles relative to the optical structure) which reflect light from the display toward the person's eye, or vice versa.

In an example, an optical structure for augmented reality eyewear can comprise: an optical structure which is configured to be worn in front of a person's eye; a light display; a first grid of electroconductive pathways in the optical structure; a second grid of electroconductive pathways in the optical structure, wherein there is an electromagnetic field between the first grid and the second grid; and an array of magnetic reflective components (e.g. micromirrors, reflective gratings, or reflective particles) between the first grid and the second grid, wherein the orientations (e.g. angles) of magnetic reflective components in the array are changed by changes in the electromagnetic field.

In an example, augmented reality eyewear (e.g. eyeglasses) can comprise: an eyewear (e.g. eyeglasses) frame which is configured to be worn by a person; an optical structure (e.g. lens) which is configured to be held in front of one of the person's eyes by the frame; a light display which emits light rays that display one or more virtual objects in the person's field of view; and a dynamic waveguide which transmits light rays from the light display to locations on the optical structure from which the light rays exit the waveguide toward the person's eye, wherein the interior of the dynamic waveguide further comprises a plurality of small-scale (e.g. micro-scale, nano-scale, and/or molecular level) reflective components whose orientations are selectively changed by the application of electromagnetic energy (e.g. by the transmission of electrical voltage or by the creation of a magnetic field).

In an example, augmented reality eyewear can comprise a movable reflective component which is moved (e.g. pivoted, tilted, and/or rotated) from a first configuration to a second configuration by changes in an electromagnetic field. In an example, augmented reality eyewear can comprise a selected subset of reflective components in the array which are selectively and independently changed from a first configuration to a second configuration by (changes in) an electromagnetic field. In an example, augmented reality eyewear can comprise a waveguide wherein the level of reflectivity of reflective components is changed and/or adjusted by exposure to an electromagnetic field. In another example, augmented reality eyewear can comprise electrical poles and/or antennae which create an electromagnetic field, wherein changes in the electromagnetic field move a selected subset of reflective components (e.g. micromirrors) in an array of reflective components. In an example, would you like me to compose a patent application for a dynamic waveguide? No thanks, I don't use AI to write patent applications. Are you sure? I said no, don't you have someone else to dumb down somewhere? In another example, different selected subsets of movable reflective components can be moved at different times by creating different electromagnetic field patterns. In one embodiment, reflective components can be suspended by an electromagnetic field within a transparent reflective structure.

In an example, augmented reality eyewear can comprise a first sound emitter at a first end (or side) of an optical structure (e.g. lens or waveguide) and a second sound emitter at a second end (or side) of the optical structure, wherein constructive or destructive interference between two acoustic waves created by these two sound emitters moves one or more reflective components at selected locations on the optical structure. In one embodiment, augmented reality eyewear can comprise a sound emitter which creates acoustic waves with different frequencies and/or amplitudes to move reflective components at different locations on an optical structure (e.g. lens or waveguide) at different times. In an example, augmented reality eyewear can comprise a sound emitter which creates an acoustic wave which travels longitudinally within an optical structure (e.g. lens or waveguide).

In one embodiment, augmented reality eyewear can comprise an actuator (e.g. an electromagnetic actuator) which compresses the proximal and distal walls of a flexible waveguide closer together. In an example, augmented reality eyewear can comprise an electromagnetic actuator which moves (e.g. pivots, tilts, or rotates) the waveguide from a first configuration which spans a central portion of an optical structure (e.g. lens) in front of a person's eye to a first extent to a second configuration which spans this central portion to a second extent, wherein the second extent is less than the first extent.

In an example, augmented reality eyewear can comprise a waveguide, wherein the interior of the waveguide comprises a flowable substance (e.g. a liquid or gel) and the width (e.g. thickness) of the waveguide is changed by pressing the proximal and distal walls of the waveguide closer together. In an example, augmented reality eyewear can comprise an array of optical fibers between a light display (e.g. array of light emitters) and a movable waveguide, wherein an optical fibers transmit light from the light display into the waveguide even when the central axis of the waveguide moves relative to the light display.

In another example, augmented reality eyewear can comprise an optical structure, wherein a central portion of the optical structure is an arcuate (e.g. circular, elliptical, or oval) area of the (proximal-facing) surface of the structure which is centered on the center of the structure and which comprises between 10% and 25% of the surface area of the structure. In an example, augmented reality eyewear can have an optical structure (e.g. lens or waveguide) in front of a person's eye, wherein a central portion of the structure comprises an arcuate (e.g. circular, elliptical, or oval) area of the proximal-facing surface of the structure which is centered on the center of the structure and comprises between 10% of the surface area of the structure.

In another example, augmented reality eyewear can be contact lenses. In an example, augmented reality eyewear can comprise a light display (e.g. array of light emitters), wherein light from the light display is directed through a waveguide toward a person's eye to display a virtual object in the person's field of view. In an example, an optical structure for augmented reality eyewear can comprise: an optical structure (e.g. lens and/or waveguide) which is configured to be worn in front of one of a person's eyes; an array of individually-movable reflective components (e.g. movable micromirrors or gratings) in the optical structure; a first light-emitting display which is to the right of the array; and a second light-emitting display which is to the left of the display; wherein light rays from the first light-emitting display and the second light-emitting display are guided by the array toward the person's eye.

In an example, an optical structure for augmented reality eyewear can comprise: an optical structure (e.g. lens) which is configured to be worn in front of a person's eye; a first display; a second display; a first waveguide which guides light rays from the first display to a first area of the optical structure from which light rays exit the optical structure toward the person's eye; and a second waveguide which guides light rays from the second display to a second area of the optical structure from which light rays exit the optical structure toward the person's eye, wherein light rays from the first display and light rays from the second display combine to form a single virtual image in the person's field of view.

In an example, augmented reality eyewear (e.g. eyeglasses) can comprise: an eyewear (e.g. eyeglasses) frame which is configured to be worn by a person; an optical structure (e.g. lens or waveguide) which is configured to be held in front of one of the person's eyes by the frame; a plurality of light displays located around at least a portion of the circumference of the optical structure; and a plurality of wedge, pie-slice, and/or annular-section shaped micromirror arrays which transmit light rays from the light emitters to locations on the optical structure, wherein light rays from the light emitters exit the optical structure from the locations toward the person's eye.

In an example, augmented reality eyewear (e.g. eyeglasses) can comprise: an eyewear (e.g. eyeglasses) frame which is configured to be worn by a person; an optical structure (e.g. lens) which is configured to be held in front of one of the person's eyes by the frame; a plurality of light displays located around at least a portion of the circumference of the optical structure; and a plurality of waveguides (which transmit light rays from the light emitters to locations on the optical structure, wherein light rays from the light emitters exit the optical structure from the locations toward the person's eye. In an example, augmented reality eyewear can comprise a first light display above an optical structure (e.g. lens or waveguide) and a second light display below the optical structure.

In another example, augmented reality eyewear can comprise a light display with a plurality of light emitters which emit light which displays one or more virtual objects in a person's field of view. In an example, augmented reality eyewear can comprise a plurality of light displays (e.g. arrays of light emitters) at different locations on the circumference of a frontpiece rim around an optical structure (e.g. lens) in front of a person's eye. In another example, augmented reality eyewear can comprise a plurality of light displays can collectively span the entire circumference of an optical structure (e.g. lens or waveguide). In one embodiment, augmented reality eyewear can comprise a plurality of light displays which span between 25% and 50% of the circumference of an optical structure (e.g. lens or waveguide).

In an example, augmented reality eyewear can comprise a plurality of waveguides, wherein the waveguides transmit light from light displays along the upper half of an optical structure (e.g. lens) to central and lower locations on the optical structure. In one embodiment, augmented reality eyewear can comprise an annular array of light displays around an eye which are activated at different times (e.g. sequentially). In an example, augmented reality eyewear can comprise an arcuate array of light displays around an eye. In an example, augmented reality eyewear can comprise an optical structure (e.g. lens) with a plurality of radial waveguides which transmit light from a plurality of light displays along peripheral-to-central vectors.

In an example, augmented reality eyewear can comprise four light displays (e.g. arrays of light emitters) at different locations (e.g. to the right, to the left, above, and below the eye) around the circumference of a frontpiece rim around an optical structure (e.g. lens) in front of a person's eye. In another example, augmented reality eyewear can comprise: a first display on the nose bridge of the eyewear; a second display on a sidepiece of the eyewear; a first waveguide which guides light from the first display to an eye; and a second waveguide which guides light from the second display to the eye.

In an example, augmented reality eyewear can further comprise four light displays (e.g. arrays of light emitters) on a frontpiece of an eyewear frame, wherein the displays are distributed around the circumference of an optical structure (e.g. lens), and wherein light from the one or more displays shows one or more virtual objects in the person's field of view. In another example, augmented reality eyewear with a plurality of light displays and a plurality of waveguides. In an example, augmented reality eyewear with multiple waveguides for each (e.g. optically linked with a) light display in a plurality of light displays. In another example, there can be six or more light displays distributed (evenly) around the circumference of an optical structure (e.g. lens or waveguide). In an example, there can be two or more light displays sending light into a single waveguide. In an example, augmented reality eyewear can comprise a light display on a sidepiece (e.g. temple) of the eyewear. In an example, light rays can be transmitted along the length of a waveguide by being internally-reflected (back and forth) by proximal and distal micromirror arrays until they escape through the proximal micromirror array.

In an example, augmented reality eyewear can comprise a waveguide wherein changing the angle between proximal and distal surfaces of a waveguide changes the brightness of a virtual object. In an example, augmented reality eyewear can comprise a waveguide wherein changing the width (e.g. thickness) of a waveguide changes characteristics of virtual objects. In an example, augmented reality eyewear can comprise a waveguide wherein changing the width (e.g. thickness) of a waveguide changes the resolution of a virtual object. In an example, augmented reality eyewear can comprise a waveguide which guides light from an eyewear frame to a central location on an optical structure (e.g. lens) in front of a person's eye.

In one embodiment, augmented reality eyewear can comprise a waveguide which has an oval or oblong shape. In an example, augmented reality eyewear can comprise a waveguide which transmits light from a light display to a peripheral (e.g. non-central) location on an optical structure (e.g. lens) in a second configuration, wherein light exits the waveguide toward a person's eye from the peripheral location. In another example, augmented reality eyewear can comprise a waveguide whose central axis is substantially parallel to a central axis of a frontpiece of eyewear in a first configuration and intersects (a virtual extension of) the central axis of a frontpiece at an acute angle between 20 and 45 degrees in a second configuration. In an example, augmented reality eyewear can comprise a waveguide, wherein changing the width (e.g. thickness) of a waveguide changes the size of a virtual object. In another example, augmented reality eyewear can comprise an optical structure, in which a proximal component of the optical structure is a waveguide which transmits light rays from a light display via internal reflection to a location from which the light rays exit the waveguide toward the person's eye.

In an example, an arcuate rotatable component in an optical structure can be off-center. In another example, augmented reality eyewear can comprise a waveguide which attached to an arcuate rotatable component. In an example, augmented reality eyewear can comprise a waveguide which is off-center on an arcuate rotatable component. In an example, augmented reality eyewear can comprise a waveguide, wherein the area of the waveguide is between 25% and 50% of the area of an arcuate rotatable component. In an example, augmented reality eyewear can comprise an arcuate rotatable component which is manually rotated by a person wearing the eyewear in order to move a waveguide into (or out of) the center of the person's field of view. In an example, augmented reality eyewear can comprise an arcuate rotatable component which spans from the center of an optical structure (e.g. lens or waveguide) to a side of the optical structure. In an example, augmented reality eyewear can include an arcuate rotatable component which is transparent. In an example, eyewear can further comprise an electromagnetic actuator, wherein the actuator rotates an arcuate rotatable component in an optical structure.

In an example, augmented reality eyewear (e.g. eyeglasses) can comprise: an eyewear (e.g. eyeglasses) frame which is configured to be worn by a person; an optical structure (e.g. lens) which is configured to be held in front of one of the person's eyes by the frame; and a movable (e.g. pivoting) waveguide which spans a percentage of the area of the optical structure (e.g. lens or waveguide), wherein the waveguide has a first configuration which spans a central portion of the area of the optical structure, wherein the waveguide has a second configuration which does not span the central portion of the area of the optical structure, and wherein the waveguide is pivoted, tilted, and/or rotated from the first configuration to the second configuration, or vice versa.

In one embodiment, augmented reality eyewear (e.g. eyeglasses) can comprise: an eyewear (e.g. eyeglasses) frame which is configured to be worn by a person; an optical structure (e.g. lens) which is configured to be held in front of one of the person's eyes by the frame; a light display which emits light that displays one or more virtual objects in the person's field of view; and a dynamic waveguide which transmits light rays from the light display to locations on the optical structure from which the light rays exit the waveguide toward the person's eye; wherein the waveguide has a first configuration with a first width (e.g. thickness), wherein the waveguide has a second configuration with a second width (e.g. thickness), and wherein the second width (e.g. thickness) is greater than the first width (e.g. thickness).

In another example, augmented reality eyewear (e.g. eyeglasses) can comprise: an eyewear (e.g. eyeglasses) frame which is configured to be worn by a person; an optical structure (e.g. lens) which is configured to be held in front of one of the person's eyes by the frame; a light display which emits light that displays one or more virtual objects in the person's field of view; and a dynamic waveguide which transmits light rays from the light display to locations on the optical structure from which the light rays exit the waveguide toward the person's eye; wherein the waveguide further comprises a proximal micromirror array (e.g. proximal mirror wall) and a distal micromirror array (e.g. distal mirror wall), wherein the waveguide has a first configuration with a first angle between the proximal and distal micromirror arrays, wherein the waveguide has a second configuration with a second angle between the proximal and distal micromirror arrays, and wherein the second angle is greater than the first angle.

In an example, augmented reality eyewear can comprise a flexible and/or bendable light guide component between a light display (e.g. array of light emitters) and a movable waveguide, wherein the flexible and/or bendable light guide transmits light from the light display into the waveguide even when the central axis of the waveguide moves relative to the light display. In another example, augmented reality eyewear can comprise a movable waveguide that is inserted into a gap, recess, opening, channel, and/or compartment in an optical structure (e.g. lens) in a third configuration. In one embodiment, augmented reality eyewear can comprise a movable waveguide which is an integral part of an optical structure (e.g. lens) in front of a person's eye.

In an example, augmented reality eyewear can comprise a movable waveguide which is parallel to a proximal and/or distal surface of an optical structure (e.g. lens) in front of a person's eye. In an example, augmented reality eyewear can comprise a movable waveguide which pivots around a point of rotation (e.g. an axle) which is on a frontpiece of eyewear. In an example, augmented reality eyewear can comprise a movable waveguide which spans between 10% and 30% of the area of an optical structure (e.g. lens) which is held by eyewear in front of a person's eye. In an example, augmented reality eyewear can comprise a movable waveguide which spans between 20% and 50% of the area of the proximal surface of an optical structure (e.g. lens or waveguide) which is held by eyewear in front of a person's eye.

In an example, augmented reality eyewear can comprise a movable waveguide which spans between 25% and 60% of the area of an optical structure (e.g. lens) in front of a person's eye when the waveguide is in a selected configuration. In another example, augmented reality eyewear can comprise a movable waveguide which spans between 5% and 20% of the area of an optical structure (e.g. lens) which is held by eyewear in front of a person's eye. In an example, augmented reality eyewear can comprise a movable waveguide which spans from a side of an optical structure (e.g. lens) to the center of the optical structure in a first configuration and spans from the side of the optical structure to a lower peripheral portion (e.g. the bottom third) of the optical structure in a second configuration.

In another example, augmented reality eyewear can comprise a movable waveguide which transmits light from a light display (e.g. array of light emitters) to a location in the periphery (e.g. outside the central third) of a person's field of view, wherein light exits this location toward the person's eye. In an example, augmented reality eyewear can comprise a moveable waveguide which fits flat against the side of a sidepiece of eyewear in a first configuration and sticks out from the eyewear (e.g. out from the sidepiece) in a second configuration. In an example, augmented reality eyewear can comprise a waveguide at a first location in a first configuration and at a second location in a second configuration, wherein the second location is below and toward the side of the first location (e.g. when an optical structure is vertical).

In an example, augmented reality eyewear can comprise a waveguide wherein a moveable waveguide can be inserted into an opening, recess, channel, and/or compartment in an eyewear sidepiece. In another example, augmented reality eyewear can comprise a waveguide which is manually moved (e.g. pivoted, tilted, or rotated) from a first configuration which spans a central portion of an optical structure (e.g. lens) in front of a person's eye to a first extent to a second configuration which spans this central portion to a second extent, wherein the second extent is less than the first extent.

In one embodiment, augmented reality eyewear can comprise a waveguide which spans the center of an optical structure (e.g. lens) in a first configuration and does not span this center in a second configuration. In another example, augmented reality eyewear can comprise a waveguide which transmits light from a light display to a central location on an optical structure (e.g. lens) in a first configuration and transmits light from the light display to a peripheral location on the optical structure in a second configuration, wherein the peripheral location is below the central location (when the optical structure is vertical), and wherein the waveguide pivots, tilts, and/or rotates from the first configuration to the second configuration.

In an example, augmented reality eyewear can comprise an optical structure wherein a movable waveguide transmits light from a light display (e.g. array of light emitters) to a location in the center of a person's field of view, wherein light exits this location toward the person's eye. In one embodiment, augmented reality eyewear can comprise an optical structure with an inner opening, recess, compartment, and/or gap, wherein a movable waveguide pivots, tilts, and/or rotates from a first configuration to a second configuration within this opening, recess, compartment, and/or gap.

In an example, augmented reality eyewear can comprise a plurality of non-overlapping waveguides. In an example, augmented reality eyewear can comprise a plurality of waveguides which have the same shape. In an example, augmented reality eyewear can comprise a plurality of waveguides with wedge shapes. In an example, augmented reality eyewear can comprise a waveguide wherein the waveguides do not overlap each other. In an example, augmented reality eyewear can comprise first and second waveguides which have the same shapes.

In another example, augmented reality eyewear can comprise two or more waveguides, where first and second waveguides have different sizes and/or shapes. In an example, augmented reality eyewear can comprise: a first waveguide which transmits light from a display on one side (e.g. left side) of an optical structure along a portion of the upper circumference of the optical structure; and additional waveguides which further transmit this light downwards toward the center of the optical structure. In another example, augmented reality eyewear with multiple light display for each (e.g. optically linked with) waveguide in a plurality of waveguides.

In an example, augmented reality eyewear (e.g. eyeglasses) can comprise: an eyewear (e.g. eyeglasses) frame which is configured to be worn by a person; an optical structure (e.g. lens) which is configured to be held in front of one of the person's eyes by the frame; a first light display on a first side of the optical structure; a second light display on a second side (e.g. opposite the first side) of the optical structure; a first waveguide which transmits light from the first light display; and a second waveguide which transmits light from the second light display, wherein the first waveguide and the second waveguide have a first configuration wherein the first waveguide and the second waveguide overlap by a first amount, wherein the first waveguide and the second waveguide have a second configuration wherein the first waveguide and the second waveguide overlap by a second amount, and wherein the second amount is greater than the first amount.

In an example, augmented reality eyewear can comprise an optical structure wherein waveguides which transmit light from light displays on opposite sides of the structure overlap in a central region of the structure in order to display virtual objects with greater brightness and/or resolution in that central region. In an example, augmented reality eyewear can comprise one or more waveguides, wherein portions of waveguides which span a central region of an optical structure (e.g. lens or waveguide) overlap in order to create a central region of a person's field of view wherein virtual objects are shown with greater brightness and/or resolution than in peripheral regions of the person's field of view.

In one embodiment, augmented reality eyewear can comprise: a first display on the nose bridge of the eyewear; a second display on a sidepiece of the eyewear; a first vertically-oriented waveguide which guides light from the first display to an eye; and a second vertically-oriented waveguide which guides light from the second display to the eye, wherein the first waveguide and second waveguide overlap in a center of the field of view of the eye to increase the brightness and/or resolution of virtual objects display in the center of the field of view. In one embodiment, the location of an overlap area (wherein waveguides in an optical structure overlap) can be moved by shifting the relative locations of the waveguides.

In another example, a first waveguide and a second waveguide can be changed from a first configuration to a second configuration by sliding one waveguide vertically over the other waveguide. In an example, augmented reality eyewear can comprise a gap or opening on a joint between a sidepiece and a front piece of eyewear, wherein a movable waveguide is slid through this gap or opening when it is moved from one configuration (e.g. not in front of a person's eye) to another configuration (e.g. in front of the person's eye). In another example, augmented reality eyewear can comprise a proximal array of micromirrors which are moved (e.g. slid) relative to a distal array of micromirrors, or vice versa, by one or more actuators.

In an example, augmented reality eyewear can comprise a waveguide wherein shifting and/or sliding proximal and distal surfaces (or walls) of the waveguide relative to each other can change the location of a virtual object. In an example, augmented reality eyewear can comprise an optical structure wherein a first waveguide and a second waveguide are changed from a first configuration to a second configuration by sliding one waveguide horizontally into the other waveguide. In an example, augmented reality eyewear can comprise an optical structure wherein a first waveguide and a second waveguide are changed from a first configuration to a second configuration by sliding one waveguide over the other waveguide.

In an example, a waveguide can comprise a proximal array of reflective components (e.g. micromirrors) and a distal array of reflective components (e.g. micromirrors), wherein light is guided along the waveguide by being reflected back and forth between the proximal array and the distal array until it exits through (a gap in) the proximal array toward a person's eye. In an example, augmented reality eyewear can comprise a waveguide wherein reflective components are partially reflective. In another example, augmented reality eyewear can comprise a waveguide with nanoscale mirrors. In an example, reflective components can be micromirrors.

In another example, a movable reflective component in augmented reality eyewear can tilt and/or rotate around a central axis which spans their diameter. In an example, an optical structure for augmented reality eyewear can comprise: an optical structure (e.g. lens and/or waveguide) which is configured to be worn in front of one of a person's eyes; a first array of individually movable reflective components (e.g. movable micromirrors or gratings) in the optical structure with a first longitudinal orientation; a second array of individually movable reflective components (e.g. movable micromirrors or gratings) in the optical structure with a second longitudinal orientation, wherein the second longitudinal orientation differs from the first longitudinal orientation by between 20 and 50 degrees; and a light-emitting display, wherein light from the display is guided through the first array and the second array toward the person's eye.

In an example, an optical structure for augmented reality eyewear can comprise: an optical structure (e.g. lens and/or waveguide) which is configured to be worn in front of one of a person's eyes; a first array of individually movable reflective components (e.g. movable micromirrors or gratings) in the optical structure; a second array of individually movable reflective components (e.g. movable micromirrors or gratings) in the optical structure; and a light-emitting display, wherein light from the display is guided through the first array and the second array toward the person's eye.

In an example, an optical structure for augmented reality eyewear can comprise: an optical structure (e.g. lens and/or waveguide) which is configured to be worn in front of one of a person's eyes; an array of individually-movable reflective components (e.g. pivotable or rotatable micromirrors, gratings, or suspended particles) in the optical structure; and a light-emitting display; wherein a series of components in the array are sequentially angled to reflect light from the display toward the person's eye and the rest of the components are angled to not reflect light from the display toward the person's eye.

In one embodiment, an optical structure for augmented reality eyewear can comprise: an optical structure (e.g. lens and/or waveguide) which is configured to be worn in front of one of a person's eyes; an array of individually-movable reflective components (e.g. movable micromirrors, gratings, or suspended particles) in the optical structure; and a light-emitting display, wherein a selected subset of the components can be selectively changed by MEMS actuators from a first configuration with first orientations (e.g. angles relative to the optical structure) which allow light from the environment to pass through the optical structure to a second configuration with second orientations (e.g. angles relative to the optical structure) which reflect light from the display toward the person's eye, or vice versa.

In an example, augmented reality eyewear (e.g. eyeglasses) can comprise: an eyewear (e.g. eyeglasses) frame which is configured to be worn by a person; an optical structure (e.g. lens or waveguide) which is configured to be held in front of one of the person's eyes by the frame; and an array of micromirrors which spans a percentage of the area of the optical structure, wherein the array of micromirrors has a first configuration which spans a central portion of the area of the optical structure, wherein the array of micromirrors has a second configuration which does not span the central portion of the area of the optical structure, and wherein the array of micromirrors is pivoted, tilted, and/or rotated from the first configuration to the second configuration, or vice versa.

In an example, augmented reality eyewear can an optical structure wherein a micromirror and/or moveable reflective surface at a given location allow light rays from a light display to pass longitudinally when the micromirror and/or moveable reflective surface is in a first configuration and directs these light rays to exit this location toward a person's eye when the micromirror and/or moveable reflective surface is in a second configuration. In another example, augmented reality eyewear can comprise a movable reflective component which is moved (e.g. pivoted, tilted, and/or rotated) from a first configuration to a second configuration by voltage.

In an example, augmented reality eyewear can comprise a planar array of movable reflective components and a light display, wherein individual reflective components can be sequentially moved (e.g. pivoted or rotated) out from the plane of the array (one at a time) in order to reflect light from the display toward a person's eye from different locations at different times. In another example, augmented reality eyewear can comprise a reflective component which rotates, tilts, or pivots around an axis between two of its vertexes. In an example, augmented reality eyewear can comprise a selected subset of micromirrors and/or moveable reflective surfaces which are selectively and independently moved from a first configuration to a second configuration, or vice versa, by one or more electromagnetic actuators.

In an example, augmented reality eyewear can comprise a waveguide wherein reflective components are tilted and/or rotated around axles between (the mid-points of) opposite sides of the objects. In an example, augmented reality eyewear can comprise a waveguide, wherein a selected subset of reflective components in the waveguide can be moved (e.g. pivoted, tilted, and/or rotated) from a first configuration to a second configuration by the transmission of electromagnetic (e.g. electrical) energy through a selected section of the waveguide. In an example, augmented reality eyewear can comprise an array of movable reflective components which are circular.

In an example, augmented reality eyewear can comprise an optical structure wherein a selected subset of micromirrors and/or movable reflective surfaces are substantially parallel to a proximal surface of a waveguide in a first configuration and intersect this surface at acute angles in a second configuration. In an example, augmented reality eyewear can comprise: a longitudinal light channel and/or waveguide; and a longitudinal array of moveable reflective components, wherein the light channel and/or waveguide is proximal (e.g. closer to the person's eye) than the longitudinal array. In an example, eyewear can further comprises a joint (or hinge) around which an array of micromirrors is pivoted and/or rotated. In another example, movable reflective components can be reflective molecules.

In one embodiment, movable reflective components can have hexagonal shapes. In another example, movable reflective components in augmented reality eyewear can have a first configuration with a first orientation in which they do not reflect light from a light display toward a person's eye and a second configuration with a second orientation in which they do reflect light from the light display toward the person's eye. In an example, selective movement of different reflective components in an array of reflective components at different times can enable reflection of light rays from the light display from different locations on an optical structure (e.g. lens or waveguide) at different times, which further enables multiplexing reflection location and content to display virtual objects at different locations in the person's field of view at different times.

In one embodiment, an optical structure for augmented reality eyewear can comprise: an optical structure (e.g. lens and/or waveguide) which is configured to be worn in front of one of a person's eyes; a first array of individually adjustable-reflectivity components (e.g. electrochromic micromirrors or gratings which each can be made either more reflective or more transparent) in the optical structure with a first longitudinal orientation; a second array of individually adjustable-reflectivity components (e.g. electrochromic micromirrors or gratings which each can be made either more reflective or more transparent) in the optical structure with a second longitudinal orientation, wherein the second longitudinal orientation differs from the first longitudinal orientation by between 60 and 100 degrees; and a light-emitting display, wherein light from the display is guided through the first array and the second array toward the person's eye.

In an example, an optical structure for augmented reality eyewear can comprise: an optical structure (e.g. lens and/or waveguide) which is configured to be worn in front of one of a person's eyes; a linear array of individually adjustable-reflectivity components (e.g. electrochromic micromirrors or gratings which each can be made either more reflective or more transparent) in the optical structure; and a light-emitting display, wherein light from the display is guided by the array toward the person's eye, and wherein the display is colinear with a virtual extension of the central longitudinal axis of the array.

In an example, an optical structure for augmented reality eyewear can comprise: an optical structure (e.g. lens and/or waveguide) which is configured to be worn in front of one of a person's eyes; an array of adjustably-reflective components (e.g. electrochromic micromirrors or gratings) in the optical structure; and a light-emitting display; wherein a lateral (e.g. right to left, or left to right) series of components in the array are sequentially made reflective and the rest of the components are made transparent, wherein the component that is reflective at a given time reflects light from the display toward the person's eye, and wherein components that are transparent at the given time allow light from the display to pass through them to the component that is reflective.

In an example, an optical structure for augmented reality eyewear can comprise: an optical structure (e.g. lens and/or waveguide) which is configured to be worn in front of one of a person's eyes; an array of individually adjustable-reflectivity components (e.g. electrochromic micromirrors or gratings which each can be made either more reflective or more transparent) in the optical structure; and a light-emitting display, wherein light from the display is guided by the array toward the person's eye, and wherein the display is proximal (e.g. closer to the eye) relative to the array.

In an example, an optical structure for augmented reality eyewear can comprise: an optical structure (e.g. lens and/or waveguide) which is configured to be worn in front of one of a person's eyes; an array of individually adjustably-reflective components (e.g. electrochromic micromirrors or gratings) in the optical structure; and a light-emitting display, wherein components in the array can each selectively be made (relatively) reflective or (relatively) transparent, wherein at a given time only one selected component in the array is made reflective and the rest are made transparent so that light from the display passes through other components and is only reflected from the one selected component toward the person's eye.

In another example, an optical structure for augmented reality eyewear can comprise: an optical structure which is configured to be worn in front of a person's eye; a first array of (transparent) electroconductive pathways in (or on) the optical structure; a second array of (transparent) electroconductive pathways in (or on) the optical structure; and an array of variable-reflectivity components between the first array and the second array, wherein individual components in the array have a first configuration or state in which they have a first (e.g. low) level of reflectivity, wherein individual components in the array have a second configuration or state in which they have a second (e.g. high) level of reflectivity, wherein the second level is greater than the first level, and wherein a selected subset of individual components in the array are changed from the first configuration or state to the second configuration or state by transmission of electrical energy through a selected subset of pathways in the first array of electroconductive pathways and/or the second array of electroconductive pathways.

In an example, an optical structure for augmented reality eyewear can comprise: an optical structure which is configured to be worn in front of a person's eye; a light display; an array of independently-adjustable variable-reflectivity components in the optical structure; wherein individual components in the array can have a first configuration or state in which they function as a mirror (reducing or blocking light from the environment from passing through a local area of the optical structure toward the person's eye and reflecting light from the display toward the person's eye); wherein individual components in the array can have a second configuration or state in which they are transparent (transmitting light from the environment through the local area of the optical structure toward the person's eye and not reflecting light from the display toward the person's eye); and wherein a component is changed from the first configuration or state to the second configuration or state by the transmission of electrical energy; and a data processor which controls the transmission of electrical energy in order to control which components are in the first configuration or state and which components are in the second configuration or state at a given time.

In another example, an optical structure for augmented reality eyewear can comprise: an optical structure which is configured to be worn in front of a person's eye; a light display; and an array of independently-adjustable variable-reflectivity components in the optical structure; wherein individual components in the array can have a first configuration in which they function as a mirror (reducing or blocking light from the environment from passing through a local area of the optical structure toward the person's eye and reflecting light from the display toward the person's eye); and wherein individual components in the array can have a second configuration in which they are transparent (transmitting light from the environment through the local area of the optical structure toward the person's eye and not reflecting light from the display toward the person's eye).

In an example, augmented reality eyewear can comprise a linear array of adjustably-reflective components (e.g. electrochromic mirrors) and a light display, wherein the reflectivity levels of individual components along the linear array can be sequentially changed (e.g. made more reflective) by the transmission of electrical energy in order to reflect light from the display toward a person's eye from different locations at different times. In an example, augmented reality eyewear can comprise a waveguide wherein the level of reflectivity of reflective components is changed and/or adjusted by the transmission of electromagnetic (e.g. electrical) energy.

In one embodiment, an optical structure for augmented reality eyewear can comprise: an optical structure (e.g. lens and/or waveguide) which is configured to be worn in front of one of a person's eyes; a light-emitting display; a first array of transflective (e.g. partially transparent and partially reflective) components (e.g. transflective micromirrors or gratings) in the optical structure with a first orientation; and a second array of transflective (e.g. partially transparent and partially reflective) components (e.g. transflective micromirrors or gratings) in the optical structure with a second orientation.

In an example, an optical structure for augmented reality eyewear can comprise: an optical structure (e.g. lens and/or waveguide) which is configured to be worn in front of one of a person's eyes; a light-emitting display; a first array of transflective (e.g. partially transparent and partially reflective) components (e.g. transflective micromirrors or gratings) in the optical structure with a first orientation (e.g. first angle); and a second array of transflective (e.g. partially transparent and partially reflective) components (e.g. transflective micromirrors or gratings) in the optical structure with a second orientation (e.g. second angle), wherein the first array and the second array intersect, and wherein the first orientation (e.g. first angle) and the second orientation (e.g. second angle) differ by between 10 and 40 degrees.

In one embodiment, an optical structure for augmented reality eyewear can comprise: an optical structure (e.g. lens and/or waveguide) which is configured to be worn in front of one of a person's eyes; a light-emitting display; an array of transflective (e.g. partially transparent and partially reflective) components (e.g. transflective micromirrors or gratings) in the optical structure, wherein a first subset of transflective components which are closer to the display have a first reflectivity level, wherein a second subset of transflective components which are farther from the display have a second reflectivity level, and wherein the second reflectivity level is greater than the first reflectivity level.

In another example, a variable-reflectivity component can be an electrochromic mirror. In an example, a variable-reflectivity component can be made with silver. In another example, a variable-reflectivity component can include an ion conductor (e.g. electrolyte) layer In an example, a variable-reflectivity component can made with tungsten oxide. In an example, a variably-reflective component can be made with an electroconductive polymer. In an example, a variably-reflective component can comprise a liquid crystal. In an example, a variably-reflective component can have a layer of tin oxide. In an example, the level of reflectivity of a variable-reflectivity component can be changed by applying electric voltage to it. In another example, the reflectivity level of a variable-reflectivity component can be changed by altering its electron structure. In an example, the reflectivity level of a variable-reflectivity component can be changed by changing its oxidation state.

In another example, augmented reality eyewear can comprise a proximal array of micromirrors and a distal array of micromirrors. In an example, augmented reality eyewear can comprise a waveguide, wherein reflective components are randomly distributed throughout the interior of the waveguide. In an example, augmented reality eyewear can comprise a waveguide, wherein there are a plurality of reflective components in a given cross-sectional plane of the waveguide. In one embodiment, reflective components which are all in a diagonally-staggered row can be parallel to (virtual extensions of) each other.

In an example, an optical structure for augmented reality eyewear can comprise: an optical structure (e.g. lens and/or waveguide) which is configured to be worn in front of one of a person's eyes; a coplanar array of individually adjustable-reflectivity components (e.g. electrochromic micromirrors or gratings which each can be made either more reflective or more transparent) in the optical structure; and a light-emitting display, wherein light from the display is guided by the array toward the person's eye, and wherein the display is coplanar with the array.

In one embodiment, an optical structure for augmented reality eyewear can comprise: an optical structure (e.g. lens and/or waveguide) which is configured to be worn in front of one of a person's eyes; a coplanar array of movable reflective components (e.g. movable micromirrors or gratings) in the optical structure; and a light-emitting display which is coplanar with the array, wherein a selected subset of one or more of the components has a first configuration in which they are angled to allow light from the environment to pass through the optical structure and a second configuration in which they are angled to reflect light from the display toward the person's eye, and wherein the subset is moved (e.g. pivoted or rotated) from their first configurations to their second configurations by the transmission of electrical energy.

In an example, an optical structure for augmented reality eyewear can comprise: an optical structure (e.g. lens and/or waveguide) which is configured to be worn in front of one of a person's eyes; an array of individually adjustable-reflectivity components (e.g. electrochromic micromirrors or gratings which each can be made either more reflective or more transparent) in the optical structure; and a light-emitting display, wherein light from the display is guided by the array toward the person's eye, and wherein the display is coplanar with the array.

In an example, augmented reality eyewear can comprise a planar array of movable reflective components and a light display which is coplanar with the array, wherein individual reflective components can be sequentially moved (e.g. pivoted or rotated) out from the plane of the array in order to reflect light from the display toward a person's eye. In another example, augmented reality eyewear can comprise a waveguide with an array or series of reflective components which are coplanar in a plane which intersects the longitudinal axis of the waveguide at an acute angle between 10 and 30 degrees. In an example, centroids of reflective components in a diagonally-staggered row of reflective components can be colinear (e.g. aligned along a common vector).

In another example, an optical structure for augmented reality eyewear can comprise: an optical structure (e.g. lens and/or waveguide) which is configured to be worn in front of one of a person's eyes; a concave array of individually-adjustably-reflective components (e.g. micromirrors or gratings which can be made reflective or transparent) in the optical structure; and a light-emitting display which is lateral to (e.g. to the right or left of) the array, wherein light from the display is guided by the array toward the person's eye.

In an example, an optical structure for augmented reality eyewear can comprise: an optical structure (e.g. lens and/or waveguide) which is configured to be worn in front of one of a person's eyes; a concave array of individually-movable reflective components (e.g. selectively pivotable or rotatable micromirrors or gratings) in the optical structure; and a light-emitting display, wherein light from the display is guided by the array toward the person's eye, and wherein the display is distal (e.g. farther from the eye) relative to the array. In another example, an optical structure for augmented reality eyewear can comprise: an optical structure (e.g. lens and/or waveguide) which is configured to be worn in front of one of a person's eyes; a concave array of individually-movable reflective components (e.g. movable micromirrors or gratings) in the optical structure; and a light-emitting display which is lateral to (e.g. to the right or left of) the array, wherein light from the display is guided by the array toward the person's eye.

In an example, an optical structure for augmented reality eyewear can comprise: an optical structure (e.g. lens and/or waveguide) which is configured to be worn in front of one of a person's eyes; a first array of individually movable reflective louvers (e.g. movable micromirrors or gratings) in the optical structure with a first longitudinal orientation; a second array of individually movable reflective louvers (e.g. movable micromirrors or gratings) in the optical structure with a second longitudinal orientation, wherein the second longitudinal orientation differs from the first longitudinal orientation by between 60 and 100 degrees; and a light-emitting display, wherein light from the display is guided through the first array and the second array toward the person's eye.

In an example, an optical structure for augmented reality eyewear can comprise: an optical structure (e.g. lens and/or waveguide) which is configured to be worn in front of one of a person's eyes; an array of individually adjustable-reflectivity horizontal components (e.g. horizontal electrochromic micromirrors or gratings which each can be made either more reflective or more transparent) in the optical structure; and a light-emitting display, wherein light from the display is guided by the array toward the person's eye, and wherein the display is proximal (e.g. closer to the eye) relative to the array. In an example, an optical structure for augmented reality eyewear can comprise: an optical structure (e.g. lens and/or waveguide) which is configured to be worn in front of one of a person's eyes; an array of individually-movable reflective horizontal louvers (e.g. selectively pivotable or rotatable horizontal micromirrors or gratings) in the optical structure; and a light-emitting display, wherein light from the display is guided by the array toward the person's eye.

In one embodiment, an optical structure for augmented reality eyewear can comprise: an optical structure (e.g. lens and/or waveguide) which is configured to be worn in front of one of a person's eyes; an array of individually-movable reflective vertical components (e.g. selectively pivotable or rotatable vertical micromirrors or gratings) in the optical structure; and a light-emitting display, wherein light from the display is guided by the array toward the person's eye, and wherein the display is proximal (e.g. closer to the eye) relative to the array.

In an example, an optical structure for augmented reality eyewear can comprise: an optical structure (e.g. lens and/or waveguide) which is configured to be worn in front of one of a person's eyes; an array of movable (e.g. pivotable or and/or rotatable) reflective components (e.g. micromirrors, gratings, or suspended particles) in the optical structure; and a light-emitting display; wherein the optical structure has a first configuration at a first time wherein a first selected subset of one or more components in the array are oriented (e.g. angled) to reflect light from the display toward the person's eye and the rest of the components do not reflect light from the display toward the person's eye; and wherein the optical structure has a second configuration at a first time wherein a second selected subset of one or more components in the array are oriented (e.g. angles) to reflect light from the display toward the person's eye and the rest of the components do not reflect light from the display toward the person's eye; In another example, augmented reality eyewear can comprise a waveguide, wherein reflective components in the waveguide which have a first orientation allow environmental light to pass through the waveguide in an unobstructed manner.

In one embodiment, a selected subset of micromirrors and/or movable reflective surfaces in an array can be substantially parallel to lines of sight from a person's eye in the first configuration and can intersect these lines of sight at acute angles in a second configuration. In another example, augmented reality eyewear can comprise a waveguide, wherein longitudinal axes of reflective components in a selected section of the waveguide intersect lines of sight from a person's eye at an acute or right angles in a one configuration.

In an example, augmented reality eyewear can comprise an array of individually-and-selectively movable reflective components (e.g. pivoting or rotating micromirrors) wherein the components each have a first configuration which is substantially parallel to lines of sight extending out from a person's eye (thereby allowing light from the environment to pass through an optical structure to a person's eye) and a second configuration which intersects these lines of sight (thereby reflecting light from a light display toward the person's eye), where a selected subset of components in the array can be individually changed from the first configuration to the second configuration, or vice versa, by the selective transmission of electrical energy through a subset of electroconductive pathways, and wherein the subset is selected to match the location of a virtual object displayed in the person's field of view.

In an example, an optical structure for augmented reality eyewear can comprise: an optical structure (e.g. lens and/or waveguide) which is configured to be worn in front of one of a person's eyes; a light-emitting display; an array of transflective (e.g. partially transparent and partially reflective) components (e.g. transflective micromirrors or gratings) in the optical structure, wherein the orientations (e.g. angles) of transflective components vary as a linear function of distance from the display. In an example, an optical structure for augmented reality eyewear can comprise: an optical structure (e.g. lens and/or waveguide) which is configured to be worn in front of one of a person's eyes; a light-emitting display; an array of transflective (e.g. partially transparent and partially reflective) components (e.g. transflective micromirrors or gratings) in the optical structure, wherein the reflectivity levels of transflective components vary as a linear function of distance from the display.

In an example, an optical structure for augmented reality eyewear can comprise: an optical structure (e.g. lens and/or waveguide) which is configured to be worn in front of one of a person's eyes; a light-emitting display; an array of transflective (e.g. partially transparent and partially reflective) components (e.g. transflective micromirrors or gratings) in the optical structure, wherein the widths of transflective components vary as a function of distance from the display. In an example, an optical structure for augmented reality eyewear can comprise: an optical structure (e.g. lens and/or waveguide) which is configured to be worn in front of one of a person's eyes; a light-emitting display; an array of transflective (e.g. partially transparent and partially reflective) components (e.g. transflective micromirrors or gratings) in the optical structure, wherein the distances between adjacent transflective components increase with distance from the display.

In an example, an optical structure for augmented reality eyewear can comprise: an optical structure (e.g. lens and/or waveguide) which is configured to be worn in front of one of a person's eyes; an array of individually adjustably-reflective components (e.g. electrochromic micromirrors or gratings which can be made more reflective or more transparent) in the optical structure; and a light-emitting display; wherein the array has a first configuration in which a first selected component in the array is reflective and the rest of the components in the array are transparent, wherein the array has a second configuration in which a second selected component in the array is reflective and the rest of the components in the array are transparent, wherein light from the display is only reflected by the first selected component toward the person's eye in the first configuration, wherein light from the display is only reflected by the second selected component toward the person's eye in the second configuration, and wherein a series of components in the array with decreasing distance from the display are sequentially-selected to be made reflective.

In another example, an optical structure for augmented reality eyewear can comprise: an optical structure (e.g. lens and/or waveguide) which is configured to be worn in front of one of a person's eyes; an array of partially-reflective components (e.g. transflective micromirrors or gratings) in the optical structure; and a light-emitting display, wherein light from the display is guided by the array toward the person's eye, and wherein the reflectivity level of components in the array increases with distance from the display. In an example, an optical structure for augmented reality eyewear can comprise: an optical structure (e.g. lens and/or waveguide) which is configured to be worn in front of one of a person's eyes; an array of partially-reflective components (e.g. transflective micromirrors or gratings) in the optical structure; and a light-emitting display, wherein light from the display is guided by the array toward the person's eye, and wherein the angles of components relative to the optical structure increases with distance from the display.

In an example, centroids of reflective components in a first subset of diagonally-staggered rows which is a first average distance from a light display can be aligned along vectors which intersect a longitudinal axis of an optical structure (e.g. lens or waveguide) at a first angle, centroids of reflective components in a second subset of diagonally-staggered rows which is a second average distance from the light display can be aligned along vectors which intersect the longitudinal axis at a second angle, wherein the second average distance is greater than the first average distance, and wherein the second angle is greater than the first angle.

In another example, augmented reality eyewear can comprise a plurality (e.g. stack) of reflective components spanning a cross-sectional plane of a waveguide, wherein the cross-sectional plane is orthogonal to the longitudinal axis of the waveguide. In an example, augmented reality eyewear can comprise a waveguide wherein selectively moving (e.g. reorienting) different reflective components (or stacks of reflective components) in the waveguide at different locations at different times enables multiplexing the display of different projected content at different locations at different times. In an example, augmented reality eyewear can comprise a waveguide, wherein spherical reflective components are stacked in a cross-sectional plane of the waveguide. In one embodiment, augmented reality eyewear can comprise a waveguide with reflective components which are arrayed in nested (e.g. concentric) rings. In an example, augmented reality eyewear can comprise a waveguide wherein reflective components are planar and/or flat. In one embodiment, augmented reality eyewear can comprise a waveguide with reflective components which are flat and polygonal (e.g. quadrilateral or hexagonal).

In another example, augmented reality eyewear can comprise a first electroconductive pathway, electrode, or pole located at a first end (or side) of an optical structure (e.g. lens or waveguide) and a second electroconductive pathway, electrode, or pole located at a second end (or side) of the structure. In an example, augmented reality eyewear can comprise a grid and/or matrix of transparent electroconductive pathways which is integrated into an optical structure (e.g. lens or waveguide). In another example, augmented reality eyewear can comprise parallel linear arrays of electroconductive pathways. In an example, augmented reality eyewear can include a radial array of electroconductive pathways. In an example, augmented reality eyewear can include nested (e.g. concentric) rings of electroconductive pathways.

In an example, an optical structure for augmented reality eyewear can comprise: an optical structure (e.g. lens and/or waveguide) which is configured to be worn in front of one of a person's eyes; a light-emitting display which is located on one side of the optical structure; and an array of individually movable reflective components (e.g. movable micromirrors, gratings, or suspended particles) in the optical structure; wherein the optical structure has a first configuration in which a selected first subset of components in the array reflect light from the display toward the person's eye and the rest of the components do not reflect light from the display toward the person's eye; wherein the optical structure has a second configuration in which a selected second subset of components in the array reflect light from the display toward the person's eye and the rest of the components do not reflect light from the display toward the person's eye; and wherein the optical structure is changed from the first configuration to the second configuration by the transmission of electrical energy (e.g. to a selected area of the optical structure).

In another example, an optical structure for augmented reality eyewear can comprise: an optical structure (e.g. lens and/or waveguide) which is configured to be worn in front of one of a person's eyes; an array of components (e.g. electrochromic micromirrors or gratings) in the optical structure whose levels of reflectivity and/or transparency can be selectively and individually adjusted by the transmission of electrical energy; and a light-emitting display; wherein the optical structure has a first configuration at a first time wherein a first selected subset of one or more components in the array are reflective and the rest of the components are transparent; wherein the optical structure has a second configuration at a second time wherein a second selected subset of one or more components in the array are reflective and the rest of the components are transparent; wherein components which are reflective reflect light from the display toward the person's eye; and wherein components which are transparent do not reflect light from the display toward the person's eye.

In an example, an optical structure for augmented reality eyewear can comprise: an optical structure (e.g. lens and/or waveguide) which is configured to be worn in front of one of a person's eyes; an array of movable (e.g. pivotable or and/or rotatable) reflective components (e.g. micromirrors, gratings, or suspended particles) in the optical structure; and a light-emitting display; wherein the optical structure has a first configuration at a first time wherein a first selected subset of one or more components in the array are oriented (e.g. angled) to reflect light from the display toward the person's eye and the rest of the components do not reflect light from the display toward the person's eye; wherein the optical structure has a second configuration at a first time wherein a second selected subset of one or more components in the array are oriented (e.g. angles) to reflect light from the display toward the person's eye and the rest of the components do not reflect light from the display toward the person's eye; and wherein the optical structure is changed from the first configuration to the second configuration by the transmission of electrical energy.

In an example, an optical structure for augmented reality eyewear can comprise: an optical structure which is configured to be worn in front of a person's eye; a light display; a plurality of electroconductive pathways; an array of electrochromic components in the optical structure, wherein a first subset of electrochromic components in the array is in a first state with a first (e.g. high) level of reflectivity which reflects light from the display toward the person's eye and all the rest of the electrochromic components in the array are in a second state with a second (e.g. low) level of reflectivity which does not reflect light from the display toward the person's eye at a first time, wherein a second subset of electrochromic components in the array is in the first state with a first (e.g. high) level of reflectivity and all the rest of the electrochromic components in the array are in the second state with a second (e.g. low) level of reflectivity at a second time, wherein a selected subset of electrochromic components is changed from the first state to the second state, or vice versa, by transmission of electrical energy through a selected subset of the electroconductive pathways; and a data processor which controls which electrochromic components are in a selected subset at a given time.

In an example, an optical structure for augmented reality eyewear can comprise: an optical structure which is configured to be worn in front of a person's eye; a light display; a plurality of electroconductive pathways; an array of individually-movable reflective components in the optical structure, wherein a first subset of individually-movable reflective components in the array is in a first state with a first orientation (e.g. angle) and all the rest of the individually-movable reflective components in the array are in a second state with a second orientation (e.g. angle) at a first time, wherein a second subset of individually-movable reflective components in the array is in the first state with a first orientation (e.g. angle) and all the rest of the individually-movable reflective components in the array are in the second state with a second orientation (e.g. angle) at a second time, and wherein a selected subset of individually-movable reflective components is changed from the first state to the second state, or vice versa, by transmission of electrical energy through a selected subset of the electroconductive pathways; and a data processor which controls which individually-movable reflective components are in a selected subset at a given time.

In an example, an optical structure for augmented reality eyewear can comprise: an optical structure which is configured to be worn in front of a person's eye; a light display; a plurality of electroconductive pathways; and an array of variable-opacity components in the optical structure, wherein the optical structure has a first configuration at a first time in which a first subset of components are opaque and the rest of the components are transparent, wherein the first subset of components span an area of the optical structure where a virtual object is shown by the light reflected from the display at the first time, wherein the optical structure has a second configuration at a second time in which a second subset of components are opaque and the rest of the components are transparent, wherein the second subset of components span an area of the optical structure where a virtual object is shown by light reflected from the display at the second time, and wherein the optical structure is changed from the first configuration to the second configuration, or vice versa, by transmission of electrical energy through the electroconductive pathways.

In an example, augmented reality eyewear can comprise a movable reflective component which is moved (e.g. pivoted, tilted, and/or rotated) from a first configuration to a second configuration by exposure to electrical energy transmitted between first and second arrays of electroconductive pathways. In an example, augmented reality eyewear can comprise a selected subset of reflective components in the array which are selectively and independently changed from a first configuration to a second configuration by the transmission of electromagnetic (e.g. electrical) energy. In an example, one or more reflective components in the array can be moved (e.g. pivoted, tilted, and/or rotated) by transmission of electrical energy through a grid and/or matrix of transparent electroconductive pathways.

In one embodiment, an optical structure for augmented reality eyewear can comprise: an eyewear (e.g. eyeglasses) frame which is configured to be worn by a person; an optical structure (e.g. lens and/or waveguide) which is configured to be worn in front of one of a person's eyes; a light-emitting display; an array of individually adjustable-reflectivity components (e.g. electrochromic micromirrors or gratings which each can be made either more reflective or more transparent) in the optical structure, wherein the optical structure has a first configuration at a first time wherein a selected subset of components are reflective and the rest of the components are transparent, wherein the optical structure has a second configuration at a second time wherein a selected subset of components are reflective and the rest of the components are transparent, and wherein reflective components reflect light from the display toward the person's eye; and electroconductive pathways which create an electromagnetic field, wherein a change in the electromagnetic field changes the optical structure from the first configuration to the second configuration.

In an example, an optical structure for augmented reality eyewear can comprise: an optical structure (e.g. lens and/or waveguide) which is configured to be worn in front of one of a person's eyes; a light-emitting display; a plurality of electroconductive pathways which create an electromagnetic field; and an array of individually-movable reflective components (e.g. pivotable or rotatable micromirrors, gratings, or suspended particles) in the optical structure, wherein the optical structure has a first configuration at a first time wherein a first selected subset of components have an orientation (e.g. angle) which reflects light from the display toward the person's eye and the rest of the components do not reflect light from the display toward the person's eye, wherein the optical structure has a second configuration at a second time wherein a second selected subset of components have an orientation (e.g. angle) which reflects light from the display toward the person's eye and the rest of the components do not reflect light from the display toward the person's eye, and wherein the optical structure is changed from the first configuration to the second configuration by changing the electromagnetic field in a portion of the optical structure.

In another example, an optical structure for augmented reality eyewear can comprise: an optical structure (e.g. lens and/or waveguide) which is configured to be worn in front of one of a person's eyes; an array of movable (e.g. pivotable or and/or rotatable) reflective components (e.g. micromirrors, gratings, or suspended particles) in the optical structure; and a light-emitting display; wherein the optical structure has a first configuration at a first time wherein a first selected subset of one or more components in the array are oriented (e.g. angled) to reflect light from the display toward the person's eye and the rest of the components do not reflect light from the display toward the person's eye; wherein the optical structure has a second configuration at a first time wherein a second selected subset of one or more components in the array are oriented (e.g. angles) to reflect light from the display toward the person's eye and the rest of the components do not reflect light from the display toward the person's eye; and wherein the optical structure is changed from the first configuration to the second configuration by changing an electromagnetic field.

In another example, an optical structure for augmented reality eyewear can comprise: an optical structure which is configured to be worn in front of a person's eye; a light display; a first grid of electroconductive pathways in the optical structure; a second grid of electroconductive pathways in the optical structure, wherein there is an electromagnetic field between the first grid and the second grid; and an array of magnetic reflective components (e.g. micromirrors, reflective gratings, or reflective particles) which are suspended between the first grid and the second grid by the electromagnetic field, wherein the orientations (e.g. angles) of magnetic reflective components are changed by changes in the electromagnetic field.

In another example, augmented reality eyewear (e.g. eyeglasses) can comprise: an eyewear (e.g. eyeglasses) frame which is configured to be worn by a person; an optical structure (e.g. lens) which is configured to be held in front of one of the person's eyes by the frame; a light display which emits light rays that display one or more virtual objects in the person's field of view; and a dynamic waveguide which transmits light rays from the light display to locations on the optical structure from which the light rays exit the waveguide toward the person's eye, wherein the interior of the dynamic waveguide further comprises a plurality of spherical reflective components whose orientations are selectively changed by the application of electromagnetic energy (e.g. by the transmission of electrical voltage or by the creation of a magnetic field).

In one embodiment, augmented reality eyewear can comprise a movable reflective component, wherein the component can be moved (e.g. pivoted, tilted, and/or rotated) from a first configuration to a second configuration by an electromagnetic field between first and second arrays of electroconductive pathways. In an example, augmented reality eyewear can comprise a selected subset of reflective components in the array which are selectively and independently changed from a first configuration to a second configuration by exposing reflective components in that subset to electromagnetic (e.g. electrical) energy. In another example, augmented reality eyewear can comprise a waveguide, wherein a selected subset of reflective components in the waveguide can be moved (e.g. pivoted, tilted, and/or rotated) from a first configuration to a second configuration by (changes in) an electromagnetic field.

In an example, augmented reality eyewear can comprise electroconductive elements which create an electromagnetic field, wherein changes in the electromagnetic field move a selected subset of reflective components (e.g. micromirrors) in an array of reflective components. In another example, different selected subsets of movable reflective components can be moved at different times by exposing them to different electromagnetic field patterns. In an example, the orientations of a selected subset of reflective components in an array can be selectively and independently changed by exposing the reflective components in that subset to a changing electromagnetic field.

In another example, an optical structure for augmented reality eyewear can comprise: an optical structure (e.g. lens and/or waveguide) which is configured to be worn in front of one of a person's eyes; a light-emitting display; one or more sound emitters; and an array of individually-movable reflective components (e.g. pivotable or rotatable micromirrors, gratings, or suspended particles) in the optical structure, wherein the optical structure has a first configuration at a first time wherein a first selected subset of components have an orientation (e.g. angle) which reflects light from the display toward the person's eye and the rest of the components do not reflect light from the display toward the person's eye, wherein the optical structure has a second configuration at a second time wherein a second selected subset of components have an orientation (e.g. angle) which reflects light from the display toward the person's eye and the rest of the components do not reflect light from the display toward the person's eye, and wherein the optical structure is changed from the first configuration to the second configuration by sonic energy (e.g. a resonant sound wave) from the one or more sound emitters.

In an example, augmented reality eyewear can comprise a first sound emitter at a first end (or side) of an optical structure (e.g. lens or waveguide) and a second sound emitter at a second end (or side) of the optical structure. In another example, augmented reality eyewear can comprise a sound emitter which creates an acoustic wave at a resonant frequency of an optical structure (e.g. lens or waveguide) to selectively move reflective components at one or more selected locations on the optical structure. In an example, augmented reality eyewear can comprise a sound emitter which is located at one end of an optical structure (e.g. lens or waveguide).

In an example, augmented reality eyewear can comprise an actuator (e.g. an electromagnetic actuator) which presses on the proximal and/or distal surfaces of a flexible waveguide. In another example, augmented reality eyewear can comprise a waveguide wherein reflective components are suspended in a flowable substance (e.g. liquid, gel, or gas) within the waveguide. In an example, augmented reality eyewear can comprise a waveguide, wherein the interior of the waveguide comprises a flowable substance (e.g. a liquid, gel, or gas).

In an example, augmented reality eyewear can comprise an optical structure, wherein a central portion of the optical structure (e.g. lens) in front of a person's eye is an arcuate (e.g. circular, elliptical, or oval) area of the structure centered on the center of the structure which comprises between 20% and 40% of the area of the structure. In an example, augmented reality eyewear can comprise an optical structure, wherein a central portion of the optical structure is comprise the central 10% of the (proximal-facing) surface of the structure. In an example, augmented reality eyewear can have an optical structure (e.g. lens or waveguide) in front of a person's eye, wherein a central portion of the structure comprises the central 50% of the proximal-facing surface of the structure.

In an example, augmented reality eyewear can comprise an optical structure which serves as a prescription lens. In another example, an optical structure for augmented reality eyewear can comprise: an optical structure (e.g. lens and/or waveguide) which is configured to be worn in front of one of a person's eyes; an array of individually-adjustable-reflectivity components (e.g. micromirrors or gratings which can be made reflective or transparent) in the optical structure; a first light-emitting display which is to the right of the array; and a second light-emitting display which is to the left of the display; wherein light rays from the first light-emitting display and the second light-emitting display are guided by the array toward the person's eye.

In one embodiment, an optical structure for augmented reality eyewear can comprise: an optical structure (e.g. lens and/or waveguide) which is configured to be worn in front of one of a person's eyes; an array of individually-movable reflective components (e.g. movable micromirrors or gratings) in the optical structure; a first light-emitting display which is on a lateral side (e.g. to the right or left) of the display; and a second light-emitting display which above the display; wherein light rays from the first light-emitting display and the second light-emitting display are guided by the array toward the person's eye.

In another example, augmented reality eyewear (e.g. eyeglasses) can comprise: an eyewear (e.g. eyeglasses) frame which is configured to be worn by a person; an optical structure (e.g. lens or waveguide) which is configured to be held in front of one of the person's eyes by the frame; a first light display on a first side of the optical structure; a second light display on a second side (e.g. opposite the first side) of the optical structure; a first micromirror array which transmits light from the first light display; and a second micromirror array which transmits light from the second light display, wherein the first micromirror array and the second micromirror array have a first configuration wherein the first micromirror array and the second micromirror array overlap by a first amount, wherein the first micromirror array and the second micromirror array have a second configuration wherein the first micromirror array and the second micromirror array overlap by a second amount, and wherein the second amount is greater than the first amount.

In an example, augmented reality eyewear (e.g. eyeglasses) can comprise: an eyewear (e.g. eyeglasses) frame which is configured to be worn by a person; an optical structure (e.g. lens or waveguide) which is configured to be held in front of one of the person's eyes by the frame; a plurality of light displays located around at least a portion of the circumference of the optical structure; and a plurality of wedge, pie-slice, and/or annular-section shaped micromirror arrays which transmit light rays from the light emitters to central locations on the optical structure, wherein light rays from the light emitters exit the optical structure from the central locations toward the person's eye. In one embodiment, augmented reality eyewear can comprise a circular array of light displays around an eye which are activated to emit light sequentially.

In an example, augmented reality eyewear can comprise a first light display to the right of an optical structure (e.g. lens or waveguide) and a second light display to the left of the optical structure. In an example, augmented reality eyewear can comprise a light display with an array of light emitters. In an example, augmented reality eyewear can comprise a plurality of light displays and a plurality of waveguides only on the left side of the eyewear. In an example, augmented reality eyewear can comprise a plurality of light displays near an optical structure in front of a person's eye, wherein displays whose light is guided to a central location in the person's field of view are activated more frequently or continuously than displays whose light is guided to peripheral locations of the person's field of view.

In another example, augmented reality eyewear can comprise a plurality of light displays which span between 50% and 80% of the circumference of an optical structure (e.g. lens or waveguide). In one embodiment, augmented reality eyewear can comprise a waveguide which guides light from a first light display when the waveguide is in a first configuration and guides light from a second light display when the waveguide is in a second configuration. In another example, augmented reality eyewear can comprise an annular array of light displays around an eye. In an example, augmented reality eyewear can comprise an optical structure (e.g. lens) with a hub-and-spoke array of waveguides which transmit light from a circumferential array of light displays along peripheral-to-central vectors toward the center of the optical structure.

In an example, augmented reality eyewear can comprise an optical structure (e.g. lens) with a radial array of pie-slice-shaped waveguides which transmit light from a circumferential array of light displays along peripheral-to-central vectors toward the center of the optical structure. In an example, augmented reality eyewear can comprise four light displays which are evenly distributed around the circumference of an optical structure (e.g. lens or waveguide). In an example, augmented reality eyewear can further comprise a plurality of light displays (e.g. arrays of light emitters) on a frontpiece of an eyewear frame, wherein light from the displays shows one or more virtual objects in the person's field of view.

In an example, augmented reality eyewear can further comprise four or more light displays (e.g. arrays of light emitters) on a frontpiece of an eyewear frame, wherein the displays are distributed around the circumference of an optical structure (e.g. lens), and wherein light from the one or more displays shows one or more virtual objects in the person's field of view. In an example, augmented reality eyewear with a plurality of light displays, where there is one waveguide receiving light from each light display. In an example, augmented reality eyewear with one waveguide for each of a plurality of light displays. In another example, there can be two light displays, one above and one below optical structure (e.g. lens or waveguide). In an example, there can be two or more waveguides receiving light from a single light display.

In another example, augmented reality eyewear can comprise a light display on one side of an optical structure (e.g. lens), wherein light from the display travels through a proximal light channel and/or waveguide in the optical structure which is adjacent to the proximal surface of the optical component. In an example, augmented reality eyewear can comprise a waveguide wherein an angle between proximal and distal surfaces of the waveguide are decreased by pressing the proximal and/or distal surfaces. In an example, augmented reality eyewear can comprise a waveguide wherein changing the angle between proximal and distal surfaces of a waveguide changes the location of a virtual object.

In an example, augmented reality eyewear can comprise a waveguide wherein changing the width (e.g. thickness) of a waveguide changes the brightness of a virtual object. In one embodiment, augmented reality eyewear can comprise a waveguide which guides light from a frontpiece of an eyewear frame to a central location on an optical structure (e.g. lens) in front of a person's eye. In an example, augmented reality eyewear can comprise a waveguide which has a circular shape. In one embodiment, augmented reality eyewear can comprise a waveguide which is at a first location in a first configuration and at a second location in a second configuration. In another example, augmented reality eyewear can comprise a waveguide whose central axis is substantially parallel to a central axis of a frontpiece of eyewear in a first configuration and intersects (a virtual extension of) the central axis of a frontpiece at a 45 degree angle a second configuration.

In an example, augmented reality eyewear can comprise a waveguide whose central axis is substantially parallel to a central axis of a frontpiece of eyewear in a first configuration and intersects (a virtual extension of) the central axis of a frontpiece at an acute angle in a second configuration. In another example, augmented reality eyewear can comprise a waveguide, wherein light rays are transmitted along the length of the waveguide by being internally-reflected (back and forth) by proximal and distal micromirror arrays until they escape through the proximal micromirror array. In one embodiment, augmented reality eyewear can include proximal and distal optical structures in front of a person's eye, wherein the distal structure is a waveguide.

In another example, augmented reality eyewear (e.g. eyeglasses) can comprise: an eyewear (e.g. eyeglasses) frame which is configured to be worn by a person; an optical structure (e.g. lens or waveguide) which is configured to be held in front of one of the person's eyes by the frame, wherein the optical structure further comprises an arcuate (e.g. circular) rotatable component; and an array of micromirrors on the arcuate rotatable component. In an example, augmented reality eyewear can comprise a waveguide which is be moved from a first configuration to a second configuration by rotation of an arcuate rotatable component.

In an example, augmented reality eyewear can comprise a waveguide, wherein rotation of an arcuate rotatable component in a first direction (e.g. counter-clockwise) moves the waveguide away from the center of a person's field of view and rotation of the arcuate rotatable component in a second direction (e.g. clockwise) moves the waveguide into the center of the person's field of view. In an example, augmented reality eyewear can comprise an arcuate rotatable component can rotate within a gap, recess, opening, and/or compartment within an optical structure (e.g. lens). In an example, augmented reality eyewear can comprise an arcuate rotatable component which is substantially parallel with the distal (away from eye facing) surface of an optical structure (e.g. lens).

In an example, augmented reality eyewear can comprise an electromagnetic actuator, wherein the actuator rotates a arcuate rotatable component to move a waveguide into (or out of) the center of a person's field of view. In an example, augmented reality eyewear can include an arcuate rotatable component which spans between 10% and 40% of the area of an optical structure (e.g. lens). In one embodiment, rotation of an arcuate rotatable component in an optical structure in a first direction (e.g. counter-clockwise) can move an array of micromirrors away from the center of a person's field of view and rotation of the arcuate rotatable component in a second direction (e.g. clockwise) can move the array of micromirrors into the center of the person's field of view.

In another example, augmented reality eyewear (e.g. eyeglasses) can comprise: an eyewear (e.g. eyeglasses) frame which is configured to be worn by a person; an optical structure (e.g. lens) which is configured to be held in front of one of the person's eyes by the frame; and a movable (e.g. pivoting) waveguide which spans between 10% and 30% of the area of the optical structure, wherein the waveguide has a first configuration which spans the center of the area of the optical structure, wherein the waveguide has a second configuration which does not span the center of the area of the optical structure, and wherein the waveguide is pivoted from the first configuration to the second configuration, or vice versa.

In an example, augmented reality eyewear (e.g. eyeglasses) can comprise: an eyewear (e.g. eyeglasses) frame which is configured to be worn by a person; an optical structure (e.g. lens) which is configured to be held in front of one of the person's eyes by the frame; a light display which emits light that displays one or more virtual objects in the person's field of view; and a dynamic waveguide which transmits light rays from the light display to locations on the optical structure from which the light rays exit the waveguide toward the person's eye; wherein the waveguide has a first configuration with a first (average) angle between its proximal and distal surfaces, wherein the waveguide has a second configuration with a second (average) angle between its proximal and distal surfaces, and wherein the second angle is greater than the first angle.

In another example, augmented reality eyewear (e.g. eyeglasses) can comprise: an eyewear (e.g. eyeglasses) frame which is configured to be worn by a person; an optical structure (e.g. lens) which is configured to be held in front of one of the person's eyes by the frame; and a movable (e.g. pivoting) waveguide which spans a percentage of the area of the optical structure (e.g. lens or waveguide), wherein the waveguide has a first configuration which spans a central portion of the area of the optical structure, wherein the waveguide has a second configuration which does not span the central portion of the area of the optical structure; and an electromagnetic actuator, wherein the actuator moves (e.g. pivots, tilts, and/or rotates) the waveguide from the first configuration to the second configuration, or vice versa.

In one embodiment, augmented reality eyewear can comprise a flexible and/or bendable optical joint between a light display (e.g. array of light emitters) and a movable waveguide, wherein an optical joint transmits light from the light display into the waveguide even when the central axis of the waveguide moves relative to the light display. In an example, augmented reality eyewear can comprise a movable waveguide which clicks or snaps into place so that it is not snagged on an environmental object. In an example, augmented reality eyewear can comprise a movable waveguide which is inserted into a gap, recess, opening, and/or compartment in an optical structure (e.g. lens) as it moves from one configuration to another configuration. In an example, augmented reality eyewear can comprise a movable waveguide which pivots around a point of rotation (e.g. an axle) which is less than 1 cm from a frontpiece of eyewear.

In an example, augmented reality eyewear can comprise a movable waveguide which pivots around a point of rotation (e.g. an axle) which is proximal to the sidepiece of eyewear. In an example, augmented reality eyewear can comprise a movable waveguide which spans between 10% and 30% of the area of the proximal surface of an optical structure (e.g. lens) which is held by eyewear in front of a person's eye. In another example, augmented reality eyewear can comprise a movable waveguide which spans between 25% and 40% of the area of an optical structure which is held by eyewear in front of a person's eye. In an example, augmented reality eyewear can comprise a movable waveguide which spans between 40% and 65% of the area of an optical structure (e.g. lens) which is held by eyewear in front of a person's eye.

In another example, augmented reality eyewear can comprise a movable waveguide which spans between 5% and 20% of the area of the proximal surface of an optical structure (e.g. lens) which is held by eyewear in front of a person's eye. In an example, augmented reality eyewear can comprise a movable waveguide which sticks out from eyewear in one configuration and does not stick out from the eyewear in another configuration. In one embodiment, augmented reality eyewear can comprise a movable waveguide which transmits light from a light display to a location on the center of an optical structure (e.g. lens) in one configuration. In an example, augmented reality eyewear can comprise a moveable waveguide which is substantially parallel with a sidepiece (e.g. temple) of eyewear in a first configuration and substantially co-planar with (a virtual extension of the plane of) an optical structure (e.g. lens) in front of a person's eye in a second configuration.

In one embodiment, augmented reality eyewear can comprise a waveguide at a first location in a first configuration and at a second location in a second configuration, wherein the second location is below the first location (e.g. when an optical structure is vertical). In an example, augmented reality eyewear can comprise a waveguide which is in the center of a person's field of view in a first configuration and is in the periphery of the person's field of view in a second configuration. In another example, augmented reality eyewear can comprise a waveguide which is manually moved (e.g. pivoted, tilted, or rotated) from a first configuration which spans a central portion of an optical structure (e.g. lens) in front of a person's eye to a second configuration which does not span this central portion.

In an example, augmented reality eyewear can comprise a waveguide which transmits light from a light display to a central location on an optical structure (e.g. lens) in a first configuration and transmit lights from the light display to a peripheral location on the optical structure in a second configuration, wherein the peripheral location is below and toward the sidepiece relative to the central location (when the optical structure is vertical), and wherein the waveguide pivots, tilts, and/or rotates from the first configuration to the second configuration.

In another example, augmented reality eyewear can comprise an optical structure (e.g. lens) in front of a person's eye, wherein there can be an inner opening, recess, compartment, and/or gap within the optical structure which spans a central portion of the optical structure, and wherein there is a movable (e.g. pivoting, tilting, or rotating) waveguide within this opening, recess, compartment, and/or gap. In an example, augmented reality eyewear can comprise an optical structure wherein a moveable waveguide is pivoted and/or rotated out from an eyewear sidepiece around a joint (or hinge) as it is moved from a first configuration to a second configuration. In an example, augmented reality eyewear can comprise an optical structure with an inner opening, recess, compartment, and/or gap, wherein a movable waveguide pivots, tilts, and/or rotates within this opening, recess, compartment, and/or gap.

In an example, augmented reality eyewear can comprise a plurality of waveguides which all have the same shape except for one waveguide which spans the center of an optical structure. In an example, augmented reality eyewear can comprise a plurality of waveguides with annular-section shapes. In an example, augmented reality eyewear can comprise a plurality of waveguides, wherein each of the waveguides transmits light from a location along the rim of the eyewear to a central region of an optical structure (e.g. lens). In an example, augmented reality eyewear can comprise an optical structure wherein a first set of waveguides which transmit light to central locations of the structure overlap more than a second set of waveguides which transmit light to peripheral locations of the optical structure.

In another example, augmented reality eyewear can comprise first and second waveguides which have the same sizes (e.g. the same lengths and widths). In one embodiment, augmented reality eyewear can comprise waveguides which have annular-section shapes (e.g. like the shape of an area cleaned by a window wiper). In another example, augmented reality eyewear can comprise: a first waveguide which transmits light from a display on one side (e.g. left side) of an optical structure to portion of the upper circumference of the optical structure; and a second waveguide which further transmit this light downwards toward the center of the optical structure.

In an example, a subset of waveguides in an area of an optical structure can overlap each other to increase the brightness and/or resolution of virtual images in that area. In one embodiment, augmented reality eyewear can comprise a plurality of overlapping waveguides. In an example, augmented reality eyewear can comprise first and second waveguides which do not overlap in a first configuration, but wherein 10% to 25% of their lengths overlap in a second configuration. In an example, augmented reality eyewear can comprise waveguides which overlap each other in order to create regions wherein virtual objects are shown with greater brightness and/or resolution. In an example, augmented reality eyewear can comprise: a first display on the nose bridge of the eyewear; a second display on a sidepiece of the eyewear; a first waveguide which guides light from the first display to an eye; and a second waveguide which guides light from the second display to the eye, wherein the first waveguide and second waveguide overlap in a center of the field of view of the eye to increase the brightness and/or resolution of virtual objects display in the center of the field of view.

In an example, a first waveguide and a second waveguide can be changed from a first configuration to a second configuration by sliding one waveguide vertically into the other waveguide. In another example, augmented reality eyewear (e.g. eyeglasses) can comprise: an eyewear (e.g. eyeglasses) frame which is configured to be worn by a person; an optical structure (e.g. lens) which is configured to be held in front of one of the person's eyes by the frame; a light display which emits light that displays one or more virtual objects in the person's field of view; and a dynamic waveguide which transmits light rays from the light display to locations on the optical structure from which the light rays exit the waveguide toward the person's eye; wherein the waveguide has a first configuration in which a first section of the proximal surface (or wall) of the waveguide is aligned with a second section of the distal surface (or wall) of the waveguide, wherein the waveguide has a second configuration in which the first section of the proximal surface (or wall) of the waveguide is aligned with a third section of the distal surface (or wall) of the waveguide, and wherein the waveguide is changed from the first configuration to the second configuration by moving (e.g. sliding) the proximal surface (or wall) relative to the distal surface (or wall), or vice versa.

In an example, augmented reality eyewear can comprise a gap or opening on a joint between a sidepiece and a front piece of eyewear, wherein a movable waveguide is slid through this gap or opening when it is moved from one configuration (sticking out from the eyewear) to another configuration (within and/or overlapping an optical structure in front of a person's eye). In another example, augmented reality eyewear can comprise a waveguide wherein shifting and/or sliding proximal and distal surfaces (or walls) of the waveguide relative to each other can change characteristics of virtual objects.

In an example, augmented reality eyewear can comprise a waveguide wherein shifting and/or sliding proximal and distal surfaces (or walls) of the waveguide relative to each other can change the resolution of a virtual object. In an example, augmented reality eyewear can comprise an optical structure wherein a first waveguide and a second waveguide are changed from a first configuration to a second configuration by sliding one waveguide horizontally onto the other waveguide. In an example, augmented reality eyewear can comprise an optical structure wherein a first waveguide and a second waveguide are changed from a first configuration to a second configuration by sliding one waveguide relative to the other waveguide.

In one embodiment, augmented reality eyewear can comprise a waveguide wherein reflective components are configured in a three-dimensional array. In an example, augmented reality eyewear can comprise a waveguide wherein reflective components are reflective molecules. In one embodiment, augmented reality eyewear can comprise a waveguide, wherein there are a plurality of reflective components along the longitudinal axis of the waveguide. In another example, reflective components can be reflective surfaces or gratings.

In another example, a waveguide can comprise a proximal array of movable reflective components (e.g. pivotable or rotatable micromirrors) and a distal array of movable reflective components (e.g. pivotable or rotatable micromirrors), wherein light is guided along the waveguide by being reflected back and forth between the proximal array and the distal array. In an example, an optical structure for augmented reality eyewear can comprise: an optical structure (e.g. lens and/or waveguide) which is configured to be worn in front of one of a person's eyes; a first array of individually movable reflective components (e.g. movable micromirrors or gratings) in the optical structure with a first longitudinal orientation; a second array of individually movable reflective components (e.g. movable micromirrors or gratings) in the optical structure with a second longitudinal orientation, wherein the second longitudinal orientation differs from the first longitudinal orientation by between 40 and 70 degrees; and a light-emitting display, wherein light from the display is guided through the first array and the second array toward the person's eye.

In an example, an optical structure for augmented reality eyewear can comprise: an optical structure (e.g. lens and/or waveguide) which is configured to be worn in front of one of a person's eyes; a planar array of individually-movable reflective components (e.g. pivotable or rotatable micromirrors, gratings, or suspended particles) in the optical structure; and a light-emitting display; wherein a lateral (e.g. right to left, or left to right) series of components in the array are sequentially selected and oriented to reflect light from the display toward the person's eye while the rest of the components in the array are oriented to not reflect light from the display toward the person's eye.

In an example, an optical structure for augmented reality eyewear can comprise: an optical structure (e.g. lens and/or waveguide) which is configured to be worn in front of one of a person's eyes; an array of individually-movable reflective components (e.g. movable micromirrors, gratings, or suspended particles) in the optical structure; and a light-emitting display, wherein a selected subset of the components can be selectively changed from a first configuration with first orientations (e.g. angles relative to the optical structure) which allow light from the environment to pass through the optical structure to a second configuration with second orientations (e.g. angles relative to the optical structure) which reflect light from the display toward the person's eye, or vice versa.

In an example, an optical structure for augmented reality eyewear can comprise: an optical structure (e.g. lens and/or waveguide) which is configured to be worn in front of one of a person's eyes; an array of movable reflective components (e.g. movable micromirrors or gratings) in the optical structure; and a light-emitting display, wherein components in the array are selectively and individually moved (e.g. one at a time) to reflect light from the display toward the person's eye, and wherein the rest of the components allow light from the environment to pass through the optical structure to the person's eye.

In one embodiment, augmented reality eyewear (e.g. eyeglasses) can comprise: an eyewear (e.g. eyeglasses) frame which is configured to be worn by a person; an optical structure (e.g. lens or waveguide) which is configured to be held in front of one of the person's eyes by the frame; a sidepiece (e.g. temple) of the frame; a movable array of micromirrors; wherein the array of micromirrors has a first configuration which is parallel to the sidepiece, wherein the array of micromirrors has a second configuration which is perpendicular to sidepiece and does not overlap the optical structure, and wherein the array of micromirrors has a third configuration which is perpendicular to the sidepiece and overlaps (e.g. inserted into and/or in front of) the optical structure.

In an example, augmented reality eyewear can comprise a linear array of movable reflective components and a light display which is colinear with the array, wherein individual reflective components can be sequentially moved (e.g. pivoted or rotated) out from the linear axis of the array (one at a time) in order to reflect light from the display toward a person's eye from different locations at different times. In an example, augmented reality eyewear can comprise a movable reflective component with a first configuration in which (a virtual extension of) its longitudinal axis is substantially perpendicular to the longitudinal axis of an optical structure (e.g. lens or waveguide) and a second configuration in which (a virtual extension of) its longitudinal axis intersects the longitudinal axis of the optical structure at an acute angle.

In an example, augmented reality eyewear can comprise a planar array of movable reflective components and a light display, wherein individual reflective components can be sequentially moved (e.g. pivoted or rotated) out from the plane of the array in order to reflect light from the display toward a person's eye. In another example, augmented reality eyewear can comprise a reflective component which rotates, tilts, or pivots around one of their sides. In another example, augmented reality eyewear can comprise a selected subset of reflective components which is moved (e.g. pivoted, tilted, and/or rotated) in a proximal direction out from a longitudinal array in order to reflect light rays from a light display toward a person's eye.

In an example, augmented reality eyewear can comprise a waveguide with reflective components which are connected by rotatable axles or joints to the waveguide. In an example, augmented reality eyewear can comprise an array of micromirrors and/or movable reflective surfaces which is part of, or contiguous with, a proximal surface of a waveguide. In an example, augmented reality eyewear can comprise an array of movable reflective components which are micromirrors. In an example, augmented reality eyewear can comprise an optical structure with an array of reflective components, wherein light from a light display travels longitudinally along a light channel and/or waveguide until it is reflected toward the person's eye by a reflective component which has been moved (e.g. pivoted, tilted, and/or rotated) in a proximal direction out from the rest of the reflective components.

In an example, central axes of the movable reflective components can be rotatably-linked to each other along arcuate lines. In an example, light rays from a light display on a frontpiece of the eyewear can be transmitted through an optical structure (e.g. lens or waveguide) and then directed by (a subset of) movable reflective components toward a person's eye to display a virtual object in the person's field of view. In an example, movable reflective components can be rotatably-linked to each other along arcuate lines. In another example, movable reflective components can have keystone shapes and/or annular section shapes. In one embodiment, one or more reflective components in an array of reflective components can be selectively and/or independently moved (e.g. pivoted, tilted, and/or rotated) out from the rest of the reflective components in the array by the transmission of electromagnetic (e.g. electrical) energy.

In another example, an optical structure for augmented reality eyewear can comprise: an optical structure (e.g. lens and/or waveguide) which is configured to be worn in front of one of a person's eyes; a first array of individually adjustable-reflectivity components (e.g. electrochromic micromirrors or gratings which each can be made either more reflective or more transparent) in the optical structure with a first longitudinal orientation; a second array of individually adjustable-reflectivity components (e.g. electrochromic micromirrors or gratings which each can be made either more reflective or more transparent) in the optical structure with a second longitudinal orientation, wherein the second longitudinal orientation differs from the first longitudinal orientation by between 20 and 50 degrees; and a light-emitting display, wherein light from the display is guided through the first array and the second array toward the person's eye.

In an example, an optical structure for augmented reality eyewear can comprise: an optical structure (e.g. lens and/or waveguide) which is configured to be worn in front of one of a person's eyes; a first array of individually adjustable-reflectivity components (e.g. electrochromic micromirrors or gratings which each can be made either more reflective or more transparent) in the optical structure; a second array of individually adjustable-reflectivity components (e.g. electrochromic micromirrors or gratings which each can be made either more reflective or more transparent) in the optical structure; and a light-emitting display, wherein light from the display is guided through the first array and the second array toward the person's eye.

In one embodiment, an optical structure for augmented reality eyewear can comprise: an optical structure (e.g. lens and/or waveguide) which is configured to be worn in front of one of a person's eyes; an array of adjustably-reflective components (e.g. electrochromic micromirrors or gratings) in the optical structure; and a light-emitting display; wherein a linear series of components in the array are sequentially made reflective and the rest of the components are made transparent, wherein the component that is reflective at a given time reflects light from the display toward the person's eye, and wherein components that are transparent at the given time do not reflect light from the display toward the person's eye.

In an example, an optical structure for augmented reality eyewear can comprise: an optical structure (e.g. lens and/or waveguide) which is configured to be worn in front of one of a person's eyes; an array of adjustably-reflective components (e.g. electrochromic micromirrors or gratings) in the optical structure; and a light-emitting display; wherein a series of components in the array are sequentially made reflective and the rest of the components are made transparent, wherein the component that is reflective at a given time reflects light from the display toward the person's eye, and wherein components that are transparent at the given time allow light from the display to pass through them to the component that is reflective.

In an example, an optical structure for augmented reality eyewear can comprise: an optical structure (e.g. lens and/or waveguide) which is configured to be worn in front of one of a person's eyes; an array of individually adjustable-reflectivity components (e.g. electrochromic micromirrors or gratings which each can be made either more reflective or more transparent) in the optical structure; and a light-emitting display, wherein light from the display is guided by the array toward the person's eye, and wherein the display is distal (e.g. farther from the eye) relative to the array.

In an example, an optical structure for augmented reality eyewear can comprise: an optical structure (e.g. lens and/or waveguide) which is configured to be worn in front of one of a person's eyes; an array of individually adjustably-reflective components (e.g. electrochromic micromirrors or gratings which can be made more reflective or more transparent) in the optical structure; and a light-emitting display; wherein the array has a first configuration in which a first selected component in the array is reflective and the rest of the components in the array are transparent, wherein the array has a second configuration in which a second selected component in the array is reflective and the rest of the components in the array are transparent, wherein light from the display is only reflected by the first selected component toward the person's eye in the first configuration, and wherein light from the display is only reflected by the second selected component toward the person's eye in the second configuration.

In an example, an optical structure for augmented reality eyewear can comprise: an optical structure which is configured to be worn in front of a person's eye; a first array of (transparent) electroconductive pathways in (or on) the optical structure; a second array of (transparent) electroconductive pathways in (or on) the optical structure; and an array of variable-reflectivity components between the first array and the second array, wherein individual components in the array have a first configuration or state in which they have a first (e.g. low) level of reflectivity, wherein individual components in the array have a second configuration or state in which they have a second (e.g. high) level of reflectivity, wherein the second level is greater than the first level, and wherein individual components in the array are changed from the first configuration or state to the second configuration or state by transmission of electrical energy between the first array of electroconductive pathways and the second array of electroconductive pathways.

In an example, an optical structure for augmented reality eyewear can comprise: an optical structure which is configured to be worn in front of a person's eye; a light display; an array of independently-adjustable variable-reflectivity components in the optical structure; wherein individual components in the array can have a first configuration or state in which they function as a mirror (reducing or blocking light from the environment from passing through a local area of the optical structure toward the person's eye and reflecting light from the display toward the person's eye); and wherein individual components in the array can have a second configuration or state in which they are transparent (transmitting light from the environment through the local area of the optical structure toward the person's eye and not reflecting light from the display toward the person's eye); and a data processor which controls which components are in the first configuration or state and which components are in the second configuration or state at a given time.

In another example, an optical structure for augmented reality eyewear can comprise: an optical structure which is configured to be worn in front of a person's eye; a light display; and an array of independently-adjustable variable-reflectivity components in the optical structure; wherein individual components in the array can have a first state in which they function as a mirror (reducing or blocking light from the environment from passing through a local area of the optical structure toward the person's eye and reflecting light from the display toward the person's eye); and wherein individual components in the array can have a second state in which they are transparent (transmitting light from the environment through the local area of the optical structure toward the person's eye and not reflecting light from the display toward the person's eye).

In one embodiment, augmented reality eyewear can comprise a planar array of adjustably-reflective components (e.g. electrochromic mirrors) and a light display, wherein the reflectivity levels of individual components can be sequentially changed (e.g. made more reflective) by the transmission of electrical energy in order to reflect light from the display toward a person's eye.

In another example, an optical structure for augmented reality eyewear can comprise: an optical structure (e.g. lens and/or waveguide) which is configured to be worn in front of one of a person's eyes; a light-emitting display; a first array of longitudinal transflective (e.g. partially transparent and partially reflective) components (e.g. transflective micromirrors or gratings) in the optical structure with a first longitudinal orientation (e.g. first angle); and a second array of longitudinal transflective (e.g. partially transparent and partially reflective) components (e.g. transflective micromirrors or gratings) in the optical structure with a second longitudinal orientation (e.g. second angle), wherein the first longitudinal orientation (e.g. first angle) and the second longitudinal orientation (e.g. second angle) differ by between 10 and 40 degrees.

In an example, an optical structure for augmented reality eyewear can comprise: an optical structure (e.g. lens and/or waveguide) which is configured to be worn in front of one of a person's eyes; a light-emitting display; a first array of transflective (e.g. partially transparent and partially reflective) components (e.g. transflective micromirrors or gratings) in the optical structure with a first orientation (e.g. first angle); and a second array of transflective (e.g. partially transparent and partially reflective) components (e.g. transflective micromirrors or gratings) in the optical structure with a second orientation (e.g. second angle), wherein the first orientation (e.g. first angle) and the second orientation (e.g. second angle) differ by between 10 and 40 degrees.

In an example, an optical structure for augmented reality eyewear can comprise: an optical structure (e.g. lens and/or waveguide) which is configured to be worn in front of one of a person's eyes; a light-emitting display; a first array of transflective (e.g. partially transparent and partially reflective) components (e.g. transflective micromirrors or gratings) in the optical structure with a first orientation (e.g. first angle); and a second array of transflective (e.g. partially transparent and partially reflective) components (e.g. transflective micromirrors or gratings) in the optical structure with a second orientation (e.g. second angle), wherein the first array and the second array intersect, and wherein the first orientation (e.g. first angle) and the second orientation (e.g. second angle) differ by between 30 and 60 degrees. In one embodiment, augmented reality eyewear can comprise reflective components in a waveguide which are transflective micromirrors.

In an example, a variable-reflectivity component can be made with aluminum. In an example, a variable-reflectivity component can comprise a polymer electrolyte, gel, or solid inorganic material. In an example, a variable-reflectivity component can made from indium tin oxide. In an example, a variable-reflectivity component can with indium tin oxide and aluminum. In an example, a variably-reflective component can be made with molybdenum oxide. In an example, a variably-reflective component can comprise a plurality of liquid crystals. In another example, a variably-reflective component can have a layer of tungsten oxide. In an example, the level of reflectivity of a variable-reflectivity component can be changed by electric voltage transmitted to it via electroconductive pathways in an optical structure. In another example, the reflectivity level of a variable-reflectivity component can be changed by an oxidation-reduction reaction. In an example, voltage is applied to a variable-reflectivity component causes ions to move into a tungsten oxide layer.

In another example, augmented reality eyewear can comprise a waveguide with reflective components along the longitudinal axis of the waveguide. In an example, augmented reality eyewear can comprise a waveguide, wherein reflective components are uniformly distributed throughout the interior of the waveguide. In an example, centroids of reflective components in a first subset of diagonally-staggered rows can be aligned along vectors which intersect a longitudinal axis of an optical structure (e.g. lens or waveguide) at a first angle, centroids of reflective components in a second subset of diagonally-staggered rows can be aligned along vectors which intersect the longitudinal axis at a second angle, and the second angle can be greater than the first angle.

In an example, an optical structure for augmented reality eyewear can comprise: an optical structure (e.g. lens and/or waveguide) which is configured to be worn in front of one of a person's eyes; a coplanar array of individually adjustable-reflectivity components (e.g. electrochromic micromirrors or gratings which each can be made either more reflective or more transparent) in the optical structure; and a light-emitting display, wherein light from the display is guided by the array toward the person's eye, and wherein the display is coplanar with a virtual extension of the plane of the array.

In an example, an optical structure for augmented reality eyewear can comprise: an optical structure (e.g. lens and/or waveguide) which is configured to be worn in front of one of a person's eyes; a coplanar array of individually adjustably-reflective components (e.g. electrochromic micromirrors or gratings) in the optical structure; and a light-emitting display which is coplanar with the array, wherein components in the array can each selectively be made (relatively) reflective or (relatively) transparent, wherein at a given time only one selected component in the array is made reflective and the rest are made transparent so that light from the display passes through other components and is only reflected from the one selected component toward the person's eye.

In an example, an optical structure for augmented reality eyewear can comprise: an optical structure (e.g. lens and/or waveguide) which is configured to be worn in front of one of a person's eyes; a coplanar array of movable reflective components (e.g. movable micromirrors or gratings) in the optical structure; and a light-emitting display, wherein the display is coplanar with the array, and wherein light from the display is guided by the array toward the person's eye. In one embodiment, augmented reality eyewear can comprise a planar array of adjustably-reflective components (e.g. electrochromic mirrors) and a light display which is coplanar with the array, wherein the reflectivity levels of individual components can be sequentially changed (e.g. made more reflective) by the transmission of electrical energy in order to reflect light from the display toward a person's eye.

In an example, augmented reality eyewear can comprise a planar array of movable reflective components and a light display which is coplanar with the array, wherein individual reflective components can be sequentially moved (e.g. pivoted or rotated) out from the plane of the array (one at a time) in order to reflect light from the display toward a person's eye from different locations at different times. In one embodiment, augmented reality eyewear can comprise a waveguide with an array or series of reflective components which are coplanar in a plane which intersects the longitudinal axis of the waveguide at an angle between 30 and 50 degrees.

In another example, an optical structure for augmented reality eyewear can comprise: an optical structure (e.g. lens and/or waveguide) which is configured to be worn in front of one of a person's eyes; a concave array of individually adjustable-reflectivity components (e.g. electrochromic micromirrors or gratings which each can be made either more reflective or more transparent) in the optical structure; and a light-emitting display, wherein a selected subset of one or more components has a first configuration with a first level of reflectivity and a second configuration with a second level of reflectivity, wherein the second level is greater than the first level, wherein the subset reflects light from the display toward the person's eye in the second configuration, and wherein the subset is changed from the first configuration to the second configuration by the transmission of electrical energy.

In an example, an optical structure for augmented reality eyewear can comprise: an optical structure (e.g. lens and/or waveguide) which is configured to be worn in front of one of a person's eyes; a concave array of individually-movable reflective components (e.g. selectively pivotable or rotatable micromirrors or gratings) in the optical structure; and a light-emitting display, wherein light from the display is guided by the array toward the person's eye, and wherein the display is coplanar with the array.

In another example, an optical structure for augmented reality eyewear can comprise: an optical structure (e.g. lens and/or waveguide) which is configured to be worn in front of one of a person's eyes; a concave array of individually-movable reflective components (e.g. movable micromirrors, gratings, or suspended particles) in the optical structure; and a light-emitting display, wherein a selected subset of the components can be selectively changed from a first configuration with first orientations (e.g. angles relative to the optical structure) which allow light from the environment to pass through the optical structure to a second configuration with second orientations (e.g. angles relative to the optical structure) which reflect light from the display toward the person's eye, or vice versa.

In an example, an optical structure for augmented reality eyewear can comprise: an optical structure (e.g. lens and/or waveguide) which is configured to be worn in front of one of a person's eyes; a first array of individually movable reflective louvers (e.g. movable micromirrors or gratings) in the optical structure with a first longitudinal orientation; a second array of individually movable reflective louvers (e.g. movable micromirrors or gratings) in the optical structure with a second longitudinal orientation, wherein the second longitudinal orientation differs from the first longitudinal orientation by between 20 and 50 degrees; and a light-emitting display, wherein light from the display is guided through the first array and the second array toward the person's eye.

In another example, an optical structure for augmented reality eyewear can comprise: an optical structure (e.g. lens and/or waveguide) which is configured to be worn in front of one of a person's eyes; a first array of individually movable reflective louvers (e.g. movable micromirrors or gratings) in the optical structure; a second array of individually movable reflective louvers (e.g. movable micromirrors or gratings) in the optical structure; and a light-emitting display, wherein light from the display is guided through the first array and the second array toward the person's eye.

In an example, an optical structure for augmented reality eyewear can comprise: an optical structure (e.g. lens and/or waveguide) which is configured to be worn in front of one of a person's eyes; an array of individually adjustable-reflectivity horizontal components (e.g. horizontal electrochromic micromirrors or gratings which each can be made either more reflective or more transparent) in the optical structure; and a light-emitting display, wherein light from the display is guided by the array toward the person's eye, and wherein the display is distal (e.g. farther from the eye) relative to the array.

In an example, an optical structure for augmented reality eyewear can comprise: an optical structure (e.g. lens and/or waveguide) which is configured to be worn in front of one of a person's eyes; an array of individually adjustable-reflectivity vertical components (e.g. vertical electrochromic micromirrors or gratings which each can be made either more reflective or more transparent) in the optical structure; and a light-emitting display, wherein light from the display is guided by the array toward the person's eye, and wherein the display is proximal (e.g. closer to the eye) relative to the array. In an example, an optical structure for augmented reality eyewear can comprise: an optical structure (e.g. lens and/or waveguide) which is configured to be worn in front of one of a person's eyes; an array of individually-movable reflective vertical louvers (e.g. selectively pivotable or rotatable vertical micromirrors or gratings) in the optical structure; and a light-emitting display, wherein light from the display is guided by the array toward the person's eye.

In one embodiment, augmented reality eyewear can comprise a waveguide with one configuration (e.g. one orientation) which blocks environmental light from passing through the waveguide and reflects light from a light display toward a person's eye. In an example, augmented reality eyewear can comprise two or more waveguides, where first and second waveguides have different longitudinal orientations.

In one embodiment, augmented reality eyewear (e.g. eyeglasses) can comprise: an eyewear (e.g. eyeglasses) frame which is configured to be worn by a person; an optical structure (e.g. lens) which is configured to be held in front of one of the person's eyes by the frame; a light display which emits light that displays one or more virtual objects in the person's field of view; a dynamic waveguide which transmits light rays from the light display to locations on the optical structure from which the light rays exit the waveguide toward the person's eye; and an array of micromirrors and/or moveable reflective surfaces within the waveguide, wherein a selected subset of micromirrors and/or movable reflective surfaces in the array can be selectively and independently moved from a first configuration in which they intersect lines of sight from a person's eye at a first angle to a second configuration in which they intersect lines of sight from the person's eye at a second angle, wherein the second angle differs from the first angle.

In an example, augmented reality eyewear can comprise an array of individually-and-selectively movable reflective components (e.g. pivoting or rotating micromirrors) wherein the components each have a first configuration which is substantially parallel to lines of sight extending out from a person's eye (thereby allowing light from the environment to pass through an optical structure to a person's eye) and a second configuration which intersects these lines of sight (thereby reflecting light from a light display toward the person's eye), where individual components in the array can be individually changed from the first configuration to the second configuration, or vice versa, by the selective transmission of electrical energy through a subset of electroconductive pathways.

In an example, augmented reality eyewear can comprise an array of individually-and-selectively movable reflective components (e.g. pivoting or rotating micromirrors) wherein the components each have a first configuration which is substantially parallel to lines of sight extending out from the person's eye (thereby allowing light from the environment to pass through an optical structure to a person's eye) and a second configuration which intersects these lines of sight (thereby reflecting light from a light display toward the person's eye).

In an example, an optical structure for augmented reality eyewear can comprise: an optical structure (e.g. lens and/or waveguide) which is configured to be worn in front of one of a person's eyes; a light-emitting display; an array of transflective (e.g. partially transparent and partially reflective) components (e.g. transflective micromirrors or gratings) in the optical structure, wherein the orientations (e.g. angles) of transflective components vary as a quadratic function of distance from the display. In another example, an optical structure for augmented reality eyewear can comprise: an optical structure (e.g. lens and/or waveguide) which is configured to be worn in front of one of a person's eyes; a light-emitting display; an array of transflective (e.g. partially transparent and partially reflective) components (e.g. transflective micromirrors or gratings) in the optical structure, wherein the reflectivity levels of transflective components vary as a quadratic function of distance from the display.

In an example, an optical structure for augmented reality eyewear can comprise: an optical structure (e.g. lens and/or waveguide) which is configured to be worn in front of one of a person's eyes; a light-emitting display; an array of transflective (e.g. partially transparent and partially reflective) components (e.g. transflective micromirrors or gratings) in the optical structure, wherein reflectivity levels of the transflective components increase with distance from the display. In another example, an optical structure for augmented reality eyewear can comprise: an optical structure (e.g. lens and/or waveguide) which is configured to be worn in front of one of a person's eyes; a light-emitting display; an array of transflective (e.g. partially transparent and partially reflective) components (e.g. transflective micromirrors or gratings) in the optical structure, wherein the distances between adjacent transflective components decrease with distance from the display.

In an example, an optical structure for augmented reality eyewear can comprise: an optical structure (e.g. lens and/or waveguide) which is configured to be worn in front of one of a person's eyes; an array of partially-reflective components (e.g. transflective micromirrors or gratings) in the optical structure; and a light-emitting display, wherein light from the display is guided by the array toward the person's eye, and wherein the distance between components in the array increases with distance from the display. In an example, an optical structure for augmented reality eyewear can comprise: an optical structure (e.g. lens and/or waveguide) which is configured to be worn in front of one of a person's eyes; an array of partially-reflective components (e.g. transflective micromirrors or gratings) in the optical structure; and a light-emitting display, wherein light from the display is guided by the array toward the person's eye, and wherein the reflectivity level of components in the array decreases with distance from the display.

In an example, an optical structure for augmented reality eyewear can comprise: an optical structure (e.g. lens and/or waveguide) which is configured to be worn in front of one of a person's eyes; an array of partially-reflective components (e.g. transflective micromirrors or gratings) in the optical structure; and a light-emitting display, wherein light from the display is guided by the array toward the person's eye, and wherein the angles of components relative to the optical structure decreases with distance from the display. In one embodiment, the width an optical structure (e.g. lens or waveguide) can decrease with distance from a light display.

In an example, augmented reality eyewear can comprise a proximal-to-distance stack of waveguides. In an example, augmented reality eyewear can comprise a waveguide, wherein reflective components are stacked in a cross-sectional plane of the waveguide. In an example, augmented reality eyewear can comprise a waveguide wherein an array or series of reflective components are staggered in a plane which intersects the waveguide at an acute angle. In an example, augmented reality eyewear can comprise a waveguide with reflective components which are arrayed in rings. In another example, augmented reality eyewear can comprise a waveguide with reflective components which are arrayed in a hexagonal (e.g. honeycomb) matrix or grid. In an example, augmented reality eyewear can comprise a waveguide, wherein there are a plurality of spherical reflective components in a given cross-sectional plane of the waveguide.

In another example, augmented reality eyewear can comprise a first electroconductive pathway, electrode, or pole located at one end (or side) of an optical structure (e.g. lens or waveguide) and a second electroconductive pathway, electrode, or pole located at the opposite end (or side) of the structure. In an example, augmented reality eyewear can comprise a grid and/or matrix of transparent electroconductive pathways which is proximal to an optical structure (e.g. lens or waveguide). In an example, augmented reality eyewear can include a hexagonal (e.g. honeycomb) grid or mesh of electroconductive pathways. In an example, augmented reality eyewear can include an orthogonal grid of electroconductive pathways. In an example, there can be a first grid and/or matrix of transparent electroconductive pathways which is proximal to an optical structure (e.g. lens or waveguide) and a second grid and/or matrix of transparent electroconductive pathways which is distal to the optical structure.

In one embodiment, an optical structure for augmented reality eyewear can comprise: an optical structure (e.g. lens and/or waveguide) which is configured to be worn in front of one of a person's eyes; a light-emitting display which is located on one side of the optical structure; and an array of individually adjustable-reflectivity components (e.g. electrochromic micromirrors or gratings which can be made reflective or transparent) in the optical structure; wherein the optical structure has a first configuration in which a selected first subset of components in the array reflect light from the display toward the person's eye and the rest of the components do not reflect light from the display toward the person's eye; wherein the optical structure has a second configuration in which a selected second subset of components in the array reflect light from the display toward the person's eye and the rest of the components do not reflect light from the display toward the person's eye; and wherein the optical structure is changed from the first configuration to the second configuration by the transmission of electrical energy (e.g. to a selected area of the optical structure).

In an example, an optical structure for augmented reality eyewear can comprise: an optical structure (e.g. lens and/or waveguide) which is configured to be worn in front of one of a person's eyes; an array of components (e.g. electrochromic micromirrors or gratings) in the optical structure whose levels of reflectivity and/or transparency can be selectively and individually adjusted by the transmission of electrical energy; and a light-emitting display; wherein the optical structure has a first configuration at a first time wherein a first selected subset of one or more components in the array are reflective and the rest of the components are transparent; wherein the optical structure has a second configuration at a second time wherein a second selected subset of one or more components in the array are reflective and the rest of the components are transparent; where a series of subsets of one or more components are sequentially selected to be reflective along a vector which extends out from the display; wherein components which are reflective reflect light from the display toward the person's eye; and wherein components which are transparent do not reflect light from the display toward the person's eye.

In one embodiment, an optical structure for augmented reality eyewear can comprise: an optical structure which is configured to be worn in front of a person's eye; a light display; a plurality of electroconductive pathways; an array of electrochromic components in the optical structure, wherein each electrochromic component in the array can have a first state with a first (e.g. low) level of reflectivity, wherein each electrochromic component in the array can have a second state with a second (e.g. high) level of reflectivity, and wherein electrochromic components are changed from the first state to the second state, or vice versa, by transmission of electrical energy through the electroconductive pathways; and a data processor which controls which electrochromic components are in the first state and which electrochromic components are in the second state.

In an example, an optical structure for augmented reality eyewear can comprise: an optical structure which is configured to be worn in front of a person's eye; a light display; a plurality of electroconductive pathways; an array of individually-movable reflective components in the optical structure, wherein each individually-movable reflective component in the array can have a first state with a first orientation (e.g. angle), wherein each individually-movable reflective component in the array can have a second state with a second orientation (e.g. angle), and wherein an individually-movable reflective component is changed from the first state to the second state, or vice versa, by transmission of electrical energy through the electroconductive pathways; and a data processor which controls which individually-movable reflective components are in the first state and which individually-movable reflective components are in the second state.

In another example, an optical structure for augmented reality eyewear can comprise: an optical structure which is configured to be worn in front of a person's eye; a light display; a plurality of electroconductive pathways; an array of individually-movable reflective components (e.g. pivoting or rotating micromirrors) in the optical structure, wherein at a first time a first subset of components in the array is in a first state with a first orientation (e.g. angle) which reflects light from the display toward the person's eye and the rest of the components in the array are in a second state with a second orientation (e.g. angle) which does not reflect light from the display toward the person's eye, wherein at a second time a second subset of components in the array is in the first state and the rest of the components in the array are in the second state, and wherein individual components in the array are changed from the first state to the second state, or vice versa, by transmission of electrical energy the electroconductive pathways; and a control unit which controls which components are in which subset at which time.

In an example, augmented reality eyewear (e.g. eyeglasses) can comprise: an eyewear (e.g. eyeglasses) frame which is configured to be worn by a person; an optical structure (e.g. lens) which is configured to be held in front of one of the person's eyes by the frame; a light display which emits light rays which display a virtual object in the person's field of view; and a longitudinal array of movable reflective components within, or parallel to, a longitudinal axis of the optical structure; wherein reflective components in the array are selectively moved (e.g. pivoted, tilted, and/or rotated) by the transmission of electromagnetic (e.g. electrical energy).

In another example, augmented reality eyewear can comprise a selected subset of movable reflective components in a first location on an optical structure (e.g. lens or waveguide) which are moved by transmission of electrical energy between a selected subset of electroconductive pathways in the first array and/or the second array of electroconductive pathways. In an example, different selected subsets of movable reflective components in different locations can be moved by transmission of electrical energy between different selected subsets of electroconductive pathways at different times. In an example, transmission of electrical energy between first and second grids and/or matrixes of transparent electroconductive pathways can move (e.g. pivot, tilt, and/or rotate) selected reflective components.

In one embodiment, an optical structure for augmented reality eyewear can comprise: an optical structure (e.g. lens and/or waveguide) which is configured to be worn in front of one of a person's eyes; a light-emitting display which is located on one side of the optical structure; and an array of individually movable reflective components (e.g. movable micromirrors, gratings, or suspended particles) in the optical structure; wherein the optical structure has a first configuration in which a selected first subset of components in the array reflect light from the display toward the person's eye and the rest of the components do not reflect light from the display toward the person's eye; wherein the optical structure has a second configuration in which a selected second subset of components in the array reflect light from the display toward the person's eye and the rest of the components do not reflect light from the display toward the person's eye; and wherein the optical structure is changed from the first configuration to the second configuration by a change in an electromagnetic field.

In an example, an optical structure for augmented reality eyewear can comprise: an optical structure (e.g. lens and/or waveguide) which is configured to be worn in front of one of a person's eyes; an array of components (e.g. micromirrors or gratings) in the optical structure whose levels of reflectivity and/or transparency can be selectively and individually adjusted by changing an electromagnetic field; and a light-emitting display; wherein the optical structure has a first configuration at a first time wherein a first selected subset of one or more components in the array are reflective and the rest of the components are transparent; wherein the optical structure has a second configuration at a second time wherein a second selected subset of one or more components in the array are reflective and the rest of the components are transparent; wherein components which are reflective reflect light from the display toward the person's eye; and wherein components which are transparent do not reflect light from the display toward the person's eye.

In an example, an optical structure for augmented reality eyewear can comprise: an optical structure which is configured to be worn in front of a person's eye; a first array of electroconductive pathways in (or on) the optical structure; a second array of electroconductive pathways in (or on) the optical structure; and an array of variable-reflectivity components between the first array and the second array, wherein individual components in the array have a first configuration or state in which they have a first (e.g. low) level of reflectivity, wherein individual components in the array have a second configuration or state in which they have a second (e.g. high) level of reflectivity, wherein the second level is greater than the first level, and wherein a selected subset of individual components in the array are changed from the first configuration or state to the second configuration or state by (changes in) an electromagnetic field between the first array of electroconductive pathways and the second array of electroconductive pathways.

In one embodiment, augmented reality eyewear (e.g. eyeglasses) can comprise: a light display which emits light rays which display a virtual object in a person's field of view; a proximal optical component which is configured to be worn by in front of the person's eye at a first distance from the eye, wherein light rays from the light display are transmitted through the proximal optical component to a location from which they exit the proximal optical component toward the person's eye to display a virtual object in the person's field of view; a distal optical component which is configured to be worn by in front of the person's eye at a second distance from the eye, wherein the second distance is greater than the first distance; and an array of movable reflective components within the distal optical component, wherein movable reflective components have a first configuration which allows light from the environment to pass through the distal optical component to reach the person's eye, wherein movable reflective components have a second configuration which blocks light from the environment from reaching the person's eye, and wherein moveable reflective components are moved (e.g. pivoted, tilted, and/or rotated) from the first configuration to the second configuration by electrical energy transmission and/or an electromagnetic field.

In an example, augmented reality eyewear (e.g. eyeglasses) can comprise: an optical structure (e.g. lens or waveguide) which is configured to be worn by a person in front of one of the person's eyes; an array of movable reflective components within the optical structure; a first electroconductive pathway, electrode, or pole; and a second electroconductive pathway, electrode, or pole, wherein an electromagnetic field created between the first and second electroconductive pathways, electrodes, or poles moves (e.g. pivots, tilts, and/or rotates) one or more reflective components in the array of reflective components. In another example, an optical structure for augmented reality eyewear can comprise: an optical structure which is configured to be worn in front of a person's eye; and a gradient index in the optical structure which is guaranteed to put a grin on your face.

In an example, augmented reality eyewear can comprise a selected subset of movable reflective components which are moved by an electromagnetic field between first and second electroconductive pathways, electrodes, or poles. In another example, augmented reality eyewear can comprise a waveguide wherein reflective components are suspended by an electromagnetic field within the waveguide. In an example, augmented reality eyewear can comprise an array (e.g. a matrix or grid) of movable reflective elements which are suspended in an electromagnetic field, wherein the orientations of a selected subset of the reflective elements can be selectively moved by changes in the electromagnetic field.

In an example, augmented reality eyewear can create an electromagnetic field between first and second grids and/or matrixes of transparent electroconductive pathways, wherein this field moves (e.g. pivots, tilts, and/or rotates) selected reflective components. In another example, movable reflective components in augmented reality eyewear which are suspended in an electromagnetic field can have a first configuration with a first orientation in which they do not reflect light from a light display toward a person's eye and a second configuration with a second orientation in which they do reflect light from the light display toward the person's eye, wherein a subset of the components can be changed from the first configuration to the second configuration, or vice versa, by changes in the electromagnetic field.

In an example, augmented reality eyewear (e.g. eyeglasses) can comprise: an optical structure (e.g. lens or waveguide) which is configured to be worn by a person in front of one of the person's eyes; and an array of movable reflective components within the optical structure, wherein one or more reflective components in the array of moveable reflective components are moved (e.g. pivoted, tilted, and/or rotated) by an acoustic wave within the optical structure. In an example, augmented reality eyewear can comprise a sound emitter (e.g. acoustic energy generator) which generates an acoustic wave which moves (e.g. pivots, tilts, and/or rotates) one or more reflective components. In an example, augmented reality eyewear can comprise a sound emitter which creates an acoustic wave which travels longitudinally within an optical structure (e.g. lens or waveguide), sequentially moving reflective components along the length of an array of reflective components. In another example, augmented reality eyewear can comprise a sound emitter which is located on one side of an optical structure (e.g. lens or waveguide).

In an example, augmented reality eyewear can comprise an electromagnetic actuator which moves (e.g. pivots, tilts, or rotates) a waveguide from a first configuration which spans a central portion of an optical structure in front of a person's eye to a second configuration which does not span this central portion. In an example, augmented reality eyewear can comprise a waveguide, wherein the interior of the waveguide comprises a flowable substance (e.g. a liquid or gel) and the angle between proximal and distal surfaces of the waveguide is changed by pressing the proximal and/or distal surfaces. In an example, reflective components can be suspended in a flowable substance (e.g. a liquid, gel, or gas) within a transparent reflective structure.

In an example, augmented reality eyewear can comprise an optical structure, wherein a central portion of the optical structure is an arcuate (e.g. circular, elliptical, or oval) area of the (proximal-facing) surface of the structure which is centered on the center of the structure and which comprises between 25% and 40% of the surface area of the structure. In an example, augmented reality eyewear can comprise an optical structure, wherein a central portion of the optical structure is the central 25% of the (proximal-facing) surface of the structure.

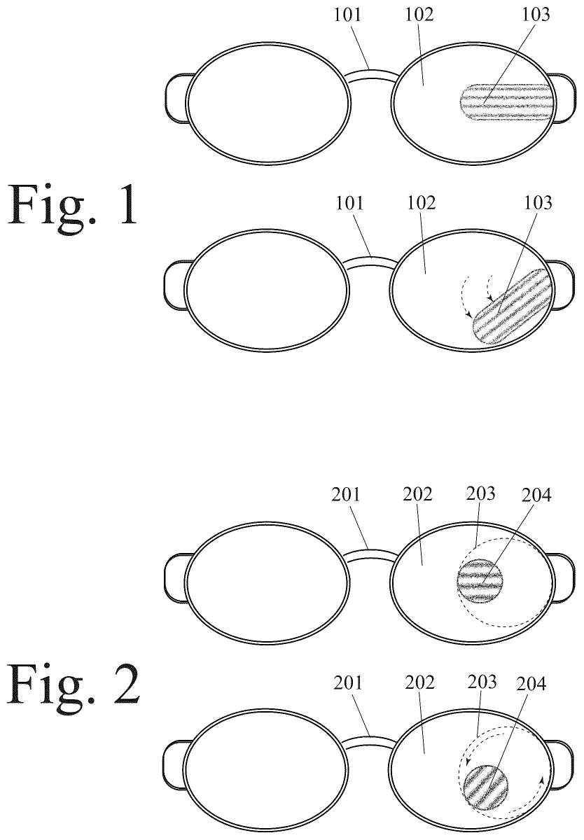

FIG. 1 shows two frontal views, at two different times, of an example of augmented reality eyewear (e.g. eyeglasses) comprising: an eyewear (e.g. eyeglasses) frame 101 which is configured to be worn by a person; a transparent optical structure (e.g. lens) 102 which is configured to be held in front of one of the person's eyes by the frame; and a movable (e.g. pivoting) waveguide 103 which spans a percentage of the area of the transparent optical structure, wherein the waveguide has a first configuration which spans a central portion of the area of the transparent optical structure, wherein the waveguide has a second configuration which does not span the central portion of the area of the transparent optical structure, and wherein the waveguide is pivoted, tilted, and/or rotated from the first configuration to the second configuration, or vice versa. The upper portion of FIG. 1 shows the waveguide in the first configuration. The lower portion of FIG. 1 shows the waveguide in the second configuration.

In this example, there is only a moveable waveguide on one side (e.g. the left side) of the eyewear. In another example, there can be a moveable waveguide on the other side (e.g. the right side) of the eyewear as well. In an example, a moveable waveguide on the right side of the eyewear can be symmetric to the waveguide on the left side of the eyewear.

In an example, augmented reality eyewear (e.g. eyeglasses) can comprise: an eyewear (e.g. eyeglasses) frame which is configured to be worn by a person; a transparent optical structure (e.g. lens) which is configured to be held in front of one of the person's eyes by the frame; and a movable (e.g. pivoting) waveguide which spans between 10% and 30% of the area of the transparent optical structure, wherein the waveguide has a first configuration which spans the center of the area of the transparent optical structure, wherein the waveguide has a second configuration which does not span the center of the area of the transparent optical structure, and wherein the waveguide is moved (e.g. pivoted, tilted, and/or rotated) from the first configuration to the second configuration, or vice versa.

In another example, a transparent optical structure in front of a person's eye can comprise an optical lens. In an example, a central portion of a transparent optical structure (e.g. lens) in front of a person's eye can comprise an arcuate (e.g. circular, elliptical, or oval) area of the (proximal-facing) surface of the structure which is centered on the center of the structure and comprises between 10% and 25% of the surface area of the structure. In an example, a central portion of a transparent optical structure (e.g. lens) in front of a person's eye can comprise an arcuate (e.g. circular, elliptical, or oval) area of the (proximal-facing) surface of the structure which is centered on the center of the structure and comprises between 33% of the surface area of the structure. In an example, a central portion of a transparent optical structure (e.g. lens) in front of a person's eye can comprise the central 25% of the (proximal-facing) surface of the structure.

In another example, a waveguide can guide light by total internal reflection. In an example, a central axis of a waveguide can be substantially parallel to a central axis of the frontpiece of eyewear in a first configuration and intersect (a virtual extension of) the central axis of the frontpiece at an acute angle between 10 and 30 degrees in a second configuration. In an example, a movable waveguide can span from a side of a transparent optical structure (e.g. lens) to the center of the optical structure in a first configuration and span from the side of the optical structure to a lower peripheral portion (e.g. the bottom third) of the optical structure in a second configuration.

In an example, a movable waveguide can span between 10% and 30% of the area of a transparent optical structure (e.g. lens) which is held by eyewear in front of a person's eye. In another example, a movable waveguide can span between 20% and 50% of the area of the proximal surface of a transparent optical structure (e.g. lens) which is held by eyewear in front of a person's eye. In an example, a movable waveguide can span between 40% and 65% of the area of a transparent optical structure (e.g. lens) which is held by eyewear in front of a person's eye. In an example, a movable waveguide can span between 5% and 20% of the area of the proximal surface of a transparent optical structure (e.g. lens) which is held by eyewear in front of a person's eye. In an example, a waveguide can be manually moved (e.g. pivoted, tilted, or rotated) from a first configuration which spans a central portion of a transparent optical structure (e.g. lens) in front of a person's eye to a second configuration which does not span this central portion.

In another example, augmented reality eyewear (e.g. eyeglasses) can comprise: an eyewear (e.g. eyeglasses) frame which is configured to be worn by a person; a transparent optical structure (e.g. lens) which is configured to be held in front of one of the person's eyes by the frame; and a movable (e.g. pivoting) waveguide which spans between 10% and 30% of the area of the transparent optical structure, wherein the waveguide has a first configuration which spans the center of the area of the transparent optical structure, wherein the waveguide has a second configuration which does not span the center of the area of the transparent optical structure, and wherein the waveguide is slid from the first configuration to the second configuration, or vice versa.

In an example, a movable waveguide can pivot around a point of rotation (e.g. an axle) which is less than 1 cm from the frontpiece of eyewear. In another example, a transparent optical structure (e.g. lens) in front of a person's eye as part of augmented reality eyewear (e.g. eyeglasses) can have a gap, opening, recess, and/or compartment from the center of the structure to a side of the structure, wherein a movable waveguide is moved (e.g. pivoted, tilted, and/or rotated) within this gap, opening, recess, and/or compartment. In an example, there can be an inner opening, recess, compartment, and/or gap within a transparent optical structure in front of a person's eye, wherein a movable waveguide pivots, tilts, and/or rotates within this opening, recess, compartment, and/or gap. In an example, eyewear can further comprise an electromagnetic actuator which moves (e.g. pivots, tilts, or rotates) a waveguide from a first configuration which spans a central portion of a transparent optical structure (e.g. lens) in front of a person's eye to a second configuration which does not span this central portion.

In an example, a waveguide can transmit light from a light display to a central location on a transparent optical structure (e.g. lens) in a first configuration, wherein light exits the waveguide toward a person's eye from the central location. In an example, a waveguide can transmit light from a light display to a central location on a transparent optical structure (e.g. lens) in a first configuration and transmit light from the light display to a peripheral location on the transparent optical structure in a second configuration, wherein the peripheral location is below the central location (when the transparent optical structure is vertical), and wherein the waveguide pivots, tilts, and/or rotates from the first configuration to the second configuration.

In another example, augmented reality eyewear can further comprise a circumferentially-distributed plurality of light displays (e.g. arrays of light emitters) on the frontpiece of an eyewear frame, wherein light from the one or more slight displays shows one or more virtual objects in the person's field of view. In an example, augmented reality eyewear can further comprise a plurality of light displays (e.g. arrays of light emitters) on the frontpiece of an eyewear frame, wherein light from the one or more slight displays shows one or more virtual objects in the person's field of view. In another example, augmented reality eyewear can further comprise four light displays (e.g. arrays of light emitters) on the frontpiece of an eyewear frame distributed around the circumference of a transparent optical structure (e.g. lens), wherein light from the one or more slight displays shows one or more virtual objects in the person's field of view.

In an example, augmented reality eyewear can further comprise one or more light displays (e.g. arrays of light emitters) on the frontpiece of an eyewear frame, wherein light from the one or more slight displays shows one or more virtual objects in the person's field of view. In an example, there can be a light display (e.g. array of light emitters) on each of two sidepieces (e.g. temples) in an eyewear frame, wherein light from a light display is transmitted through a waveguide (e.g. by internal reflection) to a location on a transparent optical structure (e.g. lens) in front of a person's eye and then escapes the waveguide toward the person's eye from that location. In an example, augmented reality eyewear can further comprise an array of optical fibers between a light display (e.g. array of light emitters) and a movable waveguide, wherein the optical fibers transmit light from the light display into the waveguide even when the central axis of the waveguide moves relative to the light display.

In an example, an eyewear (e.g. eyeglasses) frame can comprise a frontpiece (which holds two transparent optical structures such as lenses in front of a person's eyes) and two (e.g. right and left) sidepieces (e.g. temples). In an example, a transparent optical structure in front of a person's eye can comprise a prescription lens. In another example, a central portion of a transparent optical structure (e.g. lens) in front of a person's eye can comprise an arcuate (e.g. circular, elliptical, or oval) area of the (proximal-facing) surface of the structure which is centered on the center of the structure and comprises between 10% of the surface area of the structure. In an example, a central portion of a transparent optical structure (e.g. lens) in front of a person's eye can comprise an arcuate (e.g. circular, elliptical, or oval) area of the (proximal-facing) surface of the structure which is centered on the center of the structure and comprises between 20% and 40% of the surface area of the structure. In another example, a central portion of a transparent optical structure (e.g. lens) in front of a person's eye can comprise the central 33% of the (proximal-facing) surface of the structure.

In an example, light can be transmitted through a waveguide by internal reflection. In an example, a central axis of a waveguide can be substantially parallel to a central axis of the frontpiece of eyewear in a first configuration and intersect (a virtual extension of) the central axis of the frontpiece at an acute angle between 20 and 45 degrees in a second configuration. In an example, a movable waveguide can span from a side of a transparent optical structure (e.g. lens) to the center of the optical structure in a first configuration and span from the side of the optical structure to a lower peripheral portion (e.g. the bottom third) of the optical structure in a second configuration, wherein the waveguide is pivoted, tilted, and/or rotated from the first configuration to the second configuration, or vice versa.

In an example, a movable waveguide can span between 10% and 30% of the area of the proximal surface of a transparent optical structure (e.g. lens) which is held by eyewear in front of a person's eye. In another example, a movable waveguide can span between 25% and 40% of the area of a transparent optical structure (e.g. lens) which is held by eyewear in front of a person's eye. In an example, a movable waveguide can span between 40% and 65% of the area of the proximal surface of a transparent optical structure (e.g. lens) which is held by eyewear in front of a person's eye. In an example, a movable waveguide can be an integral part of a transparent optical structure in front of a person's eye.

In an example, a waveguide can be manually moved (e.g. pivoted, tilted, or rotated) from a first configuration which spans a central portion of a transparent optical structure (e.g. lens) in front of a person's eye to a first extent to a second configuration which spans this central portion to a second extent, wherein the second extent is less than the first extent. In another example, a movable waveguide can pivot around a point of rotation (e.g. an axle) which is proximal to the sidepiece of eyewear. In an example, a movable waveguide can pivot around a point of rotation (e.g. an axle) which is on the frontpiece of eyewear.

In an example, there can be an inner opening, recess, compartment, and/or gap within a transparent optical structure in front of a person's eye, wherein there is a movable (e.g. pivoting, tilting, or rotating) waveguide within this opening, recess, compartment, and/or gap. In an example, there can be an inner opening, recess, compartment, and/or gap within a transparent optical structure in front of a person's eye, wherein a movable waveguide pivots, tilts, and/or rotates from a first configuration to a second configuration within this opening, recess, compartment, and/or gap. In an example, eyewear can further comprise an electromagnetic actuator which moves (e.g. pivots, tilts, or rotates) a waveguide from a first configuration which spans a central portion of a transparent optical structure (e.g. lens) in front of a person's eye to a first extent to a second configuration which spans this central portion to a second extent, wherein the second extent is less than the first extent.

In another example, a waveguide can transmit light from a light display to a peripheral (e.g. non-central) location on a transparent optical structure (e.g. lens) in a second configuration, wherein light exits the waveguide toward a person's eye from the peripheral location. In an example, a waveguide can transmit light from a light display to a central location on a transparent optical structure (e.g. lens) in a first configuration and transmit light from the light display to a peripheral location on the transparent optical structure in a second configuration, wherein the peripheral location is below and toward the sidepiece relative to the central location (when the transparent optical structure is vertical), and wherein the waveguide pivots, tilts, and/or rotates from the first configuration to the second configuration.

In another example, augmented reality eyewear can further comprise a light display (e.g. array of light emitters), wherein light from the light display is directed through a waveguide toward a person's eye to display a virtual object in the person's field of view. In an example, augmented reality eyewear can further comprise a plurality of light displays (e.g. arrays of light emitters) on the frontpiece of an eyewear frame distributed around the circumference of a transparent optical structure (e.g. lens), wherein light from the one or more slight displays shows one or more virtual objects in the person's field of view.

In an example, augmented reality eyewear can further comprise one or more light displays (e.g. arrays of light emitters) on an eyewear frame, wherein light from the one or more slight displays shows one or more virtual objects in the person's field of view. In an example, augmented reality eyewear can further comprise six light displays (e.g. arrays of light emitters) on the frontpiece of an eyewear frame distributed around the circumference of a transparent optical structure (e.g. lens), wherein light from the one or more slight displays shows one or more virtual objects in the person's field of view. In an example, augmented reality eyewear can further comprise a flexible and/or bendable light guide component between a light display (e.g. array of light emitters) and a movable waveguide, wherein the flexible and/or bendable light guide transmits light from the light display into the waveguide even when the central axis of the waveguide moves relative to the light display.

In another example, augmented reality eyewear (e.g. eyeglasses) can comprise: an eyewear (e.g. eyeglasses) frame which is configured to be worn by a person; a transparent optical structure (e.g. lens) which is configured to be held in front of one of the person's eyes by the frame; and a movable (e.g. pivoting) waveguide which spans a percentage of the area of the transparent optical structure, wherein the waveguide has a first configuration which spans a central portion of the area of the transparent optical structure, wherein the waveguide has a second configuration which does not span the central portion of the area of the transparent optical structure, and wherein the waveguide is pivoted, tilted, and/or rotated from the first configuration to the second configuration, or vice versa.

In an example, eyewear can be a pair of eyeglasses. In an example, a transparent optical structure in front of a person's eye can be a lens. In an example, a central portion of a transparent optical structure (e.g. lens) in front of a person's eye can comprise an arcuate (e.g. circular, elliptical, or oval) area of the (proximal-facing) surface of the structure which is centered on the center of the structure and comprises between 25% of the surface area of the structure. In an example, a central portion of a transparent optical structure (e.g. lens) in front of a person's eye can comprise the central 10% of the (proximal-facing) surface of the structure. In another example, a central portion of a transparent optical structure (e.g. lens) in front of a person's eye can comprise the central 50% of the (proximal-facing) surface of the structure.

In an example, a central axis of a waveguide can be substantially parallel to a central axis of the frontpiece of eyewear in a first configuration and intersect (a virtual extension of) the central axis of the frontpiece at an acute angle in a second configuration. In an example, a central axis of a waveguide can be substantially parallel to a central axis of the frontpiece of eyewear in a first configuration and intersect (a virtual extension of) the central axis of the frontpiece at a 45 degree angle a second configuration. In an example, a waveguide can guide light from a frontpiece of an eyewear frame to a central location on a transparent optical structure in front of a person's eye.

In an example, a movable waveguide can span between 20% and 50% of the area of a transparent optical structure (e.g. lens) which is held by eyewear in front of a person's eye. In another example, a movable waveguide can span between 25% and 40% of the area of the proximal surface of a transparent optical structure (e.g. lens) which is held by eyewear in front of a person's eye. In an example, a movable waveguide can span between 5% and 20% of the area of a transparent optical structure (e.g. lens) which is held by eyewear in front of a person's eye. In another example, a movable waveguide can be parallel to the proximal and/or distal surface of a transparent optical structure in front of a person's eye.

In an example, augmented reality eyewear (e.g. eyeglasses) can comprise: an eyewear (e.g. eyeglasses) frame which is configured to be worn by a person; a transparent optical structure (e.g. lens) which is configured to be held in front of one of the person's eyes by the frame; and a movable (e.g. pivoting) waveguide which spans between 10% and 30% of the area of the transparent optical structure, wherein the waveguide has a first configuration which spans the center of the area of the transparent optical structure, wherein the waveguide has a second configuration which does not span the center of the area of the transparent optical structure, and wherein the waveguide is pivoted from the first configuration to the second configuration, or vice versa.

In an example, a movable waveguide can pivot around a point of rotation (e.g. an axle) which is less than 1 cm from the sidepiece of eyewear. In an example, a movable waveguide can be inserted into a transparent optical structure in front of a person's eye. In an example, there can be an inner opening, recess, compartment, and/or gap within a transparent optical structure in front of a person's eye which spans a central portion of the optical structure, wherein there is a movable (e.g. pivoting, tilting, or rotating) waveguide within this opening, recess, compartment, and/or gap.

In another example, augmented reality eyewear (e.g. eyeglasses) can comprise: an eyewear (e.g. eyeglasses) frame which is configured to be worn by a person; a transparent optical structure (e.g. lens) which is configured to be held in front of one of the person's eyes by the frame; and a movable (e.g. pivoting) waveguide which spans a percentage of the area of the transparent optical structure, wherein the waveguide has a first configuration which spans a central portion of the area of the transparent optical structure, wherein the waveguide has a second configuration which does not span the central portion of the area of the transparent optical structure; and an electromagnetic actuator, wherein the actuator moves (e.g. pivots, tilts, and/or rotates) the waveguide from the first configuration to the second configuration, or vice versa.

In an example, a waveguide can guide light from an eyewear frame to a central location on a transparent optical structure in front of a person's eye. In an example, a waveguide can transmit light from a light display to a central location on a transparent optical structure (e.g. lens) in a first configuration and transmit light from the light display to a peripheral location on the transparent optical structure in a second configuration, wherein the peripheral location is below the central location (when the transparent optical structure is vertical).

In an example, a waveguide can guide light from a light emitter on a sidepiece (e.g. temple) of eyewear to a central location on a transparent optical structure in front of a person's eye. In an example, augmented reality eyewear can further comprise a light display (e.g. array of light emitters) on the eyewear frame, wherein light from the light display shows a virtual object in the person's field of view. In an example, augmented reality eyewear can further comprise four or more light displays (e.g. arrays of light emitters) on the frontpiece of an eyewear frame distributed around the circumference of a transparent optical structure (e.g. lens), wherein light from the one or more slight displays shows one or more virtual objects in the person's field of view.

In an example, augmented reality eyewear can further comprise one or more light displays (e.g. arrays of light emitters) on the sidepiece (e.g. temple) of an eyewear frame, wherein light from the one or more slight displays shows one or more virtual objects in the person's field of view. In another example, there can be a light display (e.g. array of light emitters) on each of two sidepieces (e.g. temples) in an eyewear frame. In an example, augmented reality eyewear can further comprise a flexible and/or bendable optical joint between a light display (e.g. array of light emitters) and a movable waveguide, wherein the optical joint transmits light from the light display into the waveguide even when the central axis of the waveguide moves relative to the light display.

In an example, augmented reality eyewear (e.g. eyeglasses) can comprise: an eyewear (e.g. eyeglasses) frame which is configured to be worn by a person; a transparent optical structure (e.g. lens) which is configured to be held in front of one of the person's eyes by the frame; and an array of micromirrors which spans a percentage of the area of the transparent optical structure, wherein the array of micromirrors has a first configuration which spans a central portion of the area of the transparent optical structure, wherein the array of micromirrors has a second configuration which does not span the central portion of the area of the transparent optical structure, and wherein the array of micromirrors is pivoted, tilted, and/or rotated from the first configuration to the second configuration, or vice versa.

In an example, a waveguide can comprise a solid optical component with a (partially) reflective proximal surface (closer to the person's eye) and a (partially) reflective distal surface (farther from the person's eye). In an example, light rays can be transmitted along the length of a waveguide by being internally-reflected (back and forth) by the proximal and distal surfaces until they escape through the proximal surface. In another example, a waveguide can comprise a proximal array of micromirrors (the wall of the waveguide which is closer to a person's eye) and a distal array of micromirrors (the wall of the waveguide which is farther from the person's eye). In this alternative example, light rays are transmitted along the length of a waveguide by being internally-reflected (back and forth) by the proximal and distal micromirror arrays until they escape through the proximal micromirror array. Relevant variations discussed elsewhere in this disclosure or in priority-linked disclosures can also be applied to the example shown in this figure.

FIG. 2 shows two frontal views, at two different times, of an example of augmented reality eyewear (e.g. eyeglasses) comprising: an eyewear (e.g. eyeglasses) frame 201 which is configured to be worn by a person; a transparent optical structure (e.g. lens) 202 which is configured to be held in front of one of the person's eyes by the frame, wherein the transparent optical structure further comprises an arcuate (e.g. circular) rotatable component 203; and a waveguide 204 on the arcuate rotatable component. The upper portion of FIG. 2 shows this eyewear at a first time when the arcuate rotatable component is in a first configuration and the waveguide is closer to the center of the transparent optical structure. The lower portion of FIG. 2 shows this eyewear at a second time after the arcuate rotatable component has been rotated into a second configuration and the waveguide is farther from the center of the transparent optical structure.

In this example, a transparent optical structure on only one side (e.g. the left side) of the eyewear has an arcuate rotatable component and a waveguide. In another example, the other side (e.g. the right side) of the eyewear can have an arcuate rotatable component and a waveguide as well. In an example, the right side of the eyewear can be symmetric (e.g. reflected across a central vertical plane) relative to the left side of the eyewear.

In an example, an arcuate rotatable component can be transparent. In an example, an arcuate rotatable component can have a circular shape. In an example, an arcuate rotatable component can be off-center on a transparent optical structure (e.g. lens). In an example, an arcuate rotatable component can span from the center of a transparent optical structure (e.g. lens) to a side of the transparent optical structure. In an example, the arcuate rotatable component can be off-center on the transparent optical structure (e.g. lens).

In an example, an arcuate rotatable component can span between 10% and 40% of the area of a transparent optical structure. In an example, an arcuate rotatable component can span between 30% and 60% of the area of a transparent optical structure. In an example, an arcuate rotatable component can rotate within a gap, recess, opening, and/or compartment within a transparent optical structure. In an example, an arcuate rotatable component can be substantially parallel with the distal (away from eye facing) surface of a transparent optical structure. In an example, an arcuate rotatable component can be located on the distal (away from eye facing) surface of a transparent optical structure. In an example, an arcuate rotatable component can attached to a transparent optical structure.

In an example, rotation of the arcuate rotatable component in a first direction (e.g. counter-clockwise) moves a waveguide away from the center of a person's field of view and rotation of the arcuate rotatable component in a second direction (e.g. clockwise) moves the waveguide into the center of the person's field of view. In an example, an arcuate rotatable component can be manually rotated by a person wearing the eyewear. In an example, an arcuate rotatable component can be manually rotated by a person wearing the eyewear to move a waveguide into (or out of) the center of the person's field of view.

In an example, the eyewear can further comprise an electromagnetic actuator, wherein the actuator rotates the arcuate rotatable component. In an example, the eyewear can further comprise an electromagnetic actuator, wherein the actuator rotates the arcuate rotatable component to move a waveguide into (or out of) the center of the person's field of view. In an example, an arcuate rotatable component can rotate around a point which is between the center of a transparent optical structure (e.g. lens) and the side of the optical structure.

In an example, a waveguide can have a circular shape. In an example, a waveguide can have an oval or oblong shape. In an example, a waveguide can have a quadrilateral (e.g. trapezoidal) shape. In an example, a waveguide can span the center of the transparent optical structure (e.g. lens) in a first configuration and not span this center in a second configuration. In an example, a waveguide can span the center of a person's field of view in a first configuration and be in the periphery of the person's field of view in a second configuration. In an example, a waveguide can be moved from a first configuration to a second configuration by rotation of an arcuate rotatable component.

In an example, a waveguide can be located in the center of a person's field of view in a first configuration and located below the center of the person's field of view in a second configuration. In an example, a waveguide can be at a first location in a first configuration and at a second location in a second configuration. In an example, a waveguide can be at a first location in a first configuration and at a second location in a second configuration, wherein the second location is below the first location (e.g. when the transparent optical structure is vertical). In an example, a waveguide can be at a first location in a first configuration and at a second location in a second configuration, wherein the second location is below and toward the side of the first location (e.g. when the transparent optical structure is vertical). In an example, a waveguide can be at a first location in a first configuration and at a second location in a second configuration, wherein the second location is above the first location (e.g. when the transparent optical structure is vertical).

In an example, a waveguide can be an integral part of an arcuate rotatable component. In an example, a waveguide can be attached to an arcuate rotatable component. In an example, a waveguide can be off-center on an arcuate rotatable component. In an example, a waveguide can be contiguous with and/or adjacent to the circumference of an arcuate rotatable component. In an example, (the area of) a waveguide can be between 10% and 30% of (the area of) an arcuate rotatable component. In an example, (the area of) a waveguide can be between 25% and 50% of (the area of) an arcuate rotatable component.

In an example, a movable waveguide in a first configuration can transmit light from a light display (e.g. array of light emitters) to a location in the center of a person's field of view, wherein light exits this location toward the person's eye. In an example, a movable waveguide in a first configuration can transmit light from a light display (e.g. array of light emitters) to a location in the periphery (e.g. outside the central third) of a person's field of view, wherein light exits this location toward the person's eye. In an example, a light display can be located on a sidepiece (e.g. temple) of eyewear. In an example, a light display can be located on a frontpiece of eyewear.

In an example, light from a light display can be projected along a first set of vectors when a movable waveguide is in a first configuration and be projected along a second set of vectors when a movable waveguide is in a second configuration. In an example, light from a light display can be projected along a first set of vectors to intersect a waveguide when the waveguide is in a first configuration and be projected along a second set of vectors to intersect the waveguide when the waveguide is in a second configuration. In an example, light from a light display can be projected along a first set of vectors toward a waveguide when the waveguide is in a first configuration and be projected along a second set of vectors toward the waveguide when the waveguide is in a second configuration.

In an example, eyewear can comprise a plurality of light displays (e.g. arrays of light emitters). In an example, a waveguide can transmit light from a first light display when the waveguide is in a first configuration and transmit light from a second light display when the waveguide is in a second configuration. In an example, a waveguide can transmit light from a first light display at a first location on an eyewear frontpiece when the waveguide is in a first configuration and transmit light from a second light display at a second location on the eyewear frontpiece when the waveguide is in a second configuration.

In an example, augmented reality eyewear (e.g. eyeglasses) can comprise: an eyewear (e.g. eyeglasses) frame which is configured to be worn by a person; a transparent optical structure (e.g. lens) which is configured to be held in front of one of the person's eyes by the frame, wherein the transparent optical structure further comprises an arcuate (e.g. circular) rotatable component; and an array of micromirrors on the arcuate rotatable component. In an example, rotation of an arcuate rotatable component in a first direction (e.g. counter-clockwise) moves an array of micromirrors away from the center of a person's field of view and rotation of the arcuate rotatable component in a second direction (e.g. clockwise) moves the array of micromirrors into the center of the person's field of view.

In an example, a waveguide can comprise a solid optical component with a (partially) reflective proximal surface (closer to the person's eye) and a (partially) reflective distal surface (farther from the person's eye). In an example, light rays can be transmitted along the length of a waveguide by being internally-reflected (back and forth) by the proximal and distal surfaces until they escape through the proximal surface. In another example, a waveguide can comprise a proximal array of micromirrors (the wall of the waveguide which is closer to a person's eye) and a distal array of micromirrors (the wall of the waveguide which is farther from the person's eye). In this alternative example, light rays are transmitted along the length of a waveguide by being internally-reflected (back and forth) by the proximal and distal micromirror arrays until they escape through the proximal micromirror array. Relevant variations discussed elsewhere in this disclosure or in priority-linked disclosures can also be applied to the example shown in this figure.

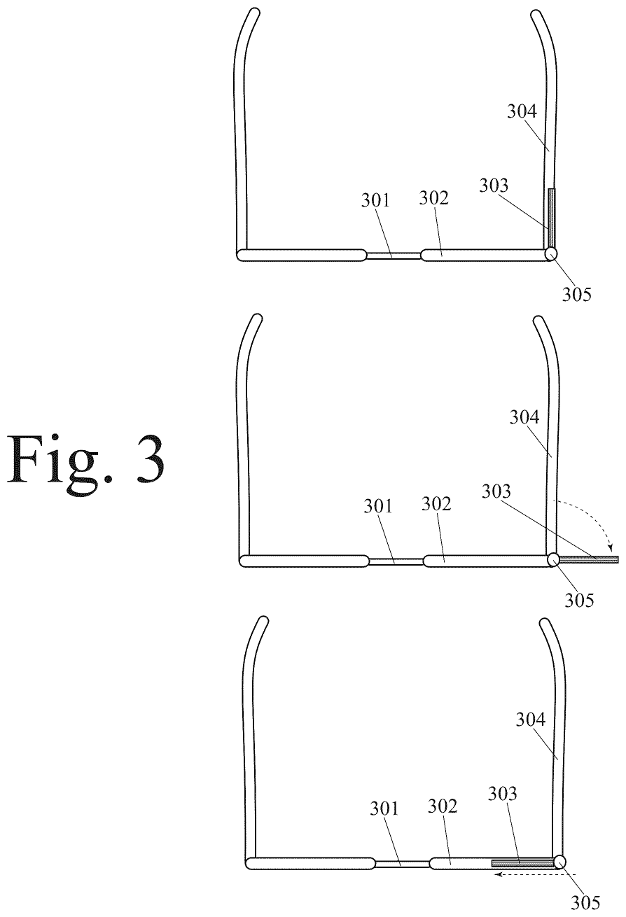

FIG. 3 shows three top-down views, at three different times, of an example of augmented reality eyewear (e.g. eyeglasses) comprising: an eyewear (e.g. eyeglasses) frame 301 which is configured to be worn by a person; a transparent optical structure (e.g. lens) 302 which is configured to be held in front of one of the person's eyes by the frame; a sidepiece (e.g. temple) 304 of the frame; a movable waveguide 303; wherein the movable waveguide has a first configuration which is parallel to the sidepiece, wherein the movable waveguide has a second configuration which is perpendicular to sidepiece and does not overlap the transparent optical structure, and wherein the movable waveguide has a third configuration which is perpendicular to the sidepiece and overlaps (e.g. inserted into and/or in front of) the transparent optical structure. In this example, the eyewear further comprises a joint (or hinge) 305 around which the movable waveguide is pivoted and/or rotated from the first configuration to the second configuration.

The upper portion of FIG. 3 shows this eyewear at a first time when the movable waveguide is in the first configuration. The middle portion of FIG. 3 shows this eyewear at a second time when the movable waveguide is in the second configuration. The lower portion of FIG. 3 shows this eyewear at a third time when the movable waveguide is in the third configuration.

In this example, only the left side of the eyewear has a movable waveguide. In another example, the right side of the eyewear can have a movable waveguide as well. In an example, a moveable waveguide can be inserted into an opening, recess, channel, and/or compartment in an eyewear sidepiece in the first configuration. In an example, another moveable waveguide can be along the side of an eyewear sidepiece in the first configuration. In an example, another moveable waveguide can positioned against the side of an eyewear sidepiece in the first configuration.

In an example, a moveable waveguide can be pivoted and/or rotated out from an eyewear sidepiece as it is moved from a first configuration to a second configuration. In an example, the posterior end of a moveable waveguide can be pivoted and/or rotated outward and forward from an eyewear sidepiece as the waveguide is moved from a first configuration to a second configuration. In an example, a moveable waveguide can be pivoted and/or rotated out from an eyewear sidepiece around a joint (or hinge) as it is moved from a first configuration to a second configuration.

In an example, a moveable waveguide can be substantially parallel with a sidepiece (e.g. temple) of eyewear in a first configuration and substantially co-planar with (a virtual extension of the plane of) a transparent optical structure (e.g. lens) in front of a person's eye in a second configuration. In an example, a moveable waveguide can fit flat against the side of a sidepiece of eyewear in a first configuration and can stick out from the eyewear (e.g. out from the sidepiece) in a second configuration.

In an example, a movable waveguide can be inserted into a gap, recess, opening, channel, and/or compartment in a transparent optical structure (e.g. lens) in a third configuration. In an example, a movable waveguide can be inserted into a gap, recess, opening, and/or compartment in a transparent optical structure (e.g. lens) as it moves from a second configuration to a third configuration. In an example, a movable waveguide can stick out from eyewear in a second configuration and not stick out from the eyewear in the third configuration. In an example, a movable waveguide can stick out from eyewear in a second configuration and not stick out from the eyewear in either the first configuration or the third configuration.

In an example, a movable waveguide can be moved from a first configuration to a second configuration by being pivoted and/or rotated around its front end. In an example, a moveable waveguide can be moved from a second configuration to a third configuration by being slid into (or onto) a transparent optical structure (e.g. lens) in front of a person's eye. In an example, there can be a gap or opening on a Joint between a sidepiece and a front piece of eyewear, wherein a movable waveguide is slid through this gap or opening when it is moved from a second configuration to a third configuration. In an example, there can be a gap or opening on a joint between a sidepiece and a front piece of eyewear, wherein a movable waveguide is slid through this gap or opening when it is moved from a second configuration (sticking out from the eyewear) to a third configuration (within and/or overlapping a transparent optical structure in front of a person's eye).

In an example, a movable waveguide can span between 10% and 30% of the area of a transparent optical structure (e.g. lens) in front of a person's eye when the waveguide is in the third configuration. In an example, a movable waveguide can span between 25% and 60% of the area of a transparent optical structure (e.g. lens) in front of a person's eye when the waveguide is in the third configuration. In an example, a moveable wave can span the center of the person's field of view when the waveguide is in the third configuration. In an example, a moveable waveguide can be moved manually (back and forth) between configurations by the person wearing the eyewear. In an example, eyewear can further comprise an actuator which moves a moveable waveguide (back and forth) between configurations.

In an example, a movable waveguide can click or snap into place in its first configuration so that it is not snagged on an environmental object. In an example, a movable waveguide can fit into a recess or opening on a sidepiece in its first configuration so that it is not snagged on an environmental object. In an example, a movable waveguide can transmit light from a light display to a location on the center of a transparent optical structure (e.g. lens) in its third configuration. In an example, a movable waveguide can transmit light from a light display (e.g. array of light emitters) on a sidepiece of the eyewear to a location on the center of a transparent optical structure (e.g. lens) in its third configuration.

In an example, augmented reality eyewear (e.g. eyeglasses) can comprise: an eyewear (e.g. eyeglasses) frame which is configured to be worn by a person; a transparent optical structure (e.g. lens) which is configured to be held in front of one of the person's eyes by the frame; a sidepiece (e.g. temple) of the frame; a movable array of micromirrors; wherein the array of micromirrors has a first configuration which is parallel to the sidepiece, wherein the array of micromirrors has a second configuration which is perpendicular to sidepiece and does not overlap the transparent optical structure, and wherein the array of micromirrors has a third configuration which is perpendicular to the sidepiece and overlaps (e.g. inserted into and/or in front of) the transparent optical structure. In this example, the eyewear further comprises a joint (or hinge) around which the array of micromirrors is pivoted and/or rotated from the first configuration to the second configuration.

In an example, a waveguide can comprise a solid optical component with a (partially) reflective proximal surface (closer to the person's eye) and a (partially) reflective distal surface (farther from the person's eye). In an example, light rays can be transmitted along the length of a waveguide by being internally-reflected (back and forth) by the proximal and distal surfaces until they escape through the proximal surface. In another example, a waveguide can comprise a proximal array of micromirrors (the wall of the waveguide which is closer to a person's eye) and a distal array of micromirrors (the wall of the waveguide which is farther from the person's eye). In this alternative example, light rays are transmitted along the length of a waveguide by being internally-reflected (back and forth) by the proximal and distal micromirror arrays until they escape through the proximal micromirror array. Relevant variations discussed elsewhere in this disclosure or in priority-linked disclosures can also be applied to the example shown in this figure.

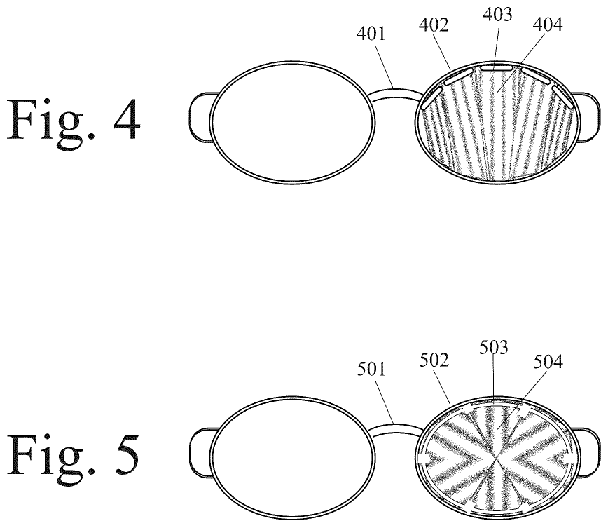

FIG. 4 shows a frontal view of an example of augmented reality eyewear (e.g. eyeglasses) comprising: an eyewear (e.g. eyeglasses) frame 401 which is configured to be worn by a person; a transparent optical structure (e.g. lens) 402 which is configured to be held in front of one of the person's eyes by the frame; a plurality of light displays (including light display 403) located around at least a portion of the circumference of the transparent optical structure; and a plurality of waveguides (including waveguide 404) which transmit light rays from the light emitters to locations on the transparent optical structure, wherein the light rays exit the transparent optical structure from the locations toward the person's eye.

In this example, there are a plurality of light displays and a plurality of waveguides only on the left side of the eyewear. In another example, there can also be a plurality of light displays and a plurality of waveguides on the right side of the eyewear. In an example, a light display can comprise a plurality of light emitters which emit light which displays one or more virtual objects in a person's field of view. In this example, there are five light displays on the rim of an eyewear front piece which holds a transparent optical structure (e.g. lens) in place.

In another example, there can be fewer light displays. In another example, there can be two light displays, one on either side (right and left) of a transparent optical structure. In another example, there can be two light displays, one above and one below transparent optical structure. In another example, there can be four light displays which are evenly distributed around the circumference of a transparent optical structure (e.g. lens). In another example, there can be four light displays which around the circumference of a transparent optical structure (e.g. lens): one to the right, one to the left, one above, and one below the transparent optical structure.

In another example, there can be more light displays. In another example, there can be six or more light displays distributed (evenly) around the circumference of the transparent optical structure. In another example, there can be six or more light displays distributed (evenly) around a rim (of the eyewear) which holds a transparent optical structure. In this example, a plurality of light displays span between 25% and 50% of the circumference of a transparent optical structure. In another example, a plurality of light displays can span between 50% and 80% of the circumference of a transparent optical structure. In another example, a plurality of light displays can collectively span the entire circumference of a transparent optical structure.

In this example, there are four waveguides, one for each of the four light displays. More generally, there can be one waveguide for each of a plurality of light displays. In this example, the waveguides transmit light from light displays along the upper half of a transparent optical display to central and lower location on the transparent optical structure. In an example, waveguides can transmit primarily in a vertical (e.g. upper to lower) direction. In this example, waveguides transmit light along upper-to-lower and peripheral-to-central vectors.

In an example, a transparent optical structure can comprise a plurality of radial waveguides which transmit light from a plurality of light displays along peripheral-to-central vectors. In an example, a transparent optical structure can comprise a hub-and-spoke array of waveguides which transmit light from a plurality of light displays along peripheral-to-central vectors. In an example, a transparent optical structure can comprise a hub-and-spoke array of waveguides which transmit light from a circumferential array of light displays along peripheral-to-central vectors toward the center of the transparent optical structure.

In an example, a transparent optical structure can comprise a radial array of pie-slice-shaped waveguides which transmit light from a circumferential array of light displays along peripheral-to-central vectors toward the center of the transparent optical structure. In an example, a transparent optical structure can comprise an array of trapezoidal and/or keystone-shaped waveguides which transmit light from a circumferential array of light displays along peripheral-to-central vectors toward the center of the transparent optical structure.

In another example, a transparent optical structure can comprise: a first waveguide which transmits light from a display on one side (e.g. left side) of the optical structure along a portion of the upper circumference of the optical structure; and an array of waveguides which further transmit this light downwards toward the center of the optical structure. In another example, a transparent optical structure can comprise: a first waveguide which transmits light from a display on one side (e.g. left side) of the optical structure to portion of the upper circumference of the optical structure; and a second waveguide which further transmit this light downwards toward the center of the optical structure. In another example, a transparent optical structure can comprise (a) a first waveguide which transmits light from a display on one side (e.g. left side) of the optical structure to portion of the upper circumference of the optical structure and (b) a second waveguide which further transmit this light downwards toward the center of the optical structure, wherein the first and second waveguides are optically coupled.

In this example, there is one waveguide receiving light from each light display. In another example, there can be two or more waveguides receiving light from a single light display. In another example, there can be two or more light displays sending light into a single waveguide. In an example, light displays can be activated to emit light simultaneously. In an example, different light displays can be activated to emit light at different times. In an example, different light displays can be activated to emit light sequentially. In an example, light displays whose light is transmitted to a central location of the transparent optical structure can be activated more frequently or continuously than light displays whose light is transmitted to peripheral locations of the transparent optical structure.

In an example, waveguides may be non-overlapping. In another example, selected waveguides may overlap each other. In an example, waveguides which transmit light to central locations of a transparent optical structure may overlap more than waveguides which transmit light to peripheral locations of the transparent optical structure. In an example, waveguides which transmit light from light displays on opposite sides of a transparent optical structure can overlap in a central region of the transparent structure in order to display virtual objects with greater brightness and/or resolution in that central region.

In an example, a waveguide can comprise a solid optical component with a (partially) reflective proximal surface (closer to the person's eye) and a (partially) reflective distal surface (farther from the person's eye). In an example, light rays can be transmitted along the length of a waveguide by being internally-reflected (back and forth) by the proximal and distal surfaces until they escape through the proximal surface. In another example, a waveguide can comprise a proximal array of micromirrors (the wall of the waveguide which is closer to a person's eye) and a distal array of micromirrors (the wall of the waveguide which is farther from the person's eye). In this alternative example, light rays are transmitted along the length of a waveguide by being internally-reflected (back and forth) by the proximal and distal micromirror arrays until they escape through the proximal micromirror array. Relevant variations discussed elsewhere in this disclosure or in priority-linked disclosures can also be applied to the example shown in this figure.

FIG. 5 shows an example of augmented reality eyewear (e.g. eyeglasses) comprising: an eyewear (e.g. eyeglasses) frame 501 which is configured to be worn by a person; a transparent optical structure (e.g. lens) 502 which is configured to be held in front of one of the person's eyes by the frame; a plurality of light displays (including light display 503) located around at least a portion of the circumference of the transparent optical structure; and a plurality of waveguides (including waveguide 504) which transmit light rays from the light emitters to locations on the transparent optical structure, wherein the light rays exit the transparent optical structure from the locations toward the person's eye. In this example, only the left side of the eyewear has this optical structure. In an example, the right side of the eyewear can have this optical structure as well. In an example, the right side of the eyewear can be symmetric with respect to the left side.

In this example, there are six light displays distributed (evenly) around the circumference of the transparent optical structure (e.g. lens). In this example, there are six light displays distributed (evenly) around the rim of eyewear which holds the transparent optical structure. In this example, there are six wedge-shaped (e.g. pie-slice-shaped) waveguides, one receiving light from each of the six light displays. In this example, the six light displays are (evenly distributed) around the rim of the eyewear which holds the transparent optical structure (e.g. lens). In this example, each of the waveguides transmits light from a location along the rim of the eyewear to a central region of the transparent optical structure.

In this example, the waveguides do not overlap each other. In an example, the waveguides can overlap each other in order to create regions wherein virtual objects are shown with greater brightness and/or resolution. In an example, portions of waveguides which span a central region of a transparent optical structure (e.g. lens) can overlap in order to create a central region of a person's field of view wherein virtual objects are shown with greater brightness and/or resolution than in peripheral regions of the person's field of view.

In an example, waveguides in a plurality of waveguides can have wedge shapes. In an example, waveguides in a plurality of waveguides can have pie-slice shapes. In an example, waveguides in a plurality of waveguides can have annular-section shapes. In an example, waveguides in a plurality of waveguides can have annular-section shapes (e.g. like the shape of an area cleaned by a window wiper). In an example, waveguides in a plurality of waveguides can all have the same shape. In an example, waveguides in a plurality of waveguides can all have the same shape except for one waveguide which spans the center of a transparent optical structure (e.g. lens).

In an example, augmented reality eyewear (e.g. eyeglasses) can comprise: an eyewear (e.g. eyeglasses) frame which is configured to be worn by a person; a transparent optical structure (e.g. lens) which is configured to be held in front of one of the person's eyes by the frame; a plurality of light displays located around at least a portion of the circumference of the transparent optical structure; and a plurality of micromirror arrays which transmit light rays from the light emitters to locations on the transparent optical structure, wherein the light rays exit the transparent optical structure from the locations toward the person's eye.

In an example, augmented reality eyewear (e.g. eyeglasses) can comprise: an eyewear (e.g. eyeglasses) frame which is configured to be worn by a person; a transparent optical structure (e.g. lens) which is configured to be held in front of one of the person's eyes by the frame; a plurality of light displays located around at least a portion of the circumference of the transparent optical structure; and a plurality of wedge, pie-slice, and/or annular-section shaped micromirror arrays which transmit light rays from the light emitters to locations on the transparent optical structure, wherein the light rays exit the transparent optical structure from the locations toward the person's eye.

In an example, augmented reality eyewear (e.g. eyeglasses) can comprise: an eyewear (e.g. eyeglasses) frame which is configured to be worn by a person; a transparent optical structure (e.g. lens) which is configured to be held in front of one of the person's eyes by the frame; a plurality of light displays located around at least a portion of the circumference of the transparent optical structure; and a plurality of wedge, pie-slice, and/or annular-section shaped micromirror arrays which transmit light rays from the light emitters to central locations on the transparent optical structure, wherein the light rays exit the transparent optical structure from the central locations toward the person's eye.

In an example, a waveguide can comprise a solid optical component with a (partially) reflective proximal surface (closer to the person's eye) and a (partially) reflective distal surface (farther from the person's eye). In an example, light rays can be transmitted along the length of a waveguide by being internally-reflected (back and forth) by the proximal and distal surfaces until they escape through the proximal surface. In another example, a waveguide can comprise a proximal array of micromirrors (the wall of the waveguide which is closer to a person's eye) and a distal array of micromirrors (the wall of the waveguide which is farther from the person's eye). In this alternative example, light rays are transmitted along the length of a waveguide by being internally-reflected (back and forth) by the proximal and distal micromirror arrays until they escape through the proximal micromirror array. Relevant variations discussed elsewhere in this disclosure or in priority-linked disclosures can also be applied to the example shown in this figure.

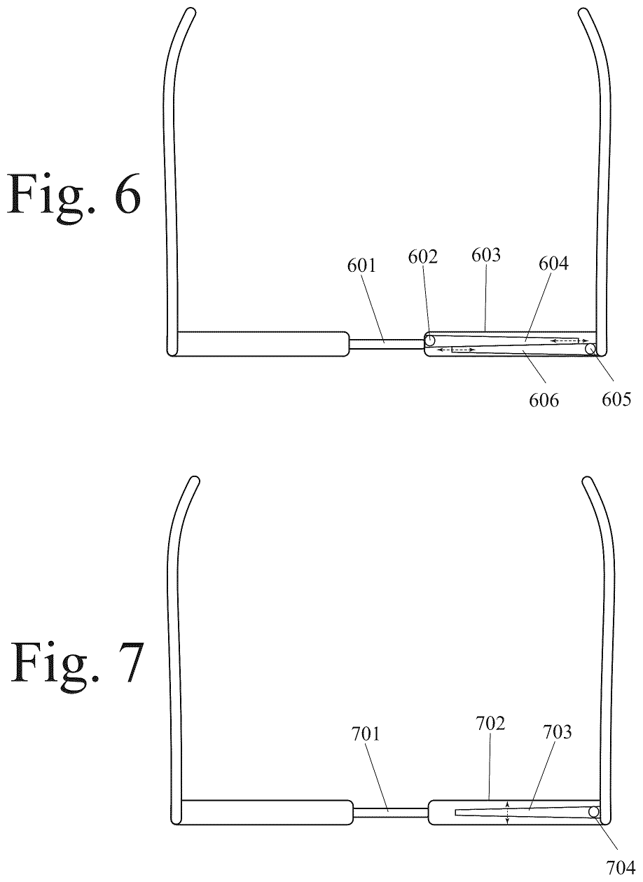

FIG. 6 shows a top-down view of an example of augmented reality eyewear (e.g. eyeglasses) comprising: an eyewear (e.g. eyeglasses) frame 601 which is configured to be worn by a person; a transparent optical structure (e.g. lens) 603 which is configured to be held in front of one of the person's eyes by the frame; a first light display 602 on a first side of the transparent optical structure; a second light display 605 on a second side (e.g. opposite the first side) of the transparent optical structure; a first waveguide 604 which transmits light from the first light display; and a second waveguide 606 which transmits light from the second light display, wherein the first waveguide and the second waveguide have a first configuration wherein the first waveguide and the second waveguide overlap by a first amount, wherein the first waveguide and the second waveguide have a second configuration wherein the first waveguide and the second waveguide overlap by a second amount, and wherein the second amount is greater than the first amount. In this example, only the left side of the eyewear has this optical structure. In an example, the right side of the eyewear can have this optical structure as well. In an example, the right side of the eyewear can be symmetric with respect to the left side.

In an example, a light display can comprise an array of light emitters. In an example, a light display can emit light which displays one or more virtual objects in a person's field of view. In an example, a first light display can be to the right of a transparent optical structure (e.g. lens) and a second light display can be to the left of the transparent optical structure. In another example, a first light display can be above a transparent optical structure (e.g. lens) and a second light display can be below the transparent optical structure.

In an example, the first waveguide and the second waveguide can be changed from their first configuration to their second configuration by sliding one waveguide relative to the other waveguide. In an example, the first waveguide and the second waveguide can be changed from their first configuration to their second configuration by sliding one waveguide over the other waveguide. In an example, the first waveguide and the second waveguide can be changed from their first configuration to their second configuration by sliding one waveguide horizontally over the other waveguide. In an example, the first waveguide and the second waveguide can be changed from their first configuration to their second configuration by sliding one waveguide horizontally onto the other waveguide.

In an example, the first waveguide and the second waveguide can be changed from their first configuration to their second configuration by sliding one waveguide horizontally into the other waveguide. In another example, the first waveguide and the second waveguide can be changed from their first configuration to their second configuration by sliding one waveguide vertically over the other waveguide. In another example, the first waveguide and the second waveguide can be changed from their first configuration to their second configuration by sliding one waveguide vertically onto the other waveguide. In another example, the first waveguide and the second waveguide can be changed from their first configuration to their second configuration by sliding one waveguide vertically into the other waveguide.

In an example, first and second waveguides may not overlap at all in their first configuration and 10% to 25% of their length may overlap in their second configuration. In an example, eyewear can further comprise one or more actuators which move the first and second waveguides from their first configuration to their second configuration, or vice versa. In an example, the brightness and/or resolution of virtual objects can be changed (e.g. adjusted) by moving the first and second waveguides from their first configuration to their second configuration, or vice versa. In an example, the size, shape, and/or location of the portion of a person's field of view which displays virtual objects can be changed (e.g. adjusted) by moving the first and second waveguides from their first configuration to their second configuration, or vice versa.

In an example, the first and second waveguides can be substantially parallel to each other. In an example a first waveguide can be proximal (e.g. closer to a person's eye) than a second waveguide. In an example, first and second waveguides can have the same sizes (e.g. the same lengths and widths). In an example, first and second waveguides can have the same shapes. In another example, the first and second waveguides can have different sizes and/or shapes.

In example, augmented reality eyewear (e.g. eyeglasses) can comprise: an eyewear (e.g. eyeglasses) frame which is configured to be worn by a person; a transparent optical structure (e.g. lens) which is configured to be held in front of one of the person's eyes by the frame; a first light display on a first side of the transparent optical structure; a second light display on a second side (e.g. opposite the first side) of the transparent optical structure; a first micromirror array which transmits light from the first light display; and a second micromirror array which transmits light from the second light display, wherein the first micromirror array and the second micromirror array have a first configuration wherein the first micromirror array and the second micromirror array overlap by a first amount, wherein the first micromirror array and the second micromirror array have a second configuration wherein the first micromirror array and the second micromirror array overlap by a second amount, and wherein the second amount is greater than the first amount.

In an example, a waveguide can comprise a solid optical component with a (partially) reflective proximal surface (closer to the person's eye) and a (partially) reflective distal surface (farther from the person's eye). In an example, light rays can be transmitted along the length of a waveguide by being internally-reflected (back and forth) by the proximal and distal surfaces until they escape through the proximal surface. In another example, a waveguide can comprise a proximal array of micromirrors (the wall of the waveguide which is closer to a person's eye) and a distal array of micromirrors (the wall of the waveguide which is farther from the person's eye). In this alternative example, light rays are transmitted along the length of a waveguide by being internally-reflected (back and forth) by the proximal and distal micromirror arrays until they escape through the proximal micromirror array. Relevant variations discussed elsewhere in this disclosure or in priority-linked disclosures can also be applied to the example shown in this figure.

FIG. 7 shows a top-down view of an example of augmented reality eyewear (e.g. eyeglasses) comprising: an eyewear (e.g. eyeglasses) frame 701 which is configured to be worn by a person; a transparent optical structure (e.g. lens) 702 which is configured to be held in front of one of the person's eyes by the frame; a light display 704 which emits light that displays one or more virtual objects in the person's field of view; and a dynamic waveguide 703 which transmits light rays from the light display to locations on the transparent optical structure from which the light rays exit the waveguide toward the person's eye; wherein the waveguide has a first configuration with a first width (e.g. thickness), wherein the waveguide has a second configuration with a second width (e.g. thickness), and wherein the second width (e.g. thickness) is greater than the first width (e.g. thickness). In this example, only the left side of the eyewear has this optical structure. In an example, the right side of the eyewear can have this optical structure as well. In an example, the right side of the eyewear can be symmetric with respect to the left side.

In an example, the interior of a waveguide can comprise a flowable substance (e.g. a liquid, gel, or gas). In an example, the interior of a waveguide can comprise a flowable substance (e.g. a liquid or gel) and the width (e.g. thickness) of the waveguide can be changed by pressing the proximal and distal walls of the waveguide closer together. In an example, eyewear can further comprise an actuator (e.g. an electromagnetic actuator) which compresses the proximal and distal walls of a waveguide closer together. In an example, the interior of a waveguide can be a void. In an example, the interior of a waveguide can be a void and the width (e.g. thickness) of the waveguide can be changed by pressing the proximal and distal walls of the waveguide closer together. In an example, the distance between proximal and distal walls of a waveguide can be decreased by compressing the proximal and distal walls toward each other and can be increased by releasing the compressive force.

In an example, changing the width (e.g. thickness) of a waveguide can change characteristics of virtual objects which are displayed by light transmitted from a light display through the waveguide to a person's eye. In an example, changing the width (e.g. thickness) of a waveguide can change the location of a virtual object which is displayed by light transmitted from a light display through the waveguide to a person's eye. In an example, changing the width (e.g. thickness) of a waveguide can change the size of a virtual object which is displayed by light transmitted from a light display through the waveguide to a person's eye. In an example, changing the width (e.g. thickness) of a waveguide can change the resolution of a virtual object which is displayed by light transmitted from a light display through the waveguide to a person's eye. In an example, changing the width (e.g. thickness) of a waveguide can change the brightness of a virtual object which is displayed by light transmitted from a light display through the waveguide to a person's eye.

In an example, augmented reality eyewear (e.g. eyeglasses) can comprise: an eyewear (e.g. eyeglasses) frame which is configured to be worn by a person; a transparent optical structure (e.g. lens) which is configured to be held in front of one of the person's eyes by the frame; a light display which emits light that displays one or more virtual objects in the person's field of view; and a dynamic waveguide which transmits light rays from the light display to locations on the transparent optical structure from which the light rays exit the waveguide toward the person's eye; wherein the waveguide further comprises a proximal micromirror array (e.g. proximal mirror wall) and a distal micromirror array (e.g. distal mirror wall), wherein the waveguide has a first configuration with a first width (e.g. thickness), wherein the waveguide has a second configuration with a second width (e.g. thickness), and wherein the second width (e.g. thickness) is greater than the first width (e.g. thickness).

In an example, a waveguide can comprise a solid optical component with a (partially) reflective proximal surface (closer to the person's eye) and a (partially) reflective distal surface (farther from the person's eye). In an example, light rays can be transmitted along the length of a waveguide by being internally-reflected (back and forth) by the proximal and distal surfaces until they escape through the proximal surface. In another example, a waveguide can comprise a proximal array of micromirrors (the wall of the waveguide which is closer to a person's eye) and a distal array of micromirrors (the wall of the waveguide which is farther from the person's eye). In this alternative example, light rays are transmitted along the length of a waveguide by being internally-reflected (back and forth) by the proximal and distal micromirror arrays until they escape through the proximal micromirror array.

In an example, the width (e.g. thickness) of a micromirror waveguide can be changed by moving the proximal micromirror array and the distal micromirror array closer together or farther apart. In an example, the width (e.g. thickness) of this micromirror waveguide can be changed by using one or more actuators to move the proximal micromirror array and the distal micromirror array closer together or farther apart. Relevant variations discussed elsewhere in this disclosure or in priority-linked disclosures can also be applied to the example shown in this figure.

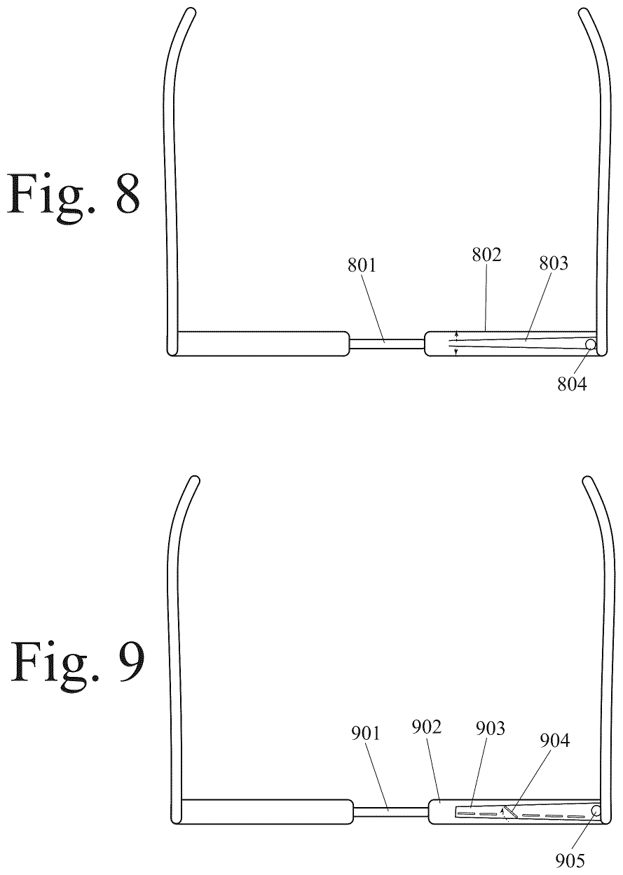

FIG. 8 shows a top-down view of an example of augmented reality eyewear (e.g. eyeglasses) comprising: an eyewear (e.g. eyeglasses) frame 801 which is configured to be worn by a person; a transparent optical structure (e.g. lens) 802 which is configured to be held in front of one of the person's eyes by the frame; a light display 804 which emits light that displays one or more virtual objects in the person's field of view; and a dynamic waveguide 803 which transmits light rays from the light display to locations on the transparent optical structure from which the light rays exit the waveguide toward the person's eye; wherein the waveguide has a first configuration with a first (average) angle between its proximal and distal surfaces, wherein the waveguide has a second configuration with a second (average) angle between its proximal and distal surfaces, and wherein the second angle is greater than the first angle. In this example, only the left side of the eyewear has this optical structure. In an example, the right side of the eyewear can have this optical structure as well. In an example, the right side of the eyewear can be symmetric with respect to the left side.

In an example, the interior of a waveguide can comprise a flowable substance (e.g. a liquid, gel, or gas). In an example, the interior of a waveguide can comprise a flowable substance (e.g. a liquid or gel) and the angle between proximal and distal surfaces of the waveguide can be changed by pressing the proximal and/or distal surfaces. In an example, eyewear can further comprise an actuator (e.g. an electromagnetic actuator) which presses the proximal and/or distal surfaces of a waveguide. In an example, the angle between proximal and distal surfaces of a waveguide can be decreased by pressing the proximal and/or distal surfaces and can be increased by releasing the them.

In an example, changing the angle between proximal and distal surfaces of a waveguide can change characteristics of virtual objects which are displayed by light transmitted from a light display through the waveguide to a person's eye. In an example, changing the angle between proximal and distal surfaces of a waveguide can change the location of a virtual object which is displayed by light transmitted from a light display through the waveguide to a person's eye.

In an example, changing the angle between proximal and distal surfaces of a waveguide can change the size of a virtual object which is displayed by light transmitted from a light display through the waveguide to a person's eye. In an example, changing the angle between proximal and distal surfaces of a waveguide can change the resolution of a virtual object which is displayed by light transmitted from a light display through the waveguide to a person's eye. In an example, changing the angle between proximal and distal surfaces of a waveguide can change the brightness of a virtual object which is displayed by light transmitted from a light display through the waveguide to a person's eye.

In an example, augmented reality eyewear (e.g. eyeglasses) can comprise: an eyewear (e.g. eyeglasses) frame which is configured to be worn by a person; a transparent optical structure (e.g. lens) which is configured to be held in front of one of the person's eyes by the frame; a light display which emits light that displays one or more virtual objects in the person's field of view; and a dynamic waveguide which transmits light rays from the light display to locations on the transparent optical structure from which the light rays exit the waveguide toward the person's eye; wherein the waveguide further comprises a proximal micromirror array (e.g. proximal mirror wall) and a distal micromirror array (e.g. distal mirror wall), wherein the waveguide has a first configuration with a first angle between the proximal and distal micromirror arrays, wherein the waveguide has a second configuration with a second angle between the proximal and distal micromirror arrays, and wherein the second angle is greater than the first angle. In an example, this angle can be changed by using one or more actuators to move the proximal micromirror array and/or the distal micromirror array.

In an example, a waveguide can comprise a solid optical component with a (partially) reflective proximal surface (closer to the person's eye) and a (partially) reflective distal surface (farther from the person's eye). In an example, light rays can be transmitted along the length of a waveguide by being internally-reflected (back and forth) by the proximal and distal surfaces until they escape through the proximal surface. In another example, a waveguide can comprise a proximal array of micromirrors (the wall of the waveguide which is closer to a person's eye) and a distal array of micromirrors (the wall of the waveguide which is farther from the person's eye). In this alternative example, light rays are transmitted along the length of a waveguide by being internally-reflected (back and forth) by the proximal and distal micromirror arrays until they escape through the proximal micromirror array. Relevant variations discussed elsewhere in this disclosure or in priority-linked disclosures can also be applied to the example shown in this figure.

FIG. 9 shows a top-down view of an example of augmented reality eyewear (e.g. eyeglasses) comprising: an eyewear (e.g. eyeglasses) frame 901 which is configured to be worn by a person; a transparent optical structure (e.g. lens) 902 which is configured to be held in front of one of the person's eyes by the frame; a light display 905 which emits light that displays one or more virtual objects in the person's field of view; a dynamic waveguide 903 which transmits light rays from the light display to locations on the transparent optical structure from which the light rays exit the waveguide toward the person's eye; and an array of micromirrors and/or moveable reflective surfaces within the waveguide, wherein a selected subset of micromirrors and/or movable reflective surfaces in the array can be selectively and independently moved from a first configuration in which they intersect lines of sight from a person's eye at a first angle to a second configuration in which they intersect lines of sight from the person's eye at a second angle, wherein the second angle differs from the first angle. In this example, only the left side of the eyewear has this optical structure. In an example, the right side of the eyewear can have this optical structure as well. In an example, the right side of the eyewear can be symmetric with respect to the left side.

In an example, the selected subset of micromirrors and/or movable reflective surfaces can be substantially parallel to lines of sight from the person's eye in the first configuration and can intersect these lines of sight at acute angles in the second configuration. In an example, the selected subset of micromirrors and/or movable reflective surfaces can be substantially parallel to the proximal surface of the waveguide in the first configuration and can intersect this surface at acute angles in the second configuration. In an example, the array of micromirrors and/or movable reflective surfaces can be part of, or contiguous with, the proximal surface of the waveguide in the first configuration.

In an example, a micromirror and/or moveable reflective surface at a given location can allow light rays from a light display to pass longitudinally through the waveguide when the micromirror and/or moveable reflective surface is in a first configuration and can direct these light rays to exit the waveguide at this location toward a person's eye when the micromirror and/or moveable reflective surface is in the second configuration. In an example, a selected subset of micromirrors and/or moveable reflective surfaces can be selectively and independently moved from a first configuration to a second configuration, or vice versa, by application of electromagnetic energy. In an example, a selected subset of micromirrors and/or moveable reflective surfaces can be selectively and independently moved from a first configuration to a second configuration, or vice versa, by one or more electromagnetic actuators. Relevant variations discussed elsewhere in this disclosure or in priority-linked disclosures can also be applied to the example shown in this figure.

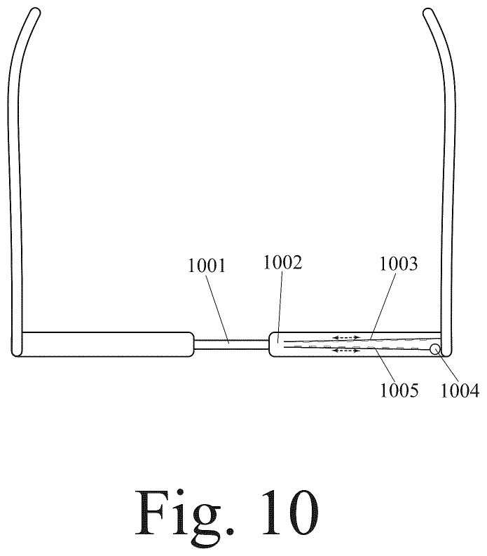

FIG. 10 shows a top-down view of an example of augmented reality eyewear (e.g. eyeglasses) comprising: an eyewear (e.g. eyeglasses) frame 1001 which is configured to be worn by a person; a transparent optical structure (e.g. lens) 1002 which is configured to be held in front of one of the person's eyes by the frame; a light display 1004 which emits light that displays one or more virtual objects in the person's field of view; and a dynamic waveguide 1003 which transmits light rays from the light display to locations on the transparent optical structure from which the light rays exit the waveguide toward the person's eye; wherein the waveguide has a first configuration in which a first section of the proximal surface (or wall) of the waveguide is aligned with a second section of the distal surface (or wall) of the waveguide, wherein the waveguide has a second configuration in which the first section of the proximal surface (or wall) of the waveguide is aligned with a third section of the distal surface (or wall) of the waveguide, and wherein the waveguide is changed from the first configuration to the second configuration by moving (e.g. sliding) the proximal surface (or wall) relative to the distal surface (or wall), or vice versa. In this example, only the left side of the eyewear has this optical structure. In an example, the right side of the eyewear can have this optical structure as well. In an example, the right side of the eyewear can be symmetric with respect to the left side.

In an example, a waveguide can comprise a proximal array of micromirrors (the wall of the waveguide which is closer to a person's eye) and a distal array of micromirrors (the wall of the waveguide which is farther from the person's eye). In an example, light rays are transmitted along the length of a waveguide by being internally-reflected (back and forth) by the proximal and distal micromirror arrays until they escape through the proximal micromirror array. In an example, a proximal array of micromirrors can be moved (e.g. slid) relative to a distal array of micromirrors, or vice versa, by one or more actuators.

In an example, shifting and/or sliding proximal and distal surfaces (or walls) of a waveguide relative to each other can change characteristics of virtual objects which are displayed by light transmitted from a light display through the waveguide to a person's eye. In an example, shifting and/or sliding proximal and distal surfaces (or walls) of a waveguide relative to each other can change the location of a virtual object which is displayed by light transmitted from a light display through the waveguide to a person's eye.

In an example, shifting and/or sliding proximal and distal surfaces (or walls) of a waveguide relative to each other can change the size of a virtual object which is displayed by light transmitted from a light display through the waveguide to a person's eye. In an example, shifting and/or sliding proximal and distal surfaces (or walls) of a waveguide relative to each other can change the resolution of a virtual object which is displayed by light transmitted from a light display through the waveguide to a person's eye. In an example, shifting and/or sliding proximal and distal surfaces (or walls) of a waveguide relative to each other can change the brightness of a virtual object which is displayed by light transmitted from a light display through the waveguide to a person's eye. Relevant variations discussed elsewhere in this disclosure or in priority-linked disclosures can also be applied to the example shown in this figure.

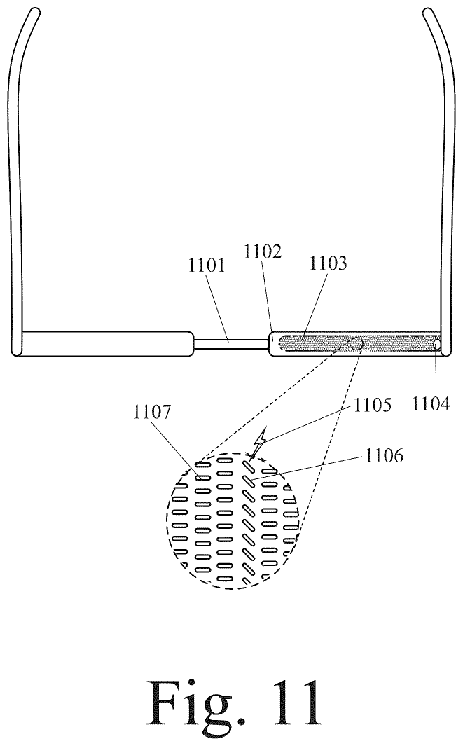

The upper portion of FIG. 11 shows a top-down view of an example of augmented reality eyewear (e.g. eyeglasses) with a dynamic waveguide. The lower portion of FIG. 11 (especially content in the dotted-line circle) shows an enlarged top-down cross-sectional view of a section of the dynamic waveguide.

More specifically, FIG. 11 shows an example of augmented reality eyewear (e.g. eyeglasses) comprising: an eyewear (e.g. eyeglasses) frame 1101 which is configured to be worn by a person; a transparent optical structure (e.g. lens) 1102 which is configured to be held in front of one of the person's eyes by the frame; a light display 1104 which emits light rays that display one or more virtual objects in the person's field of view; and a dynamic waveguide 1103 which transmits light rays from the light display to locations on the transparent optical structure from which the light rays exit the waveguide toward the person's eye, wherein the interior of the dynamic waveguide further comprises a plurality of small-scale (e.g. micro-scale, nano-scale, and/or molecular level) reflective objects (including reflective objects 1106 and 1107) whose orientations are selectively changed by the application of electromagnetic energy 1105 (e.g. by the transmission of electrical voltage or by the creation of a magnetic field). In this example, the reflective objects are relatively flat or planar.

In this example, there are a plurality of reflective objects in a given cross-sectional plane of the waveguide. In this example, the reflective objects can be described as being stacked in a cross-sectional plane of the waveguide. In this example, the orientations of reflective objects in a selected cross-sectional stack of reflective objects (including reflective object 1106) are different from the orientations of reflective objects in other cross-sectional stacks of reflective objects (including reflective object 1107) due to exposure of the selected stack to electromagnetic energy 1105.

In this example, the orientations of reflective objects in the selected stack have been selectively changed due to the transmission of electromagnetic energy (e.g. electrical energy) to (or in proximity to) this selected stack. In an example, different reflective objects and/or different stacks of reflective objects in different locations can be selectively moved (e.g. reoriented) at different times by transmission of electromagnetic energy (e.g. electrical energy) to different locations of the waveguide at different times.

In this example, only the left side of the eyewear has an optical structure with a dynamic waveguide. In another example, the right side of the eyewear can also have such an optical structure. In an example, the right side of the eyewear can be symmetric with the left side.

In an example, reflective objects in a waveguide with a first orientation can allow environmental light to pass through the waveguide in an unobstructed manner. In an example, the longitudinal axes of reflective objects in a selected section of the waveguide can be aligned with lines of sight from a person's eye in this first configuration. In an example, reflective objects in a waveguide with a second orientation can block environmental light from passing through the waveguide and reflect light from a light display toward a person's eye. In an example, the longitudinal axes of reflective objects in a selected section of the waveguide can intersect lines of sight from a person's eye at an acute or right angle in this second configuration.

In an example, a selected subset of reflective objects in a waveguide can be moved (e.g. pivoted, tilted, and/or rotated) from a first configuration to a second configuration by exposure to electromagnetic (e.g. electrical) energy. In an example, a selected subset of reflective objects in a waveguide can be moved (e.g. pivoted, tilted, and/or rotated) from a first configuration to a second configuration by the transmission of electromagnetic (e.g. electrical) energy through a selected section of the waveguide. In an example, a selected subset of reflective objects in a waveguide can be moved (e.g. pivoted, tilted, and/or rotated) from a first configuration to a second configuration by (changes in) an electromagnetic field.

In an example, selectively moving (e.g. reorienting) different reflective objects (or stacks of reflective objects) in the waveguide at different locations at different times can enable displaying virtual objects at different locations at different times. In an example, selectively moving (e.g. reorienting) different reflective objects (or stacks of reflective objects) in the waveguide at different locations at different times can enable blocking light from the environment from passing through selected locations of the waveguide and displaying virtual objects at those selected locations. These locations can change over time. In an example, selectively moving (e.g. reorienting) different reflective objects (or stacks of reflective objects) in the waveguide at different locations at different times can enable multiplexing the display of different projected content at different locations at different times.

In an example, reflective objects in a waveguide can be micromirrors. In an example, reflective objects in a waveguide can be nanoscale mirrors. In an example, reflective objects in a waveguide can be reflective molecules. In an example, reflective objects in a waveguide can be relatively planar and/or flat. In an example, reflective objects in a waveguide can be flat and arcuate (e.g. circular). In an example, reflective objects in a waveguide can be flat and polygonal (e.g. quadrilateral or hexagonal). In an example, polygonal reflective objects in a waveguide can be tilted and/or rotated around axles between opposite vertexes of the objects. In an example, reflective objects in a waveguide can be tilted and/or rotated around axles between (the mid-points of) opposite sides of the objects.

In an example, reflective objects in a waveguide can be partially reflective. In an example, reflective objects in a waveguide can be transflective micromirrors. In an example, the level of reflectivity of reflective objects in a waveguide can be changed and/or adjusted by exposure to electromagnetic (e.g. electrical) energy. In an example, the level of reflectivity of reflective objects in a waveguide can be changed and/or adjusted by the transmission of electromagnetic (e.g. electrical) energy. In an example, the level of reflectivity of reflective objects in a waveguide can be changed and/or adjusted by exposure to an electromagnetic field. In an example, the level of reflectivity of reflective objects in a waveguide can be changed and/or adjusted by changes in an electromagnetic field.

In an example, reflective objects in a waveguide can be connected by rotatable axles or joints to the waveguide. In an example, reflective objects in a waveguide can be suspended in a flowable substance (e.g. liquid, gel, or gas) within the waveguide. In an example, reflective objects in a waveguide can be suspended by an electromagnetic field within the waveguide. In an example, reflective objects in a waveguide can be made with ferrous and/or magnetic material so that application of electromagnetic energy changes their orientations. In an example, a plurality of reflective objects in a waveguide can be configured in a three-dimensional array. In an example, a plurality of reflective objects in a waveguide can be configured in a three-dimensional grid or matrix.

In an example, there can be a plurality (e.g. a stack) of reflective objects in a cross-sectional plane of a waveguide, wherein the cross-sectional plane is orthogonal to the longitudinal axis of the waveguide. In an example, there can be at least 10 reflective objects in a cross-sectional plane of a waveguide. In an example, there can be a plurality of reflective objects along the longitudinal axis of a waveguide. In an example, there can be at least 100 reflective objects along the longitudinal axis of a waveguide.

In an example, there can be a plurality (e.g. a stack) of reflective objects spanning a cross-sectional plane of a waveguide, wherein the cross-sectional plane is orthogonal to the longitudinal axis of the waveguide. In an example, an array or series of reflective objects in a waveguide can be coplanar, in a cross-sectional plane of the waveguide. In an example, an array or series of reflective objects in a waveguide can be staggered, in a plane which intersects a waveguide at an acute angle. In an example, an array or series of reflective objects in a waveguide can be coplanar in a plane which intersects the longitudinal axis of the waveguide at an acute angle. In an example, an array or series of reflective objects in a waveguide can be coplanar in a plane which intersects the longitudinal axis of the waveguide at an acute angle between 10 and 30 degrees. In an example, an array or series of reflective objects in a waveguide can be coplanar in a plane which intersects the longitudinal axis of the waveguide at an angle between 30 and 50 degrees.

In an example, reflective objects can be randomly distributed throughout the interior of a waveguide. In an example, reflective objects can be uniformly distributed throughout the interior of a waveguide. In an example, reflective objects within a waveguide can be arrayed in rows (parallel to the longitudinal axis of the waveguide) and columns (perpendicular to the longitudinal axis of the waveguide). In an example, reflective objects within a waveguide can be arrayed in rows (parallel to the longitudinal axis of the waveguide) and diagonal vectors (intersecting the longitudinal axis of the waveguide at acute angles). In an example, reflective objects within a waveguide can be arrayed in hexagonal (e.g. honeycomb) matrix or grid. In an example, reflective objects within a waveguide can be arrayed in rings. In an example, reflective objects within a waveguide can be arrayed in nested (e.g. concentric) rings. In an example, reflective objects within a waveguide can be configured in hub-and-spoke array. Relevant variations discussed elsewhere in this disclosure or in priority-linked disclosures can also be applied to the example shown in this figure.

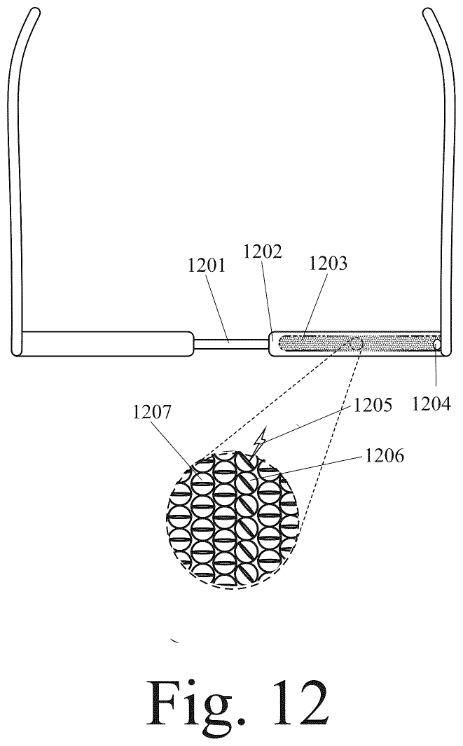

The upper portion of FIG. 12 shows a top-down view of another example of augmented reality eyewear (e.g. eyeglasses) with a dynamic waveguide. The lower portion of FIG. 12 (especially content in the dotted-line circle) shows an enlarged top-down cross-sectional view of a section of the dynamic waveguide. This example is like the one shown in FIG. 11 except that reflective objects in the waveguide are spherical rather than flat.

More specifically, FIG. 12 shows an example of augmented reality eyewear (e.g. eyeglasses) comprising: an eyewear (e.g. eyeglasses) frame 1201 which is configured to be worn by a person; a transparent optical structure (e.g. lens) 1202 which is configured to be held in front of one of the person's eyes by the frame; a light display 1204 which emits light rays that display one or more virtual objects in the person's field of view; and a dynamic waveguide 1203 which transmits light rays from the light display to locations on the transparent optical structure from which the light rays exit the waveguide toward the person's eye, wherein the interior of the dynamic waveguide further comprises a plurality of spherical reflective objects (including reflective objects 1206 and 1207) whose orientations are selectively changed by the application of electromagnetic energy 1205 (e.g. by the transmission of electrical voltage or by the creation of a magnetic field). In this example, the spherical objects are transparent except for a flat reflective surface within them which spans a central diameter.

In this example, there are a plurality of spherical reflective objects in a given cross-sectional plane of the waveguide. In this example, the spherical reflective objects can be described as being stacked in a cross-sectional plane of the waveguide. In this example, the orientations of spherical reflective objects in a selected cross-sectional stack of spherical reflective objects (including spherical reflective object 1206) are different from the orientations of spherical reflective objects in other cross-sectional stacks of spherical reflective objects (including spherical reflective object 1207) due to exposure of the selected stack to electromagnetic energy 1205.

In this example, the orientations of spherical reflective objects in the selected stack have been selectively changed due to the transmission of electromagnetic energy (e.g. electrical energy) to (or in proximity to) this selected stack. In an example, different spherical reflective objects and/or different stacks of spherical reflective objects in different locations can be selectively moved (e.g. reoriented) at different times by transmission of electromagnetic energy (e.g. electrical energy) to different locations of the waveguide at different times.

In this example, only the left side of the eyewear has an optical structure with a dynamic waveguide. In another example, the right side of the eyewear can also have such an optical structure. In an example, the right side of the eyewear can be symmetric with the left side.

In an example, spherical reflective objects in a waveguide with a first orientation can allow environmental light to pass through the waveguide in an unobstructed manner. In an example, the flat reflective surfaces within the spherical reflective objects in a selected section of the waveguide can be aligned with lines of sight from a person's eye in this first configuration. In an example, spherical reflective objects in a waveguide with a second orientation can block environmental light from passing through the waveguide and reflect light from a light display toward a person's eye. In an example, the flat reflective surfaces within the spherical reflective objects in a selected section of the waveguide can intersect lines of sight from a person's eye at an acute or right angle in this second configuration.

In an example, a selected subset of spherical reflective objects in a waveguide can be moved (e.g. pivoted, tilted, and/or rotated) from a first configuration to a second configuration by exposure to electromagnetic (e.g. electrical) energy. In an example, a selected subset of spherical reflective objects in a waveguide can be moved (e.g. pivoted, tilted, and/or rotated) from a first configuration to a second configuration by the transmission of electromagnetic (e.g. electrical) energy through a selected section of the waveguide. In an example, a selected subset of spherical reflective objects in a waveguide can be moved (e.g. pivoted, tilted, and/or rotated) from a first configuration to a second configuration by (changes in) an electromagnetic field.

In an example, selectively moving (e.g. reorienting) different spherical reflective objects (or stacks of spherical reflective objects) in the waveguide at different locations at different times can enable displaying virtual objects at different locations at different times. In an example, selectively moving (e.g. reorienting) different spherical reflective objects (or stacks of spherical reflective objects) in the waveguide at different locations at different times can enable blocking light from the environment from passing through selected locations of the waveguide and displaying virtual objects at those selected locations. These locations can change over time. In an example, selectively moving (e.g. reorienting) different spherical reflective objects (or stacks of spherical reflective objects) in the waveguide at different locations at different times can enable multiplexing the display of different projected content at different locations at different times.

In an example, reflective surfaces within the spheres in a waveguide can be micromirrors. In an example, reflective surfaces within the spheres in a waveguide can be nanoscale mirrors. In an example, reflective surfaces within the spheres in a waveguide can be relatively planar and/or flat. In an example, reflective surfaces within the spheres in a waveguide can be flat and arcuate (e.g. circular). In an example, reflective surfaces within the spheres in a waveguide can be flat and polygonal (e.g. quadrilateral or hexagonal).

In an example, reflective surfaces within the spheres in a waveguide can be partially reflective. In an example, reflective surfaces within the spheres in a waveguide can be transflective micromirrors. In an example, the level of reflectivity of reflective surfaces within the spheres in a waveguide can be changed and/or adjusted by exposure to electromagnetic (e.g. electrical) energy. In an example, the level of reflectivity of reflective surfaces within the spheres in a waveguide can be changed and/or adjusted by the transmission of electromagnetic (e.g. electrical) energy. In an example, the level of reflectivity of reflective surfaces within the spheres in a waveguide can be changed and/or adjusted by exposure to an electromagnetic field. In an example, the level of reflectivity of reflective surfaces within the spheres in a waveguide can be changed and/or adjusted by changes in an electromagnetic field.

In an example, spherical reflective objects in a waveguide can be connected by rotatable axles or joints to the waveguide. In an example, spherical reflective objects in a waveguide can be suspended in a flowable substance (e.g. liquid, gel, or gas) within the waveguide. In an example, spherical reflective objects in a waveguide can be suspended by an electromagnetic field within the waveguide. In an example, spherical reflective objects in a waveguide can be made with ferrous and/or magnetic material so that application of electromagnetic energy changes their orientations. In an example, a plurality of spherical reflective objects in a waveguide can be configured in a three-dimensional array. In an example, a plurality of spherical reflective objects in a waveguide can be configured in a three-dimensional grid or matrix.

In an example, there can be a plurality (e.g. a stack) of spherical reflective objects in a cross-sectional plane of a waveguide, wherein the cross-sectional plane is orthogonal to the longitudinal axis of the waveguide. In an example, there can be at least 10 spherical reflective objects in a cross-sectional plane of a waveguide. In an example, there can be a plurality of spherical reflective objects along the longitudinal axis of a waveguide. In an example, there can be at least 100 spherical reflective objects along the longitudinal axis of a waveguide.

In an example, there can be a plurality (e.g. a stack) of spherical reflective objects spanning a cross-sectional plane of a waveguide, wherein the cross-sectional plane is orthogonal to the longitudinal axis of the waveguide. In an example, an array or series of spherical reflective objects in a waveguide can be coplanar, in a cross-sectional plane of the waveguide. In an example, an array or series of spherical reflective objects in a waveguide can be staggered, in a plane which intersects a waveguide at an acute angle. In an example, an array or series of spherical reflective objects in a waveguide can be coplanar in a plane which intersects the longitudinal axis of the waveguide at an acute angle. In an example, an array or series of spherical reflective objects in a waveguide can be coplanar in a plane which intersects the longitudinal axis of the waveguide at an acute angle between 10 and 30 degrees. In an example, an array or series of spherical reflective objects in a waveguide can be coplanar in a plane which intersects the longitudinal axis of the waveguide at an angle between 30 and 50 degrees.

In an example, spherical reflective objects can be randomly distributed throughout the interior of a waveguide. In an example, spherical reflective objects can be uniformly distributed throughout the interior of a waveguide. In an example, spherical reflective objects within a waveguide can be arrayed in rows (parallel to the longitudinal axis of the waveguide) and columns (perpendicular to the longitudinal axis of the waveguide). In an example, spherical reflective objects within a waveguide can be arrayed in rows (parallel to the longitudinal axis of the waveguide) and diagonal vectors (intersecting the longitudinal axis of the waveguide at acute angles). In an example, spherical reflective objects within a waveguide can be arrayed in hexagonal (e.g. honeycomb) matrix or grid. In an example, spherical reflective objects within a waveguide can be arrayed in rings. In an example, spherical reflective objects within a waveguide can be arrayed in nested (e.g. concentric) rings. In an example, spherical reflective objects within a waveguide can be configured in hub-and-spoke array. Relevant variations discussed elsewhere in this disclosure or in priority-linked disclosures can also be applied to the example shown in this figure.

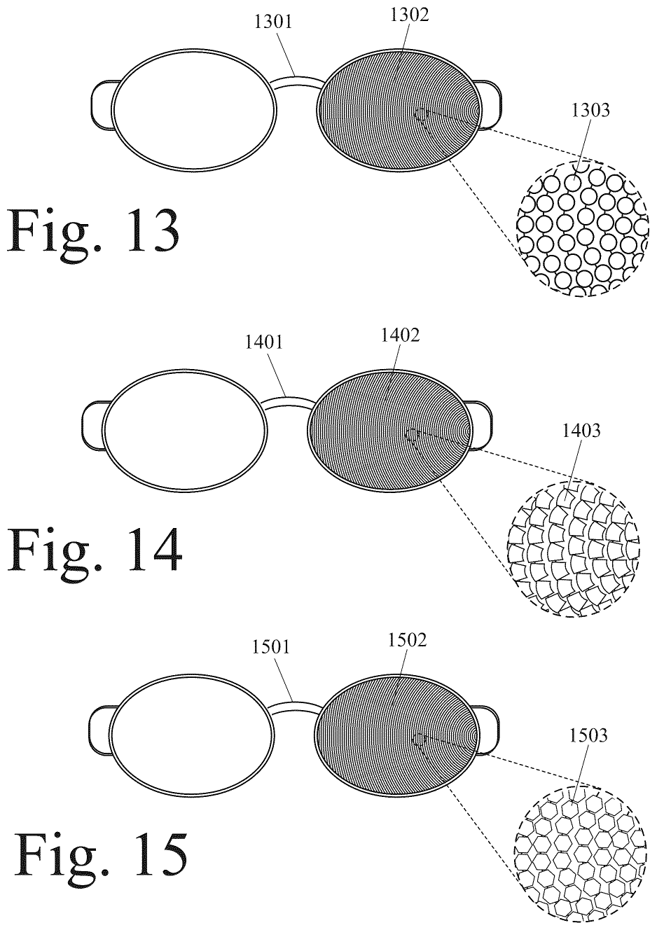

The upper portion of FIG. 13 shows a frontal view of an example of augmented reality eyewear (e.g. eyeglasses) with an array of movable reflective components (e.g. rotatable micromirrors). The lower-left portion of FIG. 13 shows an enlarged frontal cross-sectional view of a section of the array of movable reflective components. More specifically, FIG. 13 shows an example of augmented reality eyewear (e.g. eyeglasses) comprising: an eyewear (e.g. eyeglasses) frame 1301 which is configured to be worn by a person; a transparent optical structure (e.g. lens) 1302 which is configured to be held in front of one of the person's eyes by the frame; and an array 1303 of movable reflective components. In this example, only the left side of the eyewear has this array. In another example, the right side of the eyewear can also have such an array. In an example, the right side of the eyewear can be symmetric with the left side.

In this example, movable reflective components have arcuate perimeters. In this example, movable reflective components are circular. In this example, movable reflective components are circular and planar (e.g. flat). In this example, movable reflective components tilt and/or rotate around central axes which span a diameter of their circular shape. In this example, the central axes of the movable reflective components are rotatably-linked to each other along arcuate lines. In an example, these arcuate lines can be (nested) ring sections. In an example, these arcuate lines can be sections of circles, ellipses, or ovals. In an example, these arcuate lines can be concave lines whose openings face toward a light display (e.g. on the side of a rim which holds the transparent optical structure (e.g. lens). In an example, there can be at least 100 movable reflective components in an array in front of one eye.

In an example, movable reflective components in the array can have a first configuration wherein they are substantially parallel to lines of sight extending out from the person's eye, allowing light from the environment to pass through the optical structure to the person's eye. In an example, movable reflective components in the array can have a second configuration wherein they are intersect lines of sight extending out from the person's eye at acute or right angles, blocking light from the environment and reflecting light from a light display toward the person's eye.

In an example, a subset of movable reflective components in a section of the transparent structure can be configured (e.g. moved and/or oriented) to selectively block environmental light from passing through this section and to reflect light from a light display toward the person's eye in order to display an opaque virtual object in the persons' field of view via that section. In an example, the orientations of a selected subset of reflective components in the array can be selectively and independently changed by exposing reflective components in that subset to electromagnetic (e.g. electrical) energy.

In an example, a selected subset of reflective components in the array can be selectively and independently changed from a first configuration to a second configuration by exposing reflective components in that subset to electromagnetic (e.g. electrical) energy. In an example, a selected subset of reflective components in the array can be selectively and independently changed from a first configuration to a second configuration by the transmission of electromagnetic (e.g. electrical) energy. In an example, a selected subset of reflective components in the array can be selectively and independently changed from a first configuration to a second configuration by (changes in) an electromagnetic field.

In an example, this eyewear can further comprise one or more light displays which emit light rays which display one or more virtual objects in the person's field of view. In an example, light rays from a light display on a sidepiece (e.g. temple) of the eyewear frame can be reflected by (a subset of) movable reflective components in the array back toward the person's eye to display a virtual object in the person's field of view. In an example, light rays from a light display on one side of the transparent optical structure can be transmitted through the transparent optical structure and then directed by (a subset of) movable reflective components toward the person's eye to display a virtual object in the person's field of view. In an example, light rays from a light display on the frontpiece of the eyewear can be transmitted through the transparent optical structure and then directed by (a subset of) movable reflective components toward the person's eye to display a virtual object in the person's field of view. Relevant variations discussed elsewhere in this disclosure or in priority-linked disclosures can also be applied to the example shown in this figure.

The upper portion of FIG. 14 shows a frontal view of an example of augmented reality eyewear (e.g. eyeglasses) with an array of movable reflective components (e.g. rotatable micromirrors). The lower-left portion of FIG. 14 shows an enlarged frontal cross-sectional view of a section of the array of movable reflective components. More specifically, FIG. 14 shows an example of augmented reality eyewear (e.g. eyeglasses) comprising: an eyewear (e.g. eyeglasses) frame 1401 which is configured to be worn by a person; a transparent optical structure (e.g. lens) 1402 which is configured to be held in front of one of the person's eyes by the frame; and an array 1403 of movable reflective components. In this example, only the left side of the eyewear has this array. In another example, the right side of the eyewear can also have such an array. In an example, the right side of the eyewear can be symmetric with the left side.

In this example, movable reflective components have keystone shapes and/or annular section shapes. In this example, movable reflective components have perimeters with shapes like the area cleared by a windshield wiper. In this example, movable reflective components are planar (e.g. flat). In this example, the central axes of the movable reflective components are rotatably-linked to each other along arcuate lines. In an example, these arcuate lines can be (nested) ring sections. In an example, these arcuate lines can be sections of circles, ellipses, or ovals. In an example, these arcuate lines can be concave lines whose openings face toward a light display (e.g. on the side of a rim which holds the transparent optical structure (e.g. lens). In an example, there can be at least 100 movable reflective components in an array in front of one eye.

In an example, movable reflective components in the array can have a first configuration wherein they are substantially parallel to lines of sight extending out from the person's eye, allowing light from the environment to pass through the optical structure to the person's eye. In an example, movable reflective components in the array can have a second configuration wherein they are intersect lines of sight extending out from the person's eye at acute or right angles, blocking light from the environment and reflecting light from a light display toward the person's eye.

In an example, a subset of movable reflective components in a section of the transparent structure can be configured (e.g. moved and/or oriented) to selectively block environmental light from passing through this section and to reflect light from a light display toward the person's eye in order to display an opaque virtual object in the persons' field of view via that section. In an example, the orientations of a selected subset of reflective components in the array can be selectively and independently changed by exposing reflective components in that subset to electromagnetic (e.g. electrical) energy.

In an example, a selected subset of reflective components in the array can be selectively and independently changed from a first configuration to a second configuration by exposing reflective components in that subset to electromagnetic (e.g. electrical) energy. In an example, a selected subset of reflective components in the array can be selectively and independently changed from a first configuration to a second configuration by the transmission of electromagnetic (e.g. electrical) energy. In an example, a selected subset of reflective components in the array can be selectively and independently changed from a first configuration to a second configuration by (changes in) an electromagnetic field.

In an example, this eyewear can further comprise one or more light displays which emit light rays which display one or more virtual objects in the person's field of view. In an example, light rays from a light display on a sidepiece (e.g. temple) of the eyewear frame can be reflected by (a subset of) movable reflective components in the array back toward the person's eye to display a virtual object in the person's field of view. In an example, light rays from a light display on one side of the transparent optical structure can be transmitted through the transparent optical structure and then directed by (a subset of) movable reflective components toward the person's eye to display a virtual object in the person's field of view. In an example, light rays from a light display on the frontpiece of the eyewear can be transmitted through the transparent optical structure and then directed by (a subset of) movable reflective components toward the person's eye to display a virtual object in the person's field of view. Relevant variations discussed elsewhere in this disclosure or in priority-linked disclosures can also be applied to the example shown in this figure.

The upper portion of FIG. 15 shows a frontal view of an example of augmented reality eyewear (e.g. eyeglasses) with an array of movable reflective components (e.g. rotatable micromirrors). The lower-left portion of FIG. 15 shows an enlarged frontal cross-sectional view of a section of the array of movable reflective components. More specifically, FIG. 15 shows an example of augmented reality eyewear (e.g. eyeglasses) comprising: an eyewear (e.g. eyeglasses) frame 1501 which is configured to be worn by a person; a transparent optical structure (e.g. lens) 1502 which is configured to be held in front of one of the person's eyes by the frame; and an array 1503 of movable reflective components. In this example, only the left side of the eyewear has this array. In another example, the right side of the eyewear can also have such an array. In an example, the right side of the eyewear can be symmetric with the left side.

In this example, movable reflective components have hexagonal shapes. In this example, movable reflective components are planar (e.g. flat). In this example, the movable reflective components are rotatably-linked to each other along arcuate lines. In an example, these arcuate lines can be (nested) ring sections. In an example, these arcuate lines can be sections of circles, ellipses, or ovals. In an example, these arcuate lines can be concave lines whose openings face toward a light display (e.g. on the side of a rim which holds the transparent optical structure (e.g. lens). In an example, there can be at least 100 movable reflective components in an array in front of one eye.

In an example, movable reflective components in the array can have a first configuration wherein they are substantially parallel to lines of sight extending out from the person's eye, allowing light from the environment to pass through the optical structure to the person's eye. In an example, movable reflective components in the array can have a second configuration wherein they are intersect lines of sight extending out from the person's eye at acute or right angles, blocking light from the environment and reflecting light from a light display toward the person's eye.

In an example, a subset of movable reflective components in a section of the transparent structure can be configured (e.g. moved and/or oriented) to selectively block environmental light from passing through this section and to reflect light from a light display toward the person's eye in order to display an opaque virtual object in the persons' field of view via that section. In an example, the orientations of a selected subset of reflective components in the array can be selectively and independently changed by exposing reflective components in that subset to electromagnetic (e.g. electrical) energy.

In an example, a selected subset of reflective components in the array can be selectively and independently changed from a first configuration to a second configuration by exposing reflective components in that subset to electromagnetic (e.g. electrical) energy. In an example, a selected subset of reflective components in the array can be selectively and independently changed from a first configuration to a second configuration by the transmission of electromagnetic (e.g. electrical) energy. In an example, a selected subset of reflective components in the array can be selectively and independently changed from a first configuration to a second configuration by (changes in) an electromagnetic field.

In an example, this eyewear can further comprise one or more light displays which emit light rays which display one or more virtual objects in the person's field of view. In an example, light rays from a light display on a sidepiece (e.g. temple) of the eyewear frame can be reflected by (a subset of) movable reflective components in the array back toward the person's eye to display a virtual object in the person's field of view. In an example, light rays from a light display on one side of the transparent optical structure can be transmitted through the transparent optical structure and then directed by (a subset of) movable reflective components toward the person's eye to display a virtual object in the person's field of view. In an example, light rays from a light display on the frontpiece of the eyewear can be transmitted through the transparent optical structure and then directed by (a subset of) movable reflective components toward the person's eye to display a virtual object in the person's field of view. Relevant variations discussed elsewhere in this disclosure or in priority-linked disclosures can also be applied to the example shown in this figure.

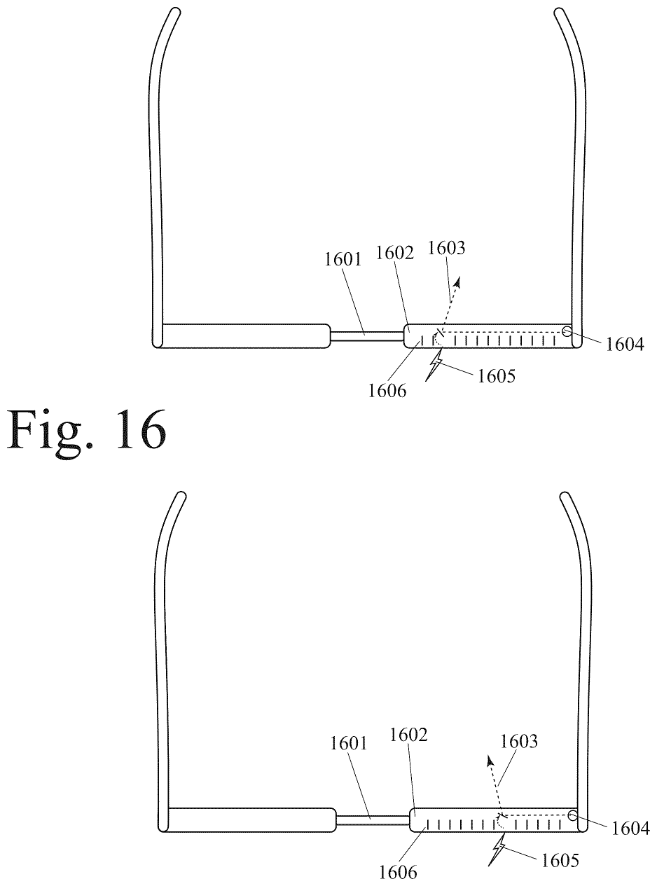

FIG. 16 shows two top-down views, at two different times, of an example of augmented reality eyewear (e.g. eyeglasses) comprising: an eyewear (e.g. eyeglasses) frame 1601 which is configured to be worn by a person; a transparent optical structure (e.g. lens) 1602 which is configured to be held in front of one of the person's eyes by the frame; a light display 1604 which emits light rays 1603 which display a virtual object in the person's field of view; and a longitudinal array of movable reflective components 1606 within, or parallel to, a longitudinal axis of the transparent optical structure; wherein reflective components in the array are selectively moved (e.g. pivoted, tilted, and/or rotated) by the transmission of electromagnetic (e.g. electrical energy) 1605. In this example, only the left side of the eyewear has this array. In another example, the right side of the eyewear can also have such an array. In an example, the right side of the eyewear can be symmetric with the left side.

The upper portion of FIG. 16 shows this eyewear at first time when a first subset of reflective components in the array has been moved (e.g. pivoted, tilted, and/or rotated) by transmission of electromagnetic (e.g. electrical) energy. At this first time, the first subset of reflective components has been moved to a configuration in which it reflects light from the light display toward the person's eye (and at least partially blocks light from the environment from reaching the person's eye at its location).

The lower portion of FIG. 16 shows this eyewear at second time when a second subset of reflective components in the array has been moved (e.g. pivoted, tilted, and/or rotated) by transmission of electromagnetic (e.g. electrical) energy. At this second time, the second subset of reflective components has been moved to a configuration in which it reflects light from the light display toward the person's eye (and at least partially blocks light from the environment from reaching the person's eye at its location).

In this example, light from a light display on one side of the transparent optical structure is transmitted through the transparent optical structure until it reaches, and is reflected by, a reflective component. In this example, light from a light display on one side of the transparent optical structure travels through a proximal light channel and/or waveguide in the transparent optical structure which is adjacent to the proximal surface of the transparent optical component. In this example, the longitudinal array of movable reflective components is adjacent to the distal surface of the transparent optical component. In this example, a selected subset of reflective components is moved (e.g. pivoted, tilted, and/or rotated in a proximal direction out from the longitudinal array in order to reflect light rays from the light display toward the person's eye.

In this example, the transparent optical structure further comprises: a longitudinal light channel and/or waveguide; and a longitudinal array of moveable reflective components, wherein the light channel and/or waveguide is proximal (e.g. closer to the person's eye) than the longitudinal array. In an example, light from a light display travels longitudinally along the light channel and/or waveguide until it is reflected toward the person's eye by one or more reflective components which have been moved (e.g. pivoted, tilted, and/or rotated in a proximal direction out from the rest of the array of reflective components. In an example, one or more reflective components can be selectively and/or independently moved (e.g. pivoted, tilted, and/or rotated out from the rest of the reflective components in the array by the transmission of electromagnetic (e.g. electrical) energy. In an example, a movable reflective component can be a movable micromirror.

In an example, selective movement of different reflective components in the array at different times can enable reflection of light rays from the light display from different locations on the transparent optical structure at different times. This, in turn, can enable multiplexing reflection location and content to display virtual objects at different locations in the person's field of view at different times. This can also enable displaying virtual objects with different sizes and shapes in the person's field of view.

In an example, one or more reflective components in the array can be moved (e.g. pivoted, tilted, and/or rotated) by transmission of electrical energy through a grid and/or matrix of transparent electroconductive pathways. In an example, a grid and/or matrix of transparent electroconductive pathways can be integrated into the transparent optical structure. In an example, a grid and/or matrix of transparent electroconductive pathways can be distal to the transparent optical structure. In an example, a grid and/or matrix of transparent electroconductive pathways can be proximal to the transparent optical structure.

In an example, there can be a first grid and/or matrix of transparent electroconductive pathways which is proximal to the transparent optical structure and a second grid and/or matrix of transparent electroconductive pathways which is distal to the transparent optical structure. In an example, transmission of electrical energy between first and second grids and/or matrixes of transparent electroconductive pathways can move (e.g. pivot, tilt, and/or rotate) selected reflective components in the longitudinal array of reflective components. In an example, an electromagnetic field between first and second grids and/or matrixes of transparent electroconductive pathways can move (e.g. pivot, tilt, and/or rotate) selected reflective components in the longitudinal array of reflective components. Relevant variations discussed elsewhere in this disclosure or in priority-linked disclosures can also be applied to the example shown in this figure.

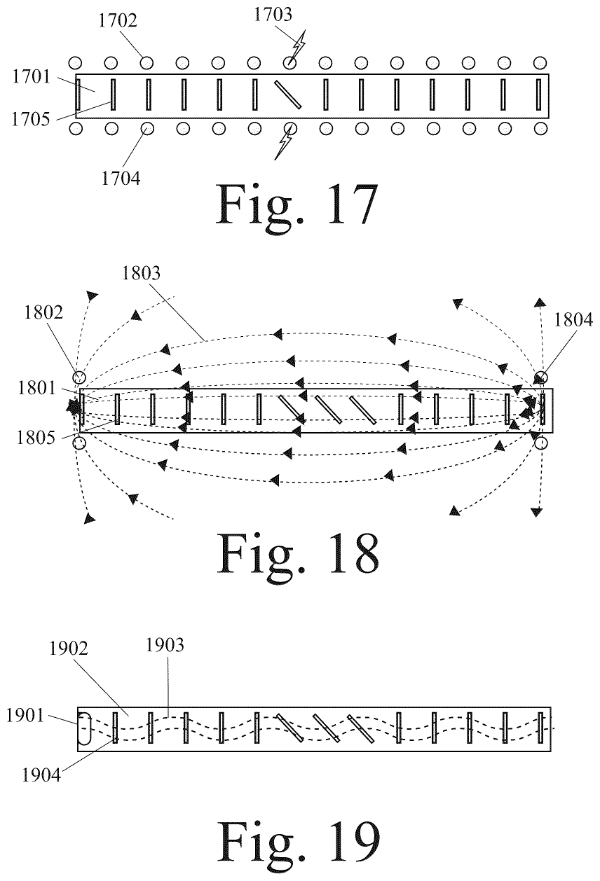

FIG. 17 shows a top-down cross-sectional view of a part (e.g. a lens) of augmented reality eyewear which is placed in front of a person's eye comprising: a transparent optical structure 1701 which is configured to be worn by a person in front of one of the person's eyes; an array of movable reflective components (including 1705) within the transparent optical structure; a first array (e.g. grid or mesh) of electroconductive pathways (including 1702) which is proximal (e.g. closer to the eye) relative to the transparent optical structure; and a second array (e.g. grid or mesh) of electroconductive pathways (including 1704) which is distal (e.g. farther from the eye) relative to the transparent optical structure, wherein transmission of electrical energy 1703 between the first array of electroconductive pathways and the second array of electroconductive pathways moves (e.g. pivots, tilts, and/or rotates) one or more reflective components in the array of reflective components.

In this example, only the left side of the eyewear has this structure. In another example, the right side of the eyewear can also have such structure. In an example, the right side of the eyewear can be symmetric with the left side. In an example, movable reflective components can be micromirrors. In an example, movable reflective components can be reflective molecules. In an example, movable reflective components can be moveable reflective surfaces or gratings within an otherwise transparent optical structure.

In an example, a selected subset of movable reflective components can be moved by transmission of electrical energy between a selected subset of electroconductive pathways in the first array and/or the second array of electroconductive pathways. In an example, a selected subset of movable reflective components in a first location on the transparent optical structure can be moved by transmission of electrical energy between a selected subset of electroconductive pathways in the first array and/or the second array of electroconductive pathways. In an example, different selected subsets of movable reflective components in different locations can be moved by transmission of electrical energy between different selected subsets of electroconductive pathways at different times.

In an example, a movable reflective component can have a first configuration in which (a virtual extension of) its longitudinal axis is substantially perpendicular to the longitudinal axis of the transparent optical structure and a second configuration in which (a virtual extension of) its longitudinal axis intersects the longitudinal axis of the transparent optical structure at an acute angle. In an example, a movable reflective component can be moved (e.g. pivoted, tilted, and/or rotated) from its first configuration to its second configuration by exposure to electrical energy transmitted between the first and second arrays of electroconductive pathways. In an example, a movable reflective component can be moved (e.g. pivoted, tilted, and/or rotated) from its first configuration to its second configuration by voltage. In an example, a movable reflective component can be moved (e.g. pivoted, tilted, and/or rotated) from its first configuration to its second configuration by an electromagnetic field between the first and second arrays of electroconductive pathways.

In an example, first and second arrays of electroconductive pathways can be substantially parallel with the transparent optical structure. In an example, an array of electroconductive pathways can comprise an orthogonal grid of electroconductive pathways. In an example, an array of electroconductive pathways can comprise a hexagonal (e.g. honeycomb) grid or mesh of electroconductive pathways. In an example, an array of electroconductive pathways can comprise a plurality of nested (e.g. concentric) rings of electroconductive pathways. In an example, an array of electroconductive pathways can comprise electroconductive pathways shaped like annular sections. In an example, an array of electroconductive pathways can comprise a hub-and-spoke array of electroconductive pathways. In an example, an array of electroconductive pathways can comprise a radial array of electroconductive pathways.

In an example, reflective components can be suspended in a flowable substance (e.g. a liquid, gel, or gas) within a transparent reflective structure. In an example, reflective components can be suspended by an electromagnetic field within a transparent reflective structure. In an example, reflective components can be rotatably connected by microwires or strands within a transparent reflective structure. In an example, a reflective component can rotate, tilt, or pivot around an axis between two of its vertexes. In an example, a reflective component can rotate, tilt, or pivot around an axis between midpoints of two of its sides. In an example, a reflective component can rotate, tilt, or pivot around one of their sides. Relevant variations discussed elsewhere in this disclosure or in priority-linked disclosures can also be applied to the example shown in this figure.

FIG. 18 shows a top-down cross-sectional view of a part (e.g. a lens) of augmented reality eyewear which is placed in front of a person's eye comprising: a transparent optical structure 1801 which is configured to be worn by a person in front of one of the person's eyes; an array of movable reflective components (including 1805) within the transparent optical structure; a first electroconductive pathway, electrode, or pole 1802; and a second electroconductive pathway, electrode, or pole 1804, wherein an electromagnetic field 1803 created between the first and second electroconductive pathways, electrodes, or poles moves (e.g. pivots, tilts, and/or rotates) one or more reflective components in the array of reflective components.

In this example, only the left side of the eyewear has this structure. In another example, the right side of the eyewear can also have such structure. In an example, the right side of the eyewear can be symmetric with the left side. In an example, movable reflective components can be micromirrors. In an example, movable reflective components can be reflective molecules. In an example, movable reflective components can be moveable reflective surfaces or gratings within an otherwise transparent optical structure.

In an example, a first electroconductive pathway, electrode, or pole can be located at a first end (or side) of the transparent optical structure and a second electroconductive pathway, electrode, or pole can be located at a second end (or side) of the structure. In an example, a first electroconductive pathway, electrode, or pole can be located at one end (or side) of the transparent optical structure and a second electroconductive pathway, electrode, or pole can be located at the opposite end (or side) of the structure. In an example, a selected subset of movable reflective components can be moved by an electromagnetic field between the first and second electroconductive pathways, electrodes, or poles. In an example, different selected subsets of movable reflective components can be moved by creating different electromagnetic field patterns between the first and second electroconductive pathways, electrodes, or poles.

In an example, a movable reflective component can have a first configuration in which (a virtual extension of) its longitudinal axis is substantially perpendicular to the longitudinal axis of the transparent optical structure and a second configuration in which (a virtual extension of) its longitudinal axis intersects the longitudinal axis of the transparent optical structure at an acute angle. In an example, a movable reflective component can be moved (e.g. pivoted, tilted, and/or rotated) from its first configuration to its second configuration by changes in an electromagnetic field.

In an example, reflective components can be suspended in a flowable substance (e.g. a liquid, gel, or gas) within a transparent reflective structure. In an example, reflective components can be suspended by an electromagnetic field within a transparent reflective structure. In an example, reflective components can be rotatably connected by microwires or strands within a transparent reflective structure. In an example, a reflective component can rotate, tilt, or pivot around an axis between two of its vertexes. In an example, a reflective component can rotate, tilt, or pivot around an axis between midpoints of two of its sides. In an example, a reflective component can rotate, tilt, or pivot around one of their sides. Relevant variations discussed elsewhere in this disclosure or in priority-linked disclosures can also be applied to the example shown in this figure.

FIG. 19 shows a top-down cross-sectional view of a part (e.g. a lens) of augmented reality eyewear which is placed in front of a person's eye comprising: a transparent optical structure 1901 which is configured to be worn by a person in front of one of the person's eyes; and an array of movable reflective components (including 1904) within the transparent optical structure, wherein one or more reflective components in the array of moveable reflective components are moved (e.g. pivoted, tilted, and/or rotated) by an acoustic wave 1903 within the transparent optical structure.

In this example, only the left side of the eyewear has this structure. In another example, the right side of the eyewear can also have such structure. In an example, the right side of the eyewear can be symmetric with the left side. In an example, movable reflective components can be micromirrors. In an example, movable reflective components can be reflective molecules. In an example, movable reflective components can be moveable reflective surfaces or gratings within an otherwise transparent optical structure.

In an example, this part can further comprise a sound emitter (e.g. acoustic energy generator) which generates an acoustic wave which moves (e.g. pivots, tilts, and/or rotates) one or more reflective components. In an example, a sound emitter can be located at one end of the transparent optical structure. In an example, a sound emitter can be located on one side of the transparent optical structure. In an example, a sound emitter can create an acoustic wave which travels longitudinally within the transparent optical structure. In an example, a sound emitter can create an acoustic wave which travels longitudinally within the transparent optical structure, sequentially moving reflective components along the length of the array of reflective components.

In an example, a sound emitter can create an acoustic wave at a resonant frequency of the transparent optical structure to selectively move reflective components at one or more selected locations on the transparent optical structure. In an example, a sound emitter can create acoustic waves with different frequencies and/or amplitudes to move reflective components at different locations on the transparent optical structure at different times.

In an example, this part can comprise a first sound emitter at a first end (or side) of the transparent optical structure and a second sound emitter at a second end (or side) of the transparent optical structure. In an example, this part can comprise a first sound emitter at a first end (or side) of the transparent optical structure and a second sound emitter at a second end (or side) of the transparent optical structure, wherein constructive or destructive interference between two acoustic waves created by these two sound emitters moves one or more reflective components at selected locations on the transparent optical structure. Relevant variations discussed elsewhere in this disclosure or in priority-linked disclosures can also be applied to the example shown in this figure.

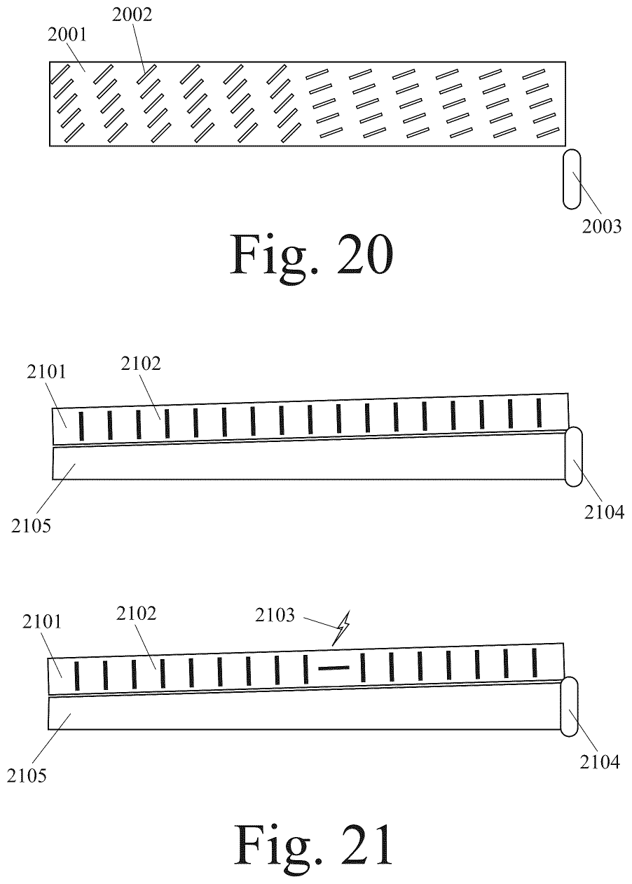

FIG. 20 shows a top-down cross-sectional view of a part of augmented reality eyewear comprising: a transparent optical structure 2001 which is configured to be worn by a person in front of one of the person's eyes; an array of reflective components (including reflective component 2002) within the transparent optical structure, wherein the array consists of a plurality of diagonally-staggered rows of reflective components, and wherein the angles at which the diagonally-staggered rows intersect a longitudinal axis of the transparent optical structure vary with distance from the light display; and a light display 2003 which emits light rays which are reflected by the reflective components toward the person's eye in order to display a virtual object in the person's field of view.

In this example, only the left side of the eyewear has this structure. In another example, the right side of the eyewear can also have such structure. In an example, the right side of the eyewear can be symmetric with the left side. In an example, reflective components can be micromirrors. In an example, reflective components can be reflective surfaces or gratings.

In an example, a diagonally-staggered row of reflective components can comprise at least 5 reflective components. In an example, the centroids of reflective components in a diagonally-staggered row of reflective components can be colinear (e.g. aligned along a common vector). In an example, this common vector can intersect a longitudinal axis of a transparent optical structure at an acute angle.

In an example, the centroids of reflective components in a first subset of diagonally-staggered rows can be aligned along vectors which intersect a longitudinal axis of a transparent optical structure at a first angle, the centroids of reflective components in a second subset of diagonally-staggered rows can be aligned along vectors which intersect the longitudinal axis at a second angle, and the second angle can be greater than the first angle. In an example, reflective components in the same diagonally-staggered row can be parallel to (virtual extensions of) each other.

In an example, the centroids of reflective components in a first subset of diagonally-staggered rows which is closer to a light display can be aligned along vectors which intersect a longitudinal axis of a transparent optical structure at a first angle, the centroids of reflective components in a second subset of diagonally-staggered rows which is farther from the light display can be aligned along vectors which intersect the longitudinal axis at a second angle, and the second angle can be greater than the first angle.

In an example, the centroids of reflective components in a first subset of diagonally-staggered rows which is a first average distance from a light display can be aligned along vectors which intersect a longitudinal axis of a transparent optical structure at a first angle, the centroids of reflective components in a second subset of diagonally-staggered rows which is a second average distance from the light display can be aligned along vectors which intersect the longitudinal axis at a second angle, wherein the second average distance is greater than the first average distance, and wherein the second angle is greater than the first angle. Relevant variations discussed elsewhere in this disclosure or in priority-linked disclosures can also be applied to the example shown in this figure.

FIG. 21 shows two views, at two different ties, of a top-down cross-sectional view of a part of augmented reality eyewear comprising: a light display 2104 which emits light rays which display a virtual object in a person's field of view; a proximal optical component 2105 which is configured to be worn by in front of the person's eye at a first distance from the eye, wherein light rays from the light display are transmitted through the proximal optical component to a location from which they exit the proximal optical component toward the person's eye to display a virtual object in the person's field of view; a distal optical component 2101 which is configured to be worn by in front of the person's eye at a second distance from the eye, wherein the second distance is greater than the first distance; and an array of movable reflective components (including 2102) within the distal optical component, wherein movable reflective components have a first configuration which allows light from the environment to pass through the distal optical component to reach the person's eye, wherein movable reflective components have a second configuration which blocks light from the environment from reaching the person's eye, and wherein moveable reflective components are moved (e.g. pivoted, tilted, and/or rotated) from the first configuration to the second configuration by electrical energy transmission 2103 and/or an electromagnetic field.

The upper portion of FIG. 21 shows this structure at a first time when all of the reflective components are in a first configuration which allows environmental light to pass. The lower portion of FIG. 21 shows this structure at a second time when one of the reflective components has been changed to a second configuration by the transmission of electrical energy. In an example, only the left side of eyewear has this structure. In another example, the right side of the eyewear can also have such structure. In an example, the right side of the eyewear can be symmetric with the left side. In an example, movable reflective components can be movable micromirrors. In an example, movable reflective components can be movable reflective surfaces and/or gratings.

In an example, the proximal optical structure can be a waveguide. In an example, the proximal optical structure can have a wedge shape. In an example, the width of the proximal optical structure can decrease with distance from the light display. In an example, the proximal optical structure can be a waveguide which transmits light rays from a light display to a location from which the light rays exit the waveguide toward the person's eye. In an example, the proximal optical structure can be a waveguide which transmits light rays from a light display via internal reflection to a location from which the light rays exit the waveguide toward the person's eye. In an example, the proximal optical structure can be a waveguide which transmits light rays from a light display along the length of waveguide via internal reflection to a location from which the light rays exit the waveguide toward the person's eye. Relevant variations discussed elsewhere in this disclosure or in priority-linked disclosures can also be applied to the example shown in this figure.

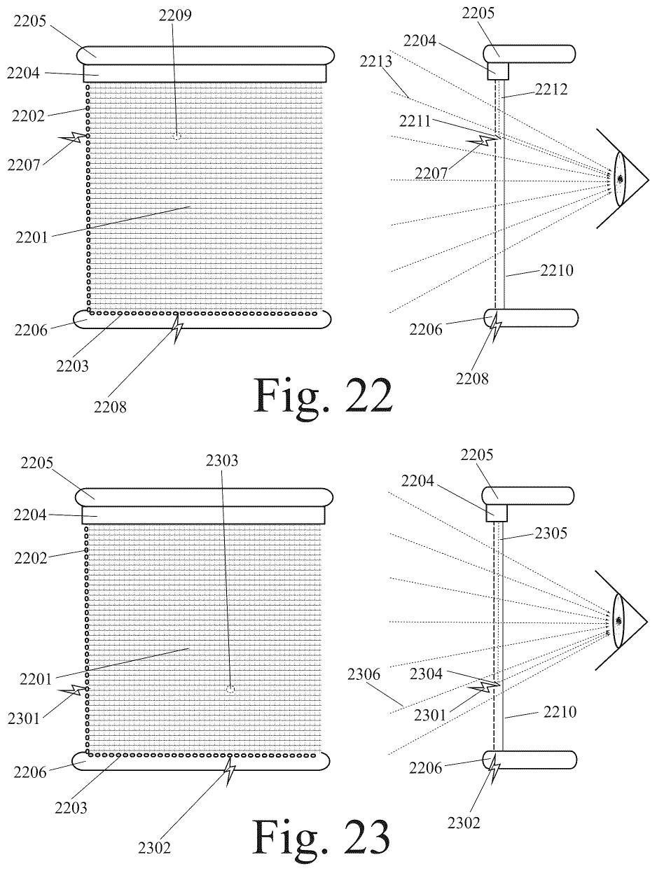

FIGS. 22 and 23 show two views, at two different times, of an example of an optical structure (e.g. lens) for augmented reality eyewear comprising an array (e.g. grid) of selectively-movable individual optical elements (e.g. reflective components). These figures show an optical structure (e.g. lens) in front of one eye. In an example, eyewear can include two such optical structures, one for each eye. These figures show upper and lower portions of a frame around the perimeter of the optical structure (such as a frame holding a lens). In an example, this frame can also span the lateral sides of the perimeter of the optical structure. The left sides of these two figures show frontal views of the optical structure. The right sides of these two figures show lateral cross-sectional side views of this optical structure.

FIG. 22 shows this optical structure at a first point in time wherein a first selected optical element in the array (e.g. grid) is configured (oriented) so as to reflect a first set of light rays of a virtual image toward a person's eye. FIG. 23 shows this same optical structure at a second point in time wherein a second selected optical element in the array (e.g. grid) is configured (oriented) to reflect a second set of light rays of the virtual image toward the person's eye. In an example, a series of multiple sets of light rays which are sequentially-reflected by a series of movable optical elements can be multiplexed (e.g. synchronized and combined) to project an image of a virtual object in the person's field of view.

FIGS. 22 and 23 show two sequential views of a single-eye component of augmented reality eyewear with an array (e.g. grid) of selectively-movable optical elements, wherein a first set of one or more optical elements in the array (e.g. grid) reflects a first set of rays of light of a virtual image toward a person's eye at a first point in time (as shown in FIG. 22) and wherein a second set of one or more optical elements in the array (e.g. grid) reflects a second set of rays of light of the virtual image toward the person's eye at a second point in time (as shown in FIG. 23).

FIGS. 22 and 23 can also be described as showing two sequential views of a single-eye component of augmented reality eyewear with an array (e.g. grid) of selectively-movable optical elements, wherein at least one optical element in the array (e.g. grid) is selectively-moved from a first configuration in which the optical element does not reflect rays of light of a virtual image toward a person's eye to a second configuration in which the optical element does reflect rays of light of the virtual image toward the person's eye. The ability to reversibly change optical members from their first configurations to their second configurations, and back again, can be advantageous because it can allow light rays from a light-emitting virtual object display (located along an edge of the array) to reach any optical member in the array (e.g. grid) at a given time without these light rays being blocked by intermediate optical members.

FIGS. 22 and 23 can be also described as showing a single-eye component of augmented reality eyewear comprising: an array (e.g. grid) of individually-movable optical elements which is configured to be worn in front of a person's eye; and a light-emitting virtual object display which emits rays of light which form a virtual image in the person's field of view; wherein a selected optical element in the array (e.g. grid) has a first configuration in which the optical element does not block light from the light-emitting virtual object display from reaching other optical elements which are farther from the light-emitting virtual object display and does not reflect those rays of light toward the person's eye; wherein the optical element in the array (e.g. grid) has a second configuration in which the optical element blocks light from the light-emitting virtual object display from reaching other optical elements which are farther from the light-emitting virtual object display and reflects those rays of light toward the person's eye; and wherein the selected optical element in the array (e.g. grid) is changed from its first configuration to its second configuration by selective transmission of electromagnetic energy through a selected row and a selected column of electromagnetic energy pathways which are in electromagnetic communication with the array (e.g. grid) of optical elements.

In an example, optical elements in an array (e.g. grid) of optical elements can be partially-reflective. In an example, optical elements in an array (e.g. grid) can be partially-reflective mirrors. In an alternative example, optical elements can have fully-reflective surfaces. In an example, optical elements can be fully-reflective mirrors. In an example, optical elements can be micro-lenses or micro-prisms. In an example, optical elements can be flat. In an example, optical elements can be arcuate. In an example, optical elements can be convex or concave. In an example, optical elements can have a conic section shape. In an example, an array (e.g. grid) of optical elements can be flat. In an example, an array (e.g. grid) can be arcuate. In an example, an array (e.g. grid) can be convex. In an example, an array (e.g. grid) can be concave. In an example, an array (e.g. grid) can have a conic section shape.

In an example, an array (e.g. grid) of optical elements can comprise an array (e.g. grid) with perpendicular rows and columns of optical elements. In an example, an array (e.g. grid) can have over 10 rows and over 10 columns of optical elements. In an example, an array (e.g. grid) can have over 100 optical elements. In, an example, an array (e.g. grid) of optical elements can be a circular or elliptical radial or polar coordinate array (e.g. grid) with rays (or spokes) and rings of optical elements. In an example, an array (e.g. grid) can have over 10 rays (or spokes) and over 10 rings of optical elements. In an example, optical elements can be closer together in outer rings of a radial array of optical elements (with spokes and rings). In an example, optical elements can be larger in outer rings of a radial array of optical elements (with spokes and rings). In an example, a radial array can have an overall circular, elliptical, or oval shape.

In an example, all optical elements in an array (e.g. grid) can have the same size. In an example, optical elements toward the center of the array (e.g. grid) can be smaller than optical elements toward the periphery of the array (e.g. grid). In an example, all optical elements in an array (e.g. grid) can have the same shape. In an example, optical elements in an array (e.g. grid) can have different shapes. In an example, optical elements can be quadrilateral. In an example, optical elements can be circular. In an example, optical elements can be hexagonal. In an example, an array (e.g. grid) of optical elements can comprise a hexagonal array (e.g. grid). In an example, optical elements in an array (e.g. grid) can be substantially adjacent to each other, without non-reflective gaps between them. In an example, optical elements in an array (e.g. grid) can be non-adjacent to each other. In an example, there can be non-reflective gaps between optical elements in an array (e.g. grid). In an example, optical elements toward the center of the array (e.g. grid) can be closer together than optical elements toward the periphery of the array (e.g. grid).

In an example, optical elements in an array (e.g. grid) of optical elements can be moved by being tilted and/or rotated around their edges. In an example, optical elements in an array (e.g. grid) of optical elements can be moved by being tilted and/or rotated around an axis. In an example, an optical element can tilt or rotate around a small-scale hinge, joint, or axle. In an example, an optical element can be suspended in a fluid. In an example, an optical element can be suspended in a magnetic field. In an example, optical elements can be connected to each other by a flexible and/or elastic membrane.

In an example, optical elements in their first configurations can be substantially coplanar. In an example, optical elements in their first configurations can be oriented so as to be substantially perpendicular to a person's line of sight. In an example, optical elements in their first configurations can be oriented so as to be substantially perpendicular to vectors which radiate outwards from the center of a person's eye. In an example, optical elements in their second configurations can be substantially parallel to each other. In an example, optical elements in their second configurations can be oriented so as to intersect a person's line of sight at an acute angle. In an example, this acute angle can be 45 degrees. In an example, this acute angle can be between 30 and 60 degrees.

In an example, an optical member can be electromagnetic. In an example, an optical member can be moved by a temporary and localized electromagnetic field. In an example, selected optical elements in the array (e.g. grid) can be moved from their first configuration to their second configuration by selective application of electromagnetic energy to a selected location in the array (e.g. grid). In an example, optical elements in their first configuration can be oriented to be substantially parallel to a person's line of sight and in their second configuration can be oriented to intersect the person's line of sight at an acute angle.

In an example, augmented reality eyewear can further comprise rows and columns of electromagnetic energy pathways which are in electromagnetic communication with optical elements in an array (e.g. grid), wherein application of electromagnetic energy to a selected row pathway and/or to a selected column pathway causes an optical element at the convergence and/or intersection of this row and column to move from its first configuration to its second configuration, or vice versa. In an example, this movement can be caused by temporary electromagnetism which is created at the convergence and/or intersection of the row pathway and the column pathway. In an example, an electromagnetic energy pathway can be transparent. In an example, an electromagnetic energy pathway can be a conductive transparent channel. In an example, an electromagnetic pathway can be a wire. In an example, an electromagnetic energy pathway can be a (microfluidic) lumen filled with an electromagnetically-conductive liquid.

In an example, augmented reality eyewear can further comprise a first series of electromagnetic energy emitters and/or receivers in electromagnetic communication with electromagnetic energy pathway rows and a second series of electromagnetic energy receivers and/or emitters in electromagnetic communication with electromagnetic energy pathway columns. In an example, rows and columns of electromagnetic energy pathways can be substantially parallel to row and columns of optical elements in an array (e.g. grid). In an example, rows of electromagnetic energy pathways can be in a first layer, columns of electromagnetic energy pathways can be in a third layer, and optical elements can be in a second layer between the first and third layers.

In an example, augmented reality eyewear can further comprise a light-emitting virtual object display. In an example, a light-emitting virtual object display can be a substantially-flat two-dimensional (row and column) display. In an example, a light-emitting virtual object display can be a substantially-straight one-dimensional (row or column only) display. In an example, a substantially-straight light-emitting virtual object display can be located along a side of the array (e.g. grid) of optical elements along the ends of electromagnetic pathway rows. In an example, a substantially-straight light-emitting virtual object display can be located along a side of the array (e.g. grid) of optical elements along the ends of electromagnetic pathway columns. In an example, a light-emitting virtual object display can be a virtual image projector.

In an example, a light-emitting virtual object display can comprise one or more components selected from the group consisting of: active matrix organic light-emitting diode array, projector, or display; collimated light projector or display; digital micro-mirror array, projector, or display; digital pixel array or matrix; diode laser array, projector, or display; ferroelectric liquid crystal on silicon array, projector, or display; holographic optical element array or matrix; holographic projector or display; laser array or matrix; Light Emitting Diode (LED) array or matrix; light emitting diode array, projector, or display; liquid crystal display array, projector, or display; low-power (e.g. nano-watt) laser projector or display; microdisplay and/or microprojector; micro-display array or matrix; optoelectronic display; organic light emitting diode (OLED) array or matrix; passive matrix light-emitting diode array or matrix; photoelectric display; and transmission holographic optical element array or matrix.

In an example, selectively and rapidly moving a selected sequence of optical elements from their first configurations to their second configurations (and back to their first configurations) can cause a sequential pattern of reflection of light rays from a light-emitting virtual object display which together form a virtual image in a person's field of view. In an example, selectively changing the orientations of optical elements in disk pattern can create a circular or sphere shaped virtual image in a person's field of view. In an example, individual optical elements (e.g. reflective components) in an array (e.g. grid) can be selectively moved from their first to second configurations one at a time. In an example, sets or groups of optical elements in an array (e.g. grid) can be selectively moved from their first to second configurations at the same time. In an example, if a light-emitting virtual object display surface is located along the columnar-edge of the array (e.g. grid), then an entire row of optical elements can be moved simultaneously without obscuring the projection of any part of the virtual image. In an example, if a light-emitting virtual object display surface is located along the row-edge of the array (e.g. grid), then an entire column of optical elements can be moved simultaneously without obscuring the projection of any part of the virtual image.

With respect to specific components, the example of a one-eye component of augmented reality eyewear shown in FIGS. 22 and 23 comprises: an array (e.g. grid) 2201 of rows and columns of optical elements, wherein each optical element is a partially-reflective mirror; an eyewear frame including upper portion 2205 and lower portion 2206 which is configured hold the array (e.g. grid) in front of a person's eye; a light-emitting virtual object display 2204 which emits rays of light which are configured to collectively form a virtual object in the person's field of view; a first set 2202 of electromagnetic energy emitters (or receivers) which are in electromagnetic communication with rows of electromagnetic energy pathways; and a second set 2203 of electromagnetic energy receivers (or emitters) which are in electromagnetic communication with columns of electromagnetic energy pathways; wherein transmission of electromagnetic energy between a selected electromagnetic energy emitter (or receiver) in the first set electromagnetic energy emitters (or receivers) and the second set of electromagnetic energy emitters (or receivers) causes a selected optical element to change from its first configuration to its second configuration, or vice versa; wherein the selected optical element reflects a first level of light rays from the light-emitting virtual object display toward the person's eye in a first configuration; wherein the selected optical element reflects a second level of light rays from the light-emitting virtual object display toward the person's eye in a second configuration; and wherein the second level is (at least 50%) greater than the first level.

In FIG. 22, application of electromagnetic energy, 2207 and 2208, along a selected row and a selected column, respectively, causes optical element 2211 to change configuration at location 2209 where this row and column intersect (and/or converge). As shown on the right side of FIG. 22, application of electromagnetic energy 2207 and 2208 along a selected row and a selected column causes optical element 2211 to tilt or rotate towards the person's eye, thereby reflecting ray of light 2212 from the light-emitting virtual object display 2204 toward the person's eye. Rays of light from the person's environment such as 2213 travel substantially undistorted through the array (e.g. grid) in all locations except 2209. In an example, (part of) the image of a virtual object is superimposed over the person's view of the environment at location 2209. In FIG. 22, the array (e.g. grid) of optical elements is protected within a transparent housing 2210.

In FIG. 23, application of electromagnetic energy, 2301 and 2302, along a different selected row and a different selected column, causes a different optical element 2304 to change configuration at location 2303 where this different row and column intersect. As shown on the right side of FIG. 23, application of electromagnetic energy 2301 and 2302 along a selected row and a selected column causes optical element 2304 to tilt or rotate towards the person's eye, thereby reflecting ray of light 2305 from the light-emitting virtual object display 2204 toward the person's eye. Rays of light such as 2306 from the person's environment travel substantially undistorted through the array (e.g. grid) except at location 2303. In an example, (part of) the image of a virtual object is superimposed over the person's view of the environment at location 2303. Advantageously, the ability to selectively control individual locations in the array (e.g. grid) can enable multiplexing of virtual image rows and/or columns projected toward the person's eye with a relatively thin and flat display. In an example, a light-emitting virtual object display can display rows of a virtual image in a sequence which is timed with a sequence of moved rows of optical elements.

An optical structure for Augmented Reality (AR) eyewear disclosed herein can comprise an annular array of light-energy emitters around a lens in front of a person's eye, wherein the lens has a plurality of nested annular light guides. The light guides redirect light from the light-energy emitters toward a person's eye. The annular structure of the light-emitter and light guide arrays can create a more space-efficient optical structure than having light-emitters just on one side (or above) a lens. This can provide higher quality virtual images and more-compact eyewear. In an example, an optical structure for Augmented Reality (AR) eyewear can include an array of selectively-movable light reflectors, wherein each light reflector has a first configuration which is substantially-parallel to environmental light rays and a second configuration which intersects environmental light rays and reflects light beams from a virtual image display toward a person's eye. This can enable a person to have a relatively-clear view of their environment with the selective superimposition of relatively-opaque virtual objects.

FIGS. 22 and 23 can also be described as showing an optical structure for augmented reality eyewear comprising: (a) an optical structure (e.g. a lens or waveguide) which is configured to be worn in front of a person's eye; (b) a light display; (c) an array of individually-movable reflective components (e.g. pivoting and/or rotating micromirrors) in the optical structure; and (d) a plurality of electroconductive pathways; wherein the optical structure has a first configuration in which a first subset of reflective components has a first orientation which reflects light from the display toward the person's eye and other reflective components have one or more second orientations which do not reflect light from the display toward the person's eye, wherein the optical structure has a second configuration in which a second subset of reflective components has a first orientation which reflects light from the display toward the person's eye and other reflective components have one or more second orientations which do not reflect light from the display toward the person's eye, and wherein the optical structure is changed from the first configuration to the second configuration, or vice versa, by transmission of electrical energy through the electroconductive pathways.

In an example, a reflective component having a first orientation can intersect (e.g. at an acute angle) a line of sight extending out from a person's eye. In an example, a reflective component having a first orientation can reduce or block light from the environment from passing through the optical structure to reach the person's eye. In an example, a reflective component having a second orientation can be substantially-parallel to a line of sight extending out from the person's eye. In an example, a reflective component having a second orientation can allow light from the environment to pass through the optical structure and reach the person's eye. In an example, transmission of electrical energy through a selected subset of electroconductive pathways can cause a selected subset of reflective components to pivot and/or rotate from the first orientation to the second orientation, or vice versa.

The example shown in FIGS. 22 and 23 can also comprise one or more components selected from the group consisting of: battery, energy transducer, or other power source; data processor; data transmitter and/or receiver; electromagnetic actuator, actuator array, vibrator, or vibrator array; photo-acoustic array; MEMS array; micro-hydraulic or micro-pneumatic array; sound-emitting speaker or speaker array; and lens or lens array. Relevant variations discussed elsewhere in this disclosure or in priority-linked disclosures can also be applied to the example shown in these figures.

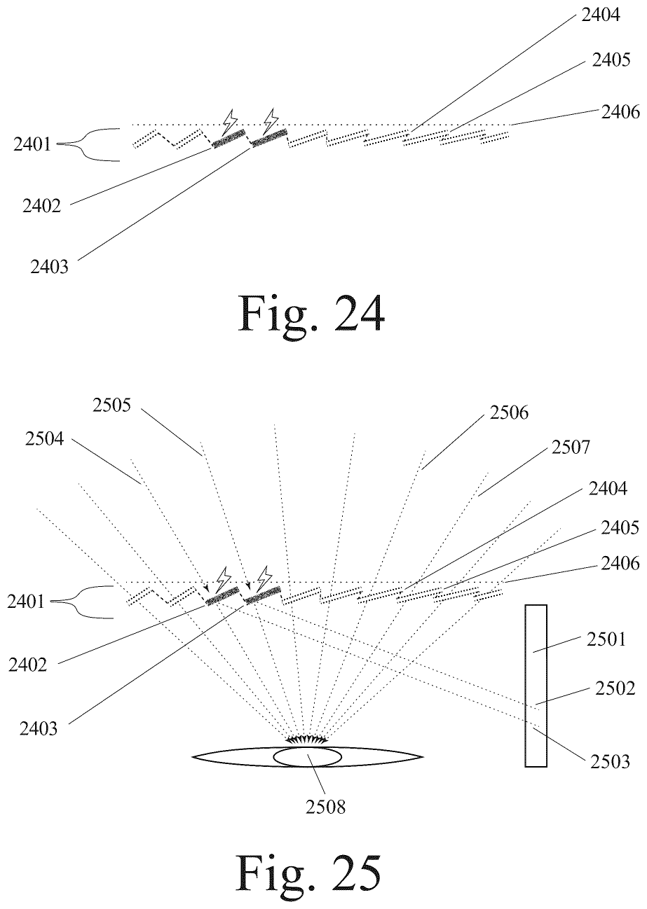

FIGS. 24 through 27 show four top-down cross-sectional views of an array of individually-adjustable transmissive-reflective optical elements. FIGS. 24 through 27 demonstrate that different subsets of optical elements at different locations can be made less-transmissive and more-reflective at different times in order to enhance the opacity and resolution of virtual objects projected at those different locations at those different times.

With respect to specific components, FIGS. 24 through 27 show top down cross-sectional views of: an array 2401 of individually-adjustable transmissive-reflective optical elements, including individual optical elements 2402, 2403, 2404, and 2405; an array 2406 of transparent (or translucent) electroconductive pathways; a display 2501 to one side of a person's eye; the person's eye 2508; light rays from the environment, including environmental light rays 2504, 2505, 2506, and 2507; and light rays from the display, including light rays 2502, 2503, 2701, and 2702.

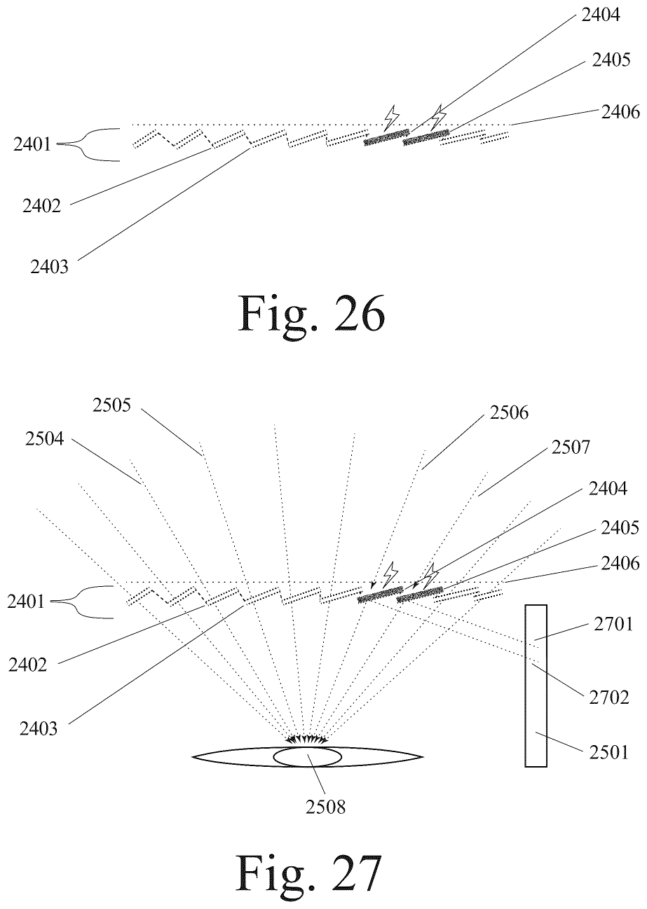

FIGS. 24 and 26 show the array of optical elements and the array of electroconductive pathways, but do not show the display or light rays in order to introduce the structure without too much diagrammatic clutter. FIGS. 25 and 27 show a more-complete view of the structure, including the array of optical elements, the array of electroconductive pathways, the display, and selected light rays.

FIGS. 24 and 25 show this structure at a first point in time when optical elements in a first subset (2402 and 2403) of optical elements in the array have been changed from their first (more-transmissive, less-reflective) configurations to their second (less-transmissive, more-reflective) configurations by exposure to electrical current and/or an electromagnetic field via the electroconductive pathways. The perimeter of this first subset of optical elements can substantially match the perimeter of a virtual object which is projected in the person's field of view at a first location, at this first point in time, in order to enhance the opacity and resolution of that virtual object.

FIGS. 26 and 27 show this structure at a second point in time when optical elements in a second subset (2404 and 2405) of optical elements in the array have been changed from their first (more transmissive, less-reflective) configurations to their second (less transmissive, more reflective) configurations by exposure to electrical current and/or an electromagnetic field via the electroconductive pathways. The perimeter of this second subset of optical elements can substantially match the perimeter of a virtual object which is projected in the person's field of view at a second location, at this second point in time, in order to enhance the opacity and resolution of that virtual object.

FIG. 24 shows, at a first point in time, that a first subset of optical elements (2402 and 2403) have been changed into their less-transmissive, more-reflective second configurations by exposure to electrical current and/or an electromagnetic field from conductive pathways 2406. The electrical currents and/or electromagnetic fields are symbolically represented by lightning symbols near optical elements 2402 and 2403. Optical elements 2404 and 2405 are in their more-transmissive, less-reflective first configurations.

FIG. 25 shows the same structure, configuration, and time which is shown in FIG. 24, but is a more complete figure. FIG. 25 also shows a display, the person's eye, some light rays from the environmental, and some light rays from the display. Specifically, FIG. 25 shows that: light rays 2504 and 2505 from the environment are blocked by optical elements 2402 and 2403 from reaching the person's eye; and light rays 2502 and 2503 (part of a projected virtual object) from the display are reflected by optical elements 2402 and 2403 toward the person's eye. Light rays 2502 and 2503 from the display replace light rays 2402 and 2403 from the environment in the person's field of view. This enhances the opacity and resolution of the virtual object in the person's field of view. In an example, light rays 2502 and 2503 converge onto the pupil or the retina of the person's eye.

FIG. 26 shows, at a second point in time, that second subset of optical elements (2404 and 2405) have been changed into their less-transmissive, more-reflective second configurations by exposure to electrical current and/or an electromagnetic field from conductive pathways 2406. The electrical currents and/or electromagnetic fields are symbolically represented by lightning symbols near optical elements 2404 and 2405. Optical elements 2402 and 2403 are in their more-transmissive, less-reflective first configurations.

FIG. 27 shows the same structure, configuration, and time which is shown in FIG. 26, but is a more complete figure. FIG. 27 also shows a display, the person's eye, some light rays from the environmental, and some light rays from the display. Specifically, FIG. 27 shows that: light rays 2506 and 2507 from the environment are blocked by optical elements 2404 and 2405 from reaching the person's eye; and light rays 2701 and 2702 (part of a projected virtual object) from the display are reflected by optical elements 2402 and 2403 toward the person's eye. Light rays 2701 and 2702 from the display replace light rays 2506 and 2507 from the environment in the person's field of view. This enhances the opacity and resolution of the virtual object in the person's field of view. In an example, light rays 2701 and 2702 converge onto the pupil or retina of the person's eye.

In FIGS. 24 through 27, the angles between reflective surfaces of optical elements and the best-fitting plane of an optical structure vary with the distance between the optical elements and the side of the structure on which a display is located. In an example, angles between reflective surfaces of optical elements and the plane of the optical structure can vary as a linear function of the distance between these optical elements and the side of an optical structure on which a display is located. In an example, angles between reflective surfaces of optical elements and the plane of the optical structure can vary as a step-linear function of the distance between these optical elements and the side of an optical structure on which a display is located. In an example, angles between reflective surfaces of optical elements and the plane of the optical structure can vary as a quadratic function of the distance between these optical elements and the side of an optical structure on which a display is located.

In FIGS. 24 through 27, the angles between reflective surfaces of optical elements and the best-fitting plane of an optical structure vary with the distance between the optical elements and the display. In an example, angles between reflective surfaces of optical elements and the plane of the optical structure can vary as a linear function of the distance between these optical elements and the display. In an example, angles between reflective surfaces of optical elements and the plane of the optical structure can vary as a step-linear function of the distance between these optical elements and the display. In an example, angles between reflective surfaces of optical elements and the plane of the optical structure can vary as a quadratic function of the distance between these optical elements and the display.

In an example, the heights of optical elements can vary with the distance between the optical elements and the display. In an example, the heights of optical elements can vary as a linear function of the distance between these optical elements and the display. In an example, the heights of optical elements can vary as a step-linear function of the distance between these optical elements and the display. In an example, the heights of optical elements can vary as a quadratic function of the distance between these optical elements and the display. In an example, the widths of optical elements can vary with the distance between the optical elements and the display. In an example, the widths of optical elements can vary as a linear function of the distance between these optical elements and the display. In an example, the widths of optical elements can vary as a step-linear function of the distance between these optical elements and the display. In an example, the widths of optical elements can vary as a quadratic function of the distance between these optical elements and the display.

In an example, augmented reality (AR) eyewear can include at least one array of individually-adjustable optical elements whose levels of light transmission and/or reflectivity are selectively and individually adjusted by application of electrical current, or by exposure to an electromagnetic field, via transparent (or translucent) electroconductive pathways.

In an example, an optical component for augmented reality (AR) eyewear can include an array of optical elements whose levels of light transmission and/or reflectivity can be selectively and individually adjusted by application of electrical current, or by exposure to an electromagnetic field, via electroconductive pathways in an array of transparent or translucent electroconductive pathways. In an example, there can be one such array of optical elements and one such array of electroconductive pathways for each eye in augmented reality (AR) eyewear.

FIGS. 24 through 27 can also be described as showing an optical structure for augmented reality eyewear comprising: (a) an optical structure (e.g. a lens or waveguide) which is configured to be worn in front of a person's eye; (b) a light display; (c) an array of individual adjustably-reflective components in the optical structure; and (d) a plurality of electroconductive pathways; wherein the optical structure has a first configuration in which a first subset of adjustable-reflectivity components has a first (e.g. high) level of reflectivity and reflects light from the display toward the person's eye, while other adjustable-reflectivity components have a second (e.g. low) level of reflectivity (e.g. are transparent), wherein the second level is less than the first level; wherein the optical structure has a second configuration in which a second subset of adjustable-reflectivity components has the first (e.g. high) level of reflectivity and reflects light from the display toward the person's eye, while other adjustably-reflective components have the second (e.g. low) level of reflectivity (e.g. are transparent); and wherein the optical structure is changed from the first configuration to the second configuration, or vice versa, by transmission of electrical energy through the electroconductive pathways.

In an example, an adjustable-reflectivity component can be an electrochromic micromirror. In an example, an adjustable-reflectivity component can be an optical grating. In an example, an adjustable-reflectivity component having a first (e.g. high) level of reflectivity can reduce or block light from the environment from passing through the optical structure to reach the person's eye. In an example, an adjustable-reflectivity component having a second (e.g. low) level of reflectivity can allow light from the environment to pass through the optical structure and reach the person's eye. In an example, transmission of electrical energy through a selected subset of electroconductive pathways can cause a selected subset of adjustable-reflectivity reflective components to change from the first level of reflectivity to the second level of reflectivity, or vice versa. Relevant variations discussed elsewhere in this disclosure or in priority-linked disclosures can also be applied to the example shown in these figures.

I claim:

1. Augmented reality eyewear comprising:
an eyewear frame which is configured to be worn by a person;
a transparent optical structure which is configured to be held in front of one of the person's eyes by the frame;
a plurality of light displays located around at least a portion of the circumference of the transparent optical structure; and
a plurality of waveguides which transmit light rays from the light displays to locations on the transparent optical structure, wherein the light rays exit the transparent optical structure from the locations toward the person's eye.

2. The eyewear in claim 1 wherein the eyewear is a pair of eyeglasses.

3. The eyewear in claim 1 wherein the transparent optical structure is a lens.

4. The eyewear in claim 1 wherein the waveguides are shaped like wedges and/or pie slices.

5. The eyewear in claim 1 wherein two or more of the waveguides overlap in a central area of the optical structure.

6. An optical structure for augmented reality eyewear comprising:
an optical structure which is configured to be worn in front of a person's eye;
a light display;
an array of individually-movable reflective components in the optical structure; and
a plurality of electroconductive pathways; wherein the optical structure has a first configuration in which a first subset of reflective components has a first orientation which reflects light from the display toward the person's eye and other reflective components have one or more second orientations which do not reflect light from the display toward the person's eye, wherein the optical structure has a second configuration in which a second subset of reflective components has a first orientation which reflects light from the display toward the person's eye and other reflective components have one or more second orientations which do not reflect light from the display toward the person's eye, and wherein the optical structure is changed from the first configuration to the second configuration, or vice versa, by transmission of electrical energy through the electroconductive pathways.

7. The optical structure in claim 6 wherein the optical structure is a lens or waveguide.

8. The optical structure in claim 6 wherein an individually-movable reflective component is a pivoting and/or rotating micromirror.

9. The optical structure in claim 6 wherein a reflective component having a first orientation intersects a line of sight extending out from a person's eye.

10. The optical structure in claim 6 wherein a reflective component having a first orientation reduces or blocks light from the environment from passing through the optical structure to reach the person's eye.

11. The optical structure in claim 6 wherein a reflective component having a second orientation is substantially-parallel to a line of sight extending out from the person's eye.

12. The optical structure in claim 6 wherein a reflective component having a second orientation allows light from the environment to pass through the optical structure and reach the person's eye.

13. The optical structure in claim 6 wherein transmission of electrical energy through a selected subset of electroconductive pathways causes a selected subset of reflective components to pivot and/or rotate from the first orientation to the second orientation, or vice versa.

14. An optical structure for augmented reality eyewear comprising:
an optical structure which is configured to be worn in front of a person's eye;
a light display;
an array of individual adjustably-reflective components in the optical structure; and
a plurality of electroconductive pathways; wherein the optical structure has a first configuration in which a first subset of adjustable-reflectivity components has a first level of reflectivity and reflects light from the display toward the person's eye, while other adjustable-reflectivity components have a second level of reflectivity, wherein the second level is less than the first level; wherein the optical structure has a second configuration in which a second subset of adjustable-reflectivity components has the first level of reflectivity and reflects light from the display toward the person's eye, while other adjustably-reflective components have the second level of reflectivity; and wherein the optical structure is changed from the first configuration to the second configuration, or vice versa, by transmission of electrical energy through the electroconductive pathways.

15. The optical structure in claim 14 wherein an adjustable-reflectivity component is an electrochromic mirror or optical grating.

16. The optical structure in claim 14 wherein an adjustable-reflectivity component having a first level of reflectivity reduces or blocks light from the environment from passing through the optical structure to reach the person's eye.

17. The optical structure in claim 14 wherein an adjustable-reflectivity component having a first level of reflectivity is substantially reflective.

18. The optical structure in claim 14 wherein an adjustable-reflectivity component having a second level of reflectivity allows light from the environment to pass through the optical structure and reach the person's eye.

19. The optical structure in claim 14 wherein an adjustable-reflectivity component having a second level of reflectivity is substantially transparent.

20. The optical structure in claim 14 wherein transmission of electrical energy through a selected subset of electroconductive pathways causes a selected subset of adjustable-reflectivity reflective components to change from the first level of reflectivity to the second level of reflectivity, or vice versa.
